(19) United States
(12) Patent Application Publication
(10) Pub. No.: US 2010/0163110 A1
(43) Pub. Date: Jul. 1, 2010

(54) Forms

(76) Inventor: Svetozar B. Petrovich, Chicago, IL (US)

Correspondence Address: Svetozar B. Petrovich, 6517 North Coldwell Avenue, Chicago, IL, 60646, US

(21) Appl. No.: 11/724,752

(22) Filed: Mar. 15, 2007

Related U.S. Application Data
(63) Continuation of application No. 11/504,304, filed on Aug. 14, 2006, now abandoned.
Application No. 11/504,304 is a continuation of application No. 11/418,157, filed on May 3, 2006, now abandoned.
Application No. 11/418,157 is a continuation of application No. 11/385,078, filed on Mar. 20, 2006, now abandoned.
Application No. 11/385,078 is a continuation of application No. 11/342,006, filed on Jan. 30, 2006, now abandoned.
Application No. 11/342,006 is a continuation of application No. 11/233,546, filed on Sep. 23, 2005, now abandoned.
Application No. 11/233,546 is a continuation of application No. 11/212,943, filed on Aug. 25, 2005, now abandoned.
Application No. 11/212,943 is a continuation of application No. 11/188,339, filed on Jul. 25, 2005, now abandoned.
Application No. 11/188,339 is a continuation of application No. 11/028,982, filed on Jan. 3, 2005, now abandoned.
Application No. 11/028,982 is a continuation of application No. 10/869,752, filed on Jun. 16, 2004, now abandoned.
Application No. 10/869,752 is a continuation of application No. 10/840,152, filed on May 5, 2004, now abandoned.
Application No. 10/840,152 is a continuation of application No. 10/742,485, filed on Dec. 19, 2003, now abandoned.
Application No. 10/742,485 is a continuation of application No. 10/190,993, filed on Jul. 8, 2002, now abandoned.
Application No. 10/190,993 is a continuation of application No. 10/156,192, filed on May 28, 2002, now abandoned.
Application No. 10/156,192 is a continuation of application No. 10/074,966, filed on Feb. 13, 2002, now abandoned.
Application No. 10/074,966 is a continuation of application No. 09/850,927, filed on May 8, 2001, now abandoned.
Application No. 09/850,927 is a continuation of application No. 09/518,884, filed on Mar. 6, 2000, now abandoned.
Application No. 09/518,884 is a continuation of application No. 09/376,957, filed on Aug. 18, 1999, now abandoned.
Application No. 10/869,752 is a continuation of application No. 10/840,152, filed on May 5, 2004, now abandoned.
Application No. 10/840,152 is a continuation of application No. 10/156,192, filed on May 28, 2002, now abandoned.
Application No. 10/156,192 is a continuation of application No. 10/074,966, filed on Feb. 13, 2002, now abandoned.
Application No. 10/074,966 is a continuation of application No. 09/850,927, filed on May 8, 2001, now abandoned.
Application No. 09/850,927 is a continuation of application No. 09/518,884, filed on Mar. 6, 2000, now abandoned.
Application No. 09/518,884 is a continuation of application No. 09/376,957, filed on Aug. 18, 1999, now abandoned.
Application No. 09/376,957 is a continuation of application No. 10/195,668, filed on Jul. 15, 2002, now abandoned.
Application No. 10/195,668 is a continuation of application No. 10/073,914, filed on Feb. 14, 2002, now abandoned.
Application No. 10/073,914 is a continuation of application No. 09/850,927, filed on May 8, 2001, now abandoned.
Application No. 09/850,927 is a continuation of application No. 09/518,884, filed on Mar. 6, 2000, now abandoned.
Application No. 09/518,884 is a continuation of application No. 09/376,957, filed on Aug. 18, 1999, now abandoned.
Application No. 10/742,485 is a continuation of application No. 10/156,192, filed on May 28, 2002, now abandoned.
Application No. 10/156,192 is a continuation of application No. 10/190,993, filed on Jul. 8, 2002, now abandoned.
Application No. 10/190,993 is a continuation of application No. 10/073,914, filed on Feb. 14, 2002, now abandoned.
Application No. 10/073,914 is a continuation of application No. 10/074,966, filed on Feb. 13, 2002, now abandoned.
Application No. 10/074,966 is a continuation of application No. 09/850,927, filed on May 8, 2001, now abandoned.
Application No. 09/850,927 is a continuation of application No. 09/518,884, filed on Mar. 6, 2000, now abandoned.
Application No. 09/518,884 is a continuation of application No. 09/376,957, filed on Aug. 18, 1999, now abandoned.
Application No. 09/376,957 is a continuation of application No. 09/518,884, filed on Mar. 6, 2000, now abandoned.
Application No. 09/518,884 is a continuation of application No. 09/376,957, filed on Aug. 18, 1999, now abandoned.
Application No. 09/376,957 is a continuation of application No. 08/950,898, filed on Oct. 15, 1997, now Pat. No. 5,941,273.
(60) Provisional application No. 60/231,514, filed on Sep. 9, 2000.
(60) Provisional application No. 60/226,750, filed on Aug. 21, 2000.
(60) Provisional application No. 60/220,358, filed on Jul. 24, 2000.
(60) Provisional application No. 60/217,308, filed on Jul. 11, 2000.
(60) Provisional application No. 60/123,504, filed on Mar. 9, 1999.
(60) Provisional application No. 60/123,207, filed on Mar. 8, 1999.
(60) Provisional application No. 60/123,153, filed on Mar. 6, 1999.
(60) Provisional application No. 60/123,504, filed on Mar. 9, 1999.
(60) Provisional application No. 60/123,207, filed on Mar. 8, 1999.
(60) Provisional application No. 60/123,153, filed on Mar. 6, 1999.

(51) Int. Cl. G05D 7/00

(52) U.S. Cl. 137/2

(57) ABSTRACT

Globose-conduits, as one-form least Sets, contain, retain, detain transport mass energy figures illustrated inventions, principles, methodologies, that is self-conserving, preserving mass energy quintessential, core, natural disposition, classic form. Globose-conduits, as unique origin one-form, evolve devolve; rotate, mutate, transpose, transfer to contain, retain, detain and transport highest conserving mass energy modes perfection beyond human skill. Flush Apparatus assemblies adeptly fit into Sets' mass energy highest conserving. Globose-conduit universe extends from microbes submicroscopic atomic subatomic to cosmos makeup retained detained nonhomogeneous, nonuniform, nonsteady, conforming, least energy-mode exchanges quintessential, core, natural disposition. By parallelism analogy of energy-forms globose-conduits are classic perimeters alongside spherical globose with parallelism to homogeneous mass energy round conductors.

This Forms application is continuation of Serial No:
11/504,304 Aug. 14, 2006 that is a continuation of
Ser. No. 11/418,157 May 3, 2007 that is a continuation of
Ser. No. 11/385,078 Mar. 20, 2006 and is a continuation of
Ser. No. 11/233,546 Sep. 3, 2005 which is a continuation of
Ser. No. 10/869,752 Jun. 16, 2004 which is a continuation of
Ser. No. 10/156,192 May 28, 2002 and said Ser. No. 11/504,304 that is a continuation of said
Ser. No. 11/385,078 Mar. 20, 2006 and is a continuation of
Ser. No. 11/342,006 Jan. 30, 2006 that is a continuation of said
Ser. No. 11/233,546 Sep. 3, 2005 that is a continuation of
Ser. No. 11/212,943 Aug. 25, 2005 which is a continuation of
Ser. No. 10/840,152 May 5, 2004 that is a continuation of said
Ser. No. 10/156,192 May 28, 2002 and is a continuation of
Ser. No. 11/188,339 Jul. 25, 2005 and is a continuation of
Ser. No. 11/028,982 Jan. 3, 2005 which is a continuation of
Ser. No. 10/742,485 Dec. 19, 2003 which is a continuation of
Ser. No. 10/190,993 Jul. 8, 2002 and is a continuation of
Ser. No. 10/195,668 Jul. 15, 2002 that is a continuation of said
Ser. No. 10/190,993 Jul. 8, 2002 and is a continuation of said
Ser. No. 10/156,192 May 28, 2002 which is a continuation of
Ser. No. 10/073,914 Feb. 14, 2002 which is a continuation of
Ser. No. 09/850,927 May 8, 2001 which is a continuation of
Ser. No. 09/376,957 Aug. 18, 1999 and said
Ser. No. 11/223,546 Sep. 3, 2005 that is a continuation of said
Ser. No. 11/212,943 Aug. 25, 2005 and is a continuation of said
Ser. No. 11/188,339 Jul. 25, 2005 and is a continuation of said
Ser. No. 10/869,752 Jun. 16, 2004 and is a continuation of said
Ser. No. 10/840,152 May 5, 2004 that is a continuation of said
Ser. No. 10/156,192 May 28, 2002 which is a continuation of
Ser. No. 10/074,966 Feb. 13, 2002 and which is a continuation of said
Ser. No. 09/850,927 May 8, 2001 and said
Ser. No. 10/869,752 Jun. 16, 2004 and is a continuation of said
Ser. No. 10/742,485 Dec. 19, 2003 that is a continuation of said
Ser. No. 10/190,993 Jul. 8, 2002 that is a continuation of said
Ser. No. 09/850,927 May 8, 2001 and said Ser. No. 10/742,485 that is a continuation of said
Ser. No. 10/156,192 May 28, 2002 that is a continuation of said
Ser. No. 09/376,957 Aug. 18, 1999 and said
Ser. No. 09/850,927 May 8, 2001 claims benefit of
Ser. No. 60/231,514 Sep. 9, 2000 and claims benefit of
Ser. No. 60/226,750 Aug. 21, 2000 and claims benefit of
Ser. No. 60/220,358 Jul. 24, 2000 and claims benefit of
Ser. No. 60/217,308 Jul. 11, 2000 and is continuation of
Ser. No. 09/518,884 Mar. 6, 2000 which claims benefit of
Ser. No. 60/123,153 Mar. 6, 1999 and claims benefit of
Ser. No. 60/123,207 Mar. 8, 1999 and claims benefit of
Ser. No. 60/123,504 Mar. 9, 1999 and is a continuation of said
Ser. No. 09/376,957 Aug. 18, 1999 which claims benefit of
Ser. No. 60/123,153 Mar. 6, 1999 and claims benefit of
Ser. No. 60/123,207 Mar. 8, 1999 and claims benefit of
Ser. No. 60/123,504 Mar. 9, 1999 and is a continuation of
Ser. No. 08/950,898 Oct. 15, 1997, U.S. Pat. No. 5,941,273

### BACKGROUND OF THE INVENTION

This application is continuation from the first application filed Oct. 15, 1997 and first of Provisional Applications 60/123,153, FIGS. 1-115 filed Mar. 6, 1999 that “ . . . lead to, cause low energy demand, least amount of energy needed to pass the waste”.

Conforming embodiments continue as the first application specification, drawings “laminar”, “flow control”. PAP, PP, and PPLD geometries make quantum paths surfaces interface forms conserve transported useful energy modes. A globose-conduit is such a form. Generic claims: PAP, path-angle-of-passage; PP, paths-of-passage; PPLD, path-of-passage-of-least-energy-demand, conforming-embodiments, the second application and filed Amendment and Communication Response dated Aug. 11, 2000, Pages 50-55 define.

Said FIGS. 1-115 without a change, herewith 19 depicted, are unchanged from the second application and are continuation of the first application. No changes to date. Applications first paragraph scope has not changed. Conduits contain fluids, gas, and air.

The continuation applications provide globose-conduit as a least drain trap Set contained, retained, detained and transported mass-energy, figures depicted inventions, principles, methodologies of most self-conserving, preserving mass energy quintessential, core, natural disposition, classic forms. Continuation applications mass-energy boundary as least mass forms is inside the first application, first paragraph fluid mass perimeter to arrive at classic perimeter forms of globose conduits. Nothing is added. The applications continuations depicts, describes unique genome form as origin of classic globose conduit Sets, also represented by the FIG. 1-2 of the first application that is extensively depicted, specified further with the continuation applications. Origin of listed FESD, flow-energy-surface-dispensators, the Figures illustrated by the continuation application, from the first application, entirely second application illustrated, detailed is mostly described toward the end of introduction to drawings, henceforth as classic globose-conduit perimeters Mechanics of Forms, Figures founded origin with the first application.

### SUMMARY OF THE INVENTION

Globose-conduit universe conduit spouts conforming embodiments and drainage line forms complete complement of completely matched Sets retain compact composite fluid mass forms that conserve energy and fluid mass. A Set consists of an inflow Inlet rotated from angled to near upright and a globose conduit spout basin-outlet. A quanta mass form of a least height and highest elevations constitutes quantum mass algorithm computed paths-of-passage, PP, lengths least sum complete complement. A submerged undersurface of an Inlet lower end, an End 2, an outlet ascending spout lower end, a First End, makes a globose, a globose-inverse Set, respectively. A one fluid mass, one length one free-surface upper, globose forms composite conforming, retention least quanta mass above said End 2 or First End undersurface submerges a transition region from a lower conduit to an upper globose form. Forms of FESD, especially outlet and Sub-outlet cross-sections lower smaller areas short heights narrow breadths, PPLD band narrowest widths, open channel quanta mass surface breach and breadth large areas complete complement of forms avoids retained fluid suction with PAP angles less than 180 degrees. A globose-conduit spout lower small conduit, transition region, and upper large globose areas cross-sections retain smaller quanta mass than an ubiquitous art form. A continual quanta mass transport, especially heavy fluids that has first priority right-of-way along with a raised mass centroid through four different cross-sections manipulated areas, is entirely through cross-sections of a lowest small conduit area narrow breadth narrowest PPLD width of band short slopes, height, and length. Retention conforming mass cross-sections area complete complement, least height composites make varied highest elevations breadths. A migrations of an End 2 or a First End from a basin-outlet sidelong to an anti-sidelong location makes up domain Sets. Globose and circumferential strain forms mutations make hybrid Sets. Drainage line manipulated cross-sections areas complete complement varied breadths constitute a lower small conduit, a transition region, and an upper globose areas compact composite. Thus, a fluid smaller mass repeatedly, indefinitely replaced, lifted, and moved through a shorter height and distances conserves infinite mass and energy amount. Flush Apparatus assemblies adeptly pre-assembled retain permanent retention or flush, sterilize, or coat surfaces of parts, forms, or a Set.

Conforming embodiments continue as the first application specification, drawings “laminar”, “flow control”. PAP, PP, and PPLD geometrics make quantum paths surfaces interface forms conserve transported useful energy modes. A globose-conduit is such a form. Generic claims: PAP, path-angle-of-passage; PP, paths-of-passage; PPLD, path-of-passage-of-least-energy-demand, conforming-embodiments, the second application and the Amendment and Communication Response dated Aug. 11, 2000, Pages 50-55 define.

The first application first paragraph most broadly specifies containment forms of mass-energy. The continuation applications provide globose-conduit as a least Sets of contained, retained, detained and transported mass energy, figures illustrated inventions, principles, methodologies of most self-conserving, preserving mass energy quintessential, core, natural disposition, classic forms. Continuation applications mass-energy boundary as least mass forms is inside the first application, first paragraph fluid mass perimeter to arrive at classic perimeter forms of globose conduits. Nothing is added. The applications continuations depicts, describes unique genome form as origin of classic globose conduit Sets, also represented by the FIG. 1-2 of the first application that is extensively depicted, specified further with the continuation applications. Origin of listed FESD, flow-energy-surface-dispensators, for continuation applications, from the first application and entirely the second application illustrated, detailed is described toward the end of this introduction to drawings, henceforth as classic globose-conduit perimeters Mechanics of Forms.

Nonhomogeneous, nonsteady, nonuniform is an inflow mass-energy composition, a perimeter refers to globose-conduit cross-sections area boundary. Mass-energy, mass energy, unless stated otherwise refers to globose-conduit quantum, quanta contained fluid mass energy. Globose-conduit units of mass, quantum, are contained continually; also, transported, retained, contained mass of transported, contained, retained, detained, phases of mass energy. Quanta mass contains varying phase's amounts in variable percentages. Contained mass-energy inside globose-conduits open channel vented forms stratifies by specific gravity under atmospheric pressure. Globose-conduits core mechanics of forms make up this introduction to the drawings, which extends and is detailed description of the drawings part.

A containment boundary controlled, contained, retained, detained, transported air, gas, fluid nonhomogeneous, nonuniform, nonsteady mass-energy constitute a list PPLD widths of band, a lower conduit perimeters, and a contained fluid heights at a modes of energy phases highest sum constitutes globose-conduit forms.

Mass-energy phases modes sum with internal, especially boundary perimeter least rotations constitute globose-conduit universe, domains, classic forms Sets, or genomes.

Generic PAP, PPLD, PP lengths least sum, conforming embodiments, evolve or devolve globose-conduit forms into round or entirely round conduit cross-sections and or globose spherical or spherical retained mass forms that rotate, mutate, transpose, transfer, make unique origin universe highest conserving mass energy phases, Sets, and domains.

A globose form confines, retains, transports; a lower conduit confines, transports; and a detention least confines, transports as mass energy phases mechanics of forms.

Core mechanics of drawings, mechanics of forms, FESD forms, Flush Apparatus inventions, principles, methodologies highest quantum mass-energy quintessential, core, natural disposition globose-conduit classic perimeter forms with the following summary:
A. Microbes' submicroscopic, atomic subatomic to cosmos makeup as described;
B. Craft's ordinary scale implemented inventions, principles, and methodologies:
a. Inflows nonhomogeneous, nonsteady, nonuniform mass-energy stratifies with:
   1. A globose-conduit detention, upper retention least transport-fluid height;
   2. Heaviest fluid topside, inside narrowest PPLD widths, conduit breadths, gravity separated nonsteady, nonuniform mass energy into following;
b. Detention one length, globose largest free-surface form steadies nonuniform, nonsteady mass energy with uniform atmospheric, detention pressures to a DCCS.
c. Narrow PPLD widths, forms' breadths confine heaviest fluid mass with:
   1. Heaviest fluid mass modes of energy at highest elevations;
   2. Confined heaviest fluid mass centroid raised by narrow breadths;
   3. Mass-energy rotations, modes of energy losses minimized;
d. Mass-energy entirely inflows into a globose-conduit conduit contained mass;
e. Mass-energy mass inflows are topside PPLD forms surface into heavy fluid:
   1. Separating, tearing, breaking, releasing heaviest fluid particles;
   2. Heaviest particles that are narrow PPLD widths confined:
      a. With natural fluid mass quintessential, core, disposition forms;
      b. Displaced contained mass, by or with FESD surface forms;
      c. Heavy fluid mass least perimeter least adhesion friction losses:
         1. Least cross-sectional area;
         2. Least friction coefficient
         3. Inflows mass-energy centroids is below a heavier mass centroids computed for;
            a. Mass-energy, perimeter friction, and adhesion least losses;
            b. Centroids alignment rotations that tend to lift heavier mass;
         4. Flush Apparatus are adeptly fitted into globose-conduit forms;
f. Most of steady inflow outflow fluid mass is through a conduit form:
   a. PPLD PP of a DCSS First Sub-outlet have highest mass velocity;
   b. Inflows are entirely through a conduit Inlet;
   c. A DCSS FESD form First Sub-outlet discharges continual outflow;
   d. Rare, unusual events fluid passes through a DCSS globose form;
g. Most of energy modes losses occur with a lower one-half of lowest conduit:
   1. Manipulations of cross-sectional areas forms minimize mass rotations;
   2. Upper retention mainly a transport fluid has least or no friction losses;
   3. Most energy loss occurs between lowest conduit springing points that extends from under an Inlet to an outlet DCSS to an Exhaust;
   4. A PPLD form is at highest elevations in respect to its Inlet End 1; An End 1 higher than a globose-conduit is a safety factor, convenience;
   5. Shrunken PPLD is least height and length conforming:
      a. PAP least angle, with best alignment and symmetry;
      b. Least contained mass, least perimeter losses, PP lengths least sum;
      c. PP lengths least sum inventions, principles, methods, FESD forms:
         1. With algorithm computing up to smallest elements;
         2. Entire quanta subdivided mass computed PP lengths;
         3. With graphical prototypes scaled measurements;
         4. With laboratory testing confirmations;
h. Mechanics of forms mass-energy absolute highest conserving globose-conduit perimeter forms, conforming rotation least fluid mass classic genome Sets:
   1. Globose, spherical form conforming mass retained mass-energy;
   2. Retained mass-energy least surface perimeter globose, spherical form;
   3. Least surface perimeter friction, adhesion mass-energy losses;
   4. Heavier mass least retained mass-energy rounded conduit form:
      a. With statistical analysis of heavy fluid mass-energy inflows, rate;
      b. With conformance to PPLD width of band and length forms;
      c. Retained mass-energy least surface perimeter conduit form;
      d. Least surface perimeter friction, adhesion mass-energy losses;
      e. Amalgamated with upper retention that is a low friction fluid;
   5. Least PAP angle, PP lengths, sum of, PPLD height and length forms;
i. Universe of Globose-conduit mechanics originated from unique genome form:
   1. Retention genome graphical intellectual, inclusion, exclusion shown:
      a. Illustrates Retention unique genome of globose-conduit forms;
      b. Unique genome form originates universe domains;
   2. Globose-conduits evolve or devolve conforming-conduit forms contained least mass into out of globose, spherical contained mass retention least surface forms;
   from globose, spherical retained mass least surface forms;
   3. Amalgamated globose-conduit forms rotate, mutate, transpose, transfer to contain, retain, detain and transport highest conserving mass-energy modes made up of mass-energy contain, detained, transferred phases;
   4. Globose conduit forms manipulated cross-sections areas manipulate, raise a smaller heavy fluid mass centroid ahead of larger transport fluid mass, or vice versa detain transport fluid to pant-up hydrostatic pressures for heavier fluid mass confined discharge four times;
      a. Under an End 2 undersurface a least height separated from a PPLD lowest surface form at highest elevations;
      b. With gradual devolution from a globose to a rounded, or called for by statistical analysis of fluid mass composition, rate to a curvilinear globose-conduit conduit perimeter transition form;
      c. With a DCSS form First Sub-outlet conduit form with a higher energy, smaller heavy mass pushed ahead of a much larger globose detention transport fluid mass; A forth time is with Industrial forms DCSS areas manipulation with transport fluid discharge through Second Sub-outlet;
   5. Globose-conduits are classic perimeters alongside globose, spherical, with parallelism to homogeneous round conductors as described;
      a. A globose-conduit's globose area height vary, from about 5% to about 95% of entire cross-section height, globose breadths manipulated up to orders of magnitude greater than a venting pipe (the first application shown up to three times greater).

Inventions, principles, methodologies quintessential highest self-preserving, self-conserving, core, natural mass energy modes dispositions is globose-conduit universally manipulated forms, Sets, and domains that constitute unique origin universe is as follows:

Quantum mass conforming PAP, PP, and PPLD energy demand self-preserving, self-compliance to mass energy, omnipotent force fields makes Sets' conforming forms. Globose-conduit energy conserving constitutes universe of conformed forms Sets, herein. Controlled vented gas, air and fluid mass inflow, outflow into out of open channel forms.

Globose-conduit classic cross-section areas, perimeters, surface interface forces at boundaries, and mass centroids respective locations are computed for least or no rotations about fluid mass constitutes said “flow control” mass and energy highest conservation.

Basin-outlets least Set includes Inlet forms inside, a conforming retention mass, a globose form transported detention, and said Inlet fluid mass outside of said basin-outlet. Continued first application FIG. 1-2, 10-12 versions show conduit Inlet least height that is barely outside of a basin upper casing. A conforming and a detained fluid mass make up retention mass. The former precludes venting or backups, the latter moves mass. Fluids free surface essential elevations pass largest size submerged particle through a First Sub-outlet and DCSS forms.

Inlet inflows provide paths-of-passage, PP, mass potential, kinetic energy modes sum. An Inlet End 2 separation from a PPLD form barely exceeds largest particle sizes. For drain traps, a globose End 2, a globose-inverse First End undersurface lowest point elevation is globose conduit springing points' elevation.

Transition region cross-section areas are from conduit to globose springing points. Cross-sections fluid structure interface perimeter are two symmetrical smooth curvilinear lines which connect lower conduit upper globose cross-section perimeter springing points ranging from a rounded cross-section to a globose area having springing points breadths a multi order magnitude wider than those of its counterpart conduit form springing points.

FESD forms within transition region make up permanent retention conduit forms, wherein permanent retention is a mass-volume that precludes venting of gas or backups.

Transition region fluid mass least rotations computed viscosity least friction, least breadth or height cross-section area forms having highest conserving modes of energy are listed FESD forms that seamlessly convert classic globose retention into conduit forms.

Generic claims' PPLD forms constitute a part or a counterpart to FESD forms.

For purposes of presenting describing, depicting the following free falling fluid mass has an entire End 1 cross-sectional area without constituted hydrostatic pressure.

Globose-conduit conduit springing points constitutes an elevation no higher then conduit entire height. Rounded conduit forms may make a Trough, a Trough inside a Trough, or Troughs inside Troughs curvilinear forms, a Ridge, a Partition FESD lowest surface forms with sides slopes constituted transition region forms complete complement.

Especially Trough(s), Ridge(s) including upright, Partition(s), or indented Ridges as turning veins Troughs, along with End 2, First End basin lower surfaces, side surfaces includes Dimensions 44 spaced counterparts among listed FESD forms, for PAP upright plane symmetric fluid mass radial outflow, inflow into a basin-outlet. Ordinary trades or crafts fabrication scale to arts sciences microscopic near infinitesimal units of mass FESD forms complete engagement of globose-conduit retained, detained fluid mass constitutes a range of FESD forms complete complement. First and foremost globose-conduit forms constitute open channel conduit forms that contain, retain, detain and transport fluid mass energy with highest conservation of both, including rare events such as high hydrostatic pressures, a hundred year, or once in a lifetime storms.

For a PPLD form slope rise, in tandem, increases its area form side surface slopes into narrower breadths that with cross-sections height narrows transition region breadths, giving upper retention, globose form breadths curvilinear or elliptical upright major axis forms. Forgoing algorithm computing methodology carries out to a highest computational accuracy cross-sectional areas and perimeter fluid mass forms for least or no entire fluid mass rotations in PAP upright plane toward highest conserving of mass energy modes. A PAP upright plane horizontal orientation in space constitute absolute symmetry of forms up to DCSS springing points elevations having least or no detrimental retained, detained, transported fluid mass rotations constitutes in PAP upright plane symmetry said “flow control means” laminar fluid mass.

Globose is gravitational field energy modes, classic containment. Spherical, globose highest energy modes genome classic forms retain mass units constituting computed least resistance paths, said paths-of-passage, PP, lengths least sum that here applies to retained, detained, and transported nonsteady, nonhomogeneous, and nonuniform mass. Conduit forms must exist for transfer of energy modes. Generic claims PAP, PPLD, PP with PP lengths least sum, defines confined mass modes of energy transfer self-conservation with units of mass PP of least resistance make up of basin-outlet classic globose-conduit forms conformed embodiments, Sets. Said PP lengths least sum computes open channel fluid said centroid locations and least height classic forms for retained and transported fluid mass with least or no rotation forms, for ordinary design use, with infinitesimal elements designs for scientific purposes. Practical construction purposes, crafts finest tolerances constitute said finest units, least mass, lowest surfaces, slopes, shortest or least height, length, and said stated required construction implements stated principles that conserves fluid mass and energy.

Each breadth different width above PPLD width of band highest elevation makes on infinitesimal scale a stair step like change. A step constitutes summation of mass units widths that make least resistance paths of least elevations derived by said PP lengths least sum. Forgoing statistically compiled fluid mass properties, especially specific gravity of particles, into curvilinear forms computing methodology for influx of units of fluid mass constitutes each mass unit path of least resistance that algorithm amalgamates into entire mass PP with lengths least sum. Units of mass PP lengths least sum makes lower cross-sections a viable conduit area with a perimeter form. By definitions, inverts of globose-conduit forms, PPLD width of band horizontal segments, constitute highest elevations. A horizontal chord, breadths at respective elevations, by PP lengths least sum computing is a least transfer of kinetic to potential mode of energy, highest conservation for fluid mass and energy. Rising PPLD widths with length constitutes potential energy increase, while descending PPLD cross-sections respective breadths, conduit horizontal chords, lowering of elevations with length is potential to kinetic mode transfer highest energy conservation for statistically compiled fluid mass and energy composition. Foregoing methodology for cross-section areas, perimeter computed forms effects least fluid mass rotations in a PAP plane of symmetry, which requires exact areas and perimeter forms with length. With no PAP upright plane rotations, units of mass moves are confined by surrounding units of mass at respective elevations or move down, up governed by mass units' specific gravity. In chords, breadths, horizontal planes units of mass are confined by surrounding units of mass eventually confined by cross-sectional area form perimeter form which implements least or no rotations in PAP upright plane of symmetry, least or no rotations in horizontal planes for no fluid mass energy influx changes. Said changes require at least a change in retention free surface elevations and that also require areas, perimeter change effected by aforesaid computing for highest probability statistical fluid mass influx, outflow balance. This requires a continual slight narrowing of conduit forms lengthwise breadths with an even smaller transition region breadths increase toward a DCSS or next Inlet fluid mass influx, which constitutes immaterial change for crafts, trades fabrication. Upper globose and transition region cross-sections computed similarly makes complete complement of forms that constitute cross-sections classic areas and classic perimeter of entire globose-conduit Set of nonhomogeneous, nonuniform, nonsteady fluid mass FESD forms.

A PPLD constitutes globose-conduit unit of mass lowest path of least resistance for said globose form least retention mass, least fluid mass height conduit form highest elevation highest conservation of fluid mass energy conversion from kinetic to potential mode. Gravity force pulls higher specific gravity particles toward a path-of-passage-of-least-energy-demand, PPLD, with lighter particles moved to equal or low specific gravity mass higher elevations. Confined by narrowing of a globose, conduit ascending spout, heaviest particles are squeezed into a PPLD narrowest width highest slope single largest sphere that just passes through said spout rounded lowest surface area cross-section that is said PP lengths least sum FESD form. Surrounded by highest specific gravity transport fluid mass of highest viscosity said largest sphere is pushed in back pulled by transport fluid drag while allowed to rotate in PPLD direction toward summit without rotations of entire fluid mass. Sub-outlets, First Sub-outlets, detention fluid free surfaces essential elevation height is said largest sphere passing through Sets submerged height, elevation at summit.

An End 2 undersurface is located at about one half of upper retention depth that with a free fall locates inflows mass centroid into a lowest ¼ of a basin retention depth. Ignoring viscosity friction, adhesion, at a DCSS form, velocity of water at depths below a fluid free surface equals the square root of twice gravity acceleration times a fluid depth. High specific gravity inflows, outflows fluid mass is entirely through lower conduit form of globose-conduit cross-sections. Globose-inverse First End located about one half of basin retention depth is entirely consistent with said heavier mass inflows, outflows.

Ordinary fluid mass retention outflows are mostly through a lower small conduit cross-sectional area of a globose-conduit composite, ahead of a larger detention mass. Unusual, out of ordinary fluid mass outflows pass through globose cross-sectional forms.

Heaviest mass centroid short height to a summit is most mass energy conserving. A globose-conduit shallowest retention also has heaviest fluid mass most raised centroid.

Globose-conduit least conforming retention mass of least height of least rotations is least magnitude potential, kinetic exchanges of energy modes. Kinetic potential energy mode exchange has rotational friction and viscosity losses. Compared to round or similar piping, globose-conduit Sets forms complete complement amalgamated, least mass, least conforming retention, least rotations multi raise retained mass centroids, PPLD forms to highest elevations for modes of mass energy highest conservation. Less is more; more is less; less energy transferred conserves mass, energy either one or both. Least rotations of least mass centroid at highest elevation a least height from fluid free surface set at highest elevations have Sets' forms highest conserving mass modes of energy. Narrowest conduit breadths move heaviest fluid mass higher into entire cross-sections form, raising its mass, area, perimeter centroids to highest elevations matched by globose breaths, PPLD forms, fluid mass highest elevations, energy modes highest conserving.

Least fluid mass least rotations constitute least rotational frictional, viscosity loss higher potential, kinetic energy exchanges magnitude, mass energy highest conservation. Globose-conduit conforming detention least height globose largest breadths, lengths raise entire mass centroid elevation eight times. Once for each of four horizontal direction that is in unison with the other three, repeated again four times for conforming globose mass retention at rest, with fluid free surface elevations as the governing reference for kinetic, potential modes exchanges least energy demand with PPLD forms at highest elevations. As a system amalgamated globose-conduits raise fluid mass centroids three times; once for each globose conduit forms raised mass centroids, once for highest PPLD elevations.

Globose-conduit sewer lines detention, basin-outlet least mass conforming retention fluid mass centroids rotations are least distance from fluid free surface, which makes for highest conserving mass energy modes balanced exchanges that inflicts a least abuse or damage to earth's ecosystem mass energy balance, as follows: Energy balanced modes for least mass least rotations conserves mass energy;

A detained larger mass at insignificant or no energy loss is conserving mass energy; globose forms detain transport fluid mass that counterpart conduit uses to transport mass;

Pent up hydrostatic pressures cause discharge of nonhomogeneous heaviest mass, particles; Pent up hydrostatic pressures are to fluid free surface essential elevations, only;

A globose-conduit conduit outlet, First Sub-outlet, DCSS greatly narrowed breadths with much larger globose breadths adeptly manipulates PP pent up hydrostatic pressures;

Detention large breadths, lengths mitigate nonsteady mass flows to a least change from highest conserving mass energy fluid free surface elevations, hydrostatic pressures.

Herewith listed, also referred to, FESD specific forms are part of FESD globose-conduit forms whose specific purpose is prevention or restriction of fluid mass rotations. For highest conservation of energy, exact transfer of kinetic to potential energy requires energy path-of-passage-of-least-demand, PPLD, for a unit of mass that passes a summit. For near frictionless transport fluid critical path lengths are those against gravity direction as then mass energy required contains 32.2(ft/sec. squared) multiple. Smallest entire mass makes for least mass that requires said multiple for highest conservation of energy. Such mass must preclude venting or backups found by nearly universal or ubiquitous empirical use. Least mass contained by most compact, least volume spherical modified to a globose form units of mass constituted PP lengths least height forms make said least mass forms. Nonhomogeneous fluid mass paths-of-passage, PP, lengths least sum contains horizontal components as well. Conduit inverts, fluid mass units energy paths-of-passage-of-least-demand (most energy required), PPLD, identical PP length forms are referred to as such.

Nonhomogeneous, nonsteady nonuniform least mass highest conserving energy modes fluid mass least rotations globose-conduit complete complement PP lengths least sum retention genome round, rounded, curvilinear forms has following transpositions:

Round or rounded areas transposed to a conduit, an intermediate, and a globose form area higher centroids of retained fluid mass potential and kinetic modes of energy;

Transposed round, rounded conduit cross-sections, fluid mass essential height as for a First Sub-outlet, constitutes fluid mass least rotations curvilinear least height form;

Least rotations curvilinear fluid mass forms raise centroids of following:
Fluid mass perimeter, FESD structure interface curvilinear surface, thus;
Viscosity, cohesion, adhesion, and solids surfaces friction centroid;
Boundary layer perimeter laminar respective forces centroid location, as
Transposed centroids, forces constitute one common centroid force with least rotations, for fluid mass varied compositions respective least height forms;

Breadths, breach least height FESD make for fluid mass forms least rotations;

Contained, retained, detained transported fluid mass-energy phases forms least PPLD width of band, lower conduit perimeter, and quintessential, core, self-conservation, self-preservation for a quanta mass form least height, a mass centroid highest elevations.

Thus, a classic globose upper retention form and a classic lower conduit form constitute elevations of fluid free surfaces that is for a transfer of energy mode near or at highest elevations. A classic globose lower form amalgamates a lowest surface shrunk PPLD conduit form at highest elevations, which conserves most of fluid energy transfer to potential mode to transport highest specific gravity fluid mass specifically effected by said classic conduit to globose form transition region. Said PP lengths least sum of finite to infinitesimal retained fluid mass inherently constitutes self-conserved preserved energy highest conservation paths of least resistance, which make open channel transition region of globose-conduit fluid mass forms. Said globose-conduit transition region computing of forms forgoing figures, wherein globose-conduit conduit basin-outlet, Inlet fluid mass forms, may constitute an Inlet contained fluid mass outside a basin-outlet, especially fluid mass and Inlet forms that precludes suction or venting. Transition region forms conserve fluid mass energy with computed highest elevations of PPLD and fluid free surfaces least height difference constantly continually that with a conduit form fluid mass constitutes an essential height. Said PPLD constitutes lowest surface rounded form unless fluid mass highest specific gravity are highly uniform inflows that PP lengths least sum computes to a round form. Rounded lowest surface forms constitute highest elevation for a statistical continual inflow rate that constitutes fluid mass detention wherein said inflows of a nonhomogeneous, nonsteady, nonuniform fluid is accounted for by lowest surfaces PPLD forms. For statistical standard deviations higher inflow rates rounded forms open into PP lengths least sum computed wide form of low slope sides surfaces or parabolic horizontal major axis forms. Highest elevations PPLD forms govern unless cross-sections breadth or breach computed PP lengths least sum mandates a PPLD lower form.

Shrunk PPLD forms rounded, elliptical upright major axis, or curvilinear globose-conduit forms makeup, transition region forms, PAP angles less than 180 degrees, and PP lengths least sum forms complete complement constitute claimed universe fundamentals:

PAP two points, as “surveyor stakes” that space align fluid mass energy forms with conduit, globose springing points constituted lower, upper transition region limits;

“Self-designed” conforming PP lengths with least sum, least fluid mass energy, resistance paths constituted fluid mass perimeter surfaces that are globose-conduit forms,

Said PP paths, as “self-designed” units of fluid mass paths that use least energy;

Said PPLD forms, as “self-designed primary paths” most efficient energy forms,

Said classic retention genome, as contained retained energy genomes “parent”;

Mass units' paths of gravity force least resistance is said PP mass energy modes quintessential highest conserving, self-preservation with natural disposition visible forms;

Most self-conserved preserved fluid mass energy self-generates least magnitude of energy modes full transfer most shrunk PPLD form, globose-conduit compact forms;

Said “parent” near spherical classic conforming retention amalgamates, its outlet conduit to make up highest conserving fluid mass energy globose-conduit Sets;

Said infinitesimal units of mass PAP symmetric orderly outflows, inflows into, out of classic retention genome form, as “old”, “new” units of fluid mass and energy;

Said fluid mass energy units, as “participants” in “parent” mass energy universe;

Said laminar flows mass units, as a “confined unit” for fluid mass energy forms;

Mass units PP lengths least sum makes least PAP angle unique Set symmetrical forms through a discharge-cross-section-surface, DCSS, and springing points elevations;

Globose-conduit forms are within “genus” conforming “citizens”, Sets, by PP lengths least sum fluid mass energy highest conserving forms that constitute its universe;

Lower globose basin globose forms amalgamate into a rounded or a curvilinear globose-conduit, First End, outlet, Sub-outlets, FESD, and DCSS FESD respective forms;

Paths-of-passage compute PP lengths least sum, globose-conduit, PPLD, FESD retention conforming least fluid mass least rotations PAP upright plane symmetric forms;

Classic genomes Set of forms conforming retention least mass least height is mass modes of energy highest conservation thus PP lengths (least resistance) least sum;

Quantum units of mass PP least sum amalgamates mass units' paths into least height shallowest retained mass genome forms mass energy modes highest conservation;

Genome Sets make for retained fluids least height, least mass potential, kinetic energy modes quantum mass units least sum amalgamate into fluid mass and forms Sets;

Said PP lengths least sum for a form constitutes a conforming or a genome form; genome forms complete complement conforming embodiments are genome Sets.

Embodiment forms PP lengths least sum causes nonhomogeneous fluid mass conforming permanent retention kinetic potential energy modes passing heaviest particle.

Heaviest particles, highest specific gravity mass PPLD least height, conforming least retention mass, height, and energy modes inflows transport PP mass; A quantum, an omnipotent mass, energy physical forces compute to a conforming embodiment forms;

PPLD units of mass paths to summit topside PPLD width of band surface forms make for least rise slopes for said mass units PP lengths least sum narrowest breadths;

Outlet FESD and DCSS forms PP lengths large breadth upper area cross-sections higher than globose forms springing points elevation limit fluid free surface rises to hold least height, least fluid mass kinetic energy transfer to potential energy mode;

Further fluid free surface rise potentially wastes both;

A greatest particle height constitutes a free-fluid surface detention essential elevation PP lengths least sums lowest elevation and First Sub-outlet forms least height.

Essential detention free-surface elevations require no kinetic to potential energy energy-demand transfer required for continual mass and energy highest conservation;

Open channel globose-conduit forms nonhomogeneous fluid solids mixtures mass energy self-preservation containment, detainment, and transport is within one form.

Globose-conduit forms contain Inlet retention and forms, that altogether inside a basin-outlet constitutes a globose-conduit least mass-energy least Set of forms;

Quantum-mass PP complete complement computes Sets' least resistance forms.

Generic globose-conduit claims: PAP, path-angle-of-passage; PPLD, path-of-passage-of-least-energy-demand; PP, paths-of-passage with a least sum constitute fluid mass globose-conduit conforming embodiments self generated Sets. Globose universe conforming embodiments, Sets genus, is generic claim classic Sets conservation of mass and energy of fluids and solids mixtures that originate from said classic unique retention form genome. PP, paths-of-passage, lengths generic claim to algorithm computed least sum is energy balance for entire retention mass quantum mass upright components with gravity acceleration multiple, which through reiterative process arrives at fluid mass and structure forms interface ultimate Sets, genomes. Forgoing specified at least two points aligns Sets to a linear PAP least angle alignment and symmetry of forms. Genomes best construction of surface forms narrows the first application globose conduit construction and forms tolerances to commercial, industrial forms herein said complete complement of completely matched forms of Sets. Sciences, art fields nuclei or subatomic, microscopic or submicroscopic complete complement of forms is quintessential of globose-conduit potential, kinetic near infinitesimal quantum mass energy modes transfers perfection that is beyond human skill to create or duplicate.

Classical best known highest packed carriers of mass energy forms are electrons, protons, and neutrons, with round shape properties that continue into sub-atomic ranges. A round cross-section of an electrical wire, a water pipe is taken as best carrier of energy. Both need transport energy. First transports relatively no mass high-energy electrons, the latter transports mass with modes of energy that requires a mass weight supply. Gravity influences insignificantly the former but impacts the latter, especially nonhomogeneous, nonsteady, nonuniform mass. Globose-conduit nonhomogeneous mass, cross-section area and perimeter centroids continually at least infinitesimal at odds to gravitational direction alignment extends to quantum mass atomic subatomic or microbes structure substructure forms. Electrical wires, pure water pipes under voltage, hydrostatic respective pressures are mainly completely round cross-section areas and perimeters classic genome forms.

Globose-conduit conforming embodiments classic universe forms contain, retain, detain, transfer and conserve mass energy that transposes globose-conduit, open channel, nonhomogeneous to homogeneous high pressure round water pipe, electric wire or vice-versa or round, globose, spherical retained mass with PP lengths generic least sum claim.

Microbes microscopic, submicroscopic thin disk or short rod line like, single form cells contain, retain, transport, or detain submicroscopic ecosystem inflow, outflow mass constitute an Inlet, a basin-outlet forms of globose-conduits basic types least Sets make.

Solar system globose, spherical bodies align as if in, a detention mode, extremely thin disk like highest conservation of mass energy mode. Sun's radiation, solar system's gravitational pull maintains cosmos mass energy equilibrium. A thin disk alignment has highly precise equilibrium balance. The Sun with entire Solar System is highest modes of energy basin in equilibrium with Milky Way Galaxy mass energy. A body of the Milky Way Galaxy pulled into the Solar System with its gravity-controlled space makes an Inlet form, and when it exits, the Solar System an outlet form.

The Solar System, Milky Way Galaxy contains, retains, detains or transports for a highest conservation of its celestial bodies' energy modes. Globose-conduit forms mass energy modes phases highest conservation makes globose-conduit forms universe from a microbes' submicroscopic, atomic subatomic to cosmos makeup wherein the Milky Way Galaxy is a miniscule part.

Clearly celestial bodies travel paths of least resistance paths-of-passage, PP, that is highest mass energy conservation from cosmos to Milky Way Galaxy, to Solar System, to Earth with each body path length accounting for mass energy losses within the cosmos mass energy equilibrium. A stationary body has exhausted in space its modes of energy except for gravity that burdens it in tandem with gravity, rotations of the cosmos thus to contract only, unless it can overcome pent up compression with escape paths through a perimeter confirming to cosmos gravity, mass, energy balance. Thus, the cosmos, Milky Way, Solar System bodies constitute PP of least energy, least energy demand, least length whose PP lengths least sum for the Solar System, Milky Way, Cosmos constitutes mass energy quintessential highest self-conservation, self-preservation. Around solid celestial bodies, nuclei respective gravity, electron energy fields constitute invisible, least energy required, natural disposition to dissipate mass-energy that are frictional no energy loosing boundaries on scale beyond human skill to create.

Centroids least separation of heaviest mass, detention transport fluid mass needs less transport fluid mass and its energy. Two, three dimensional FESD forms of globose conduits much wider breadths larger area compared to entirely round or otherwise similar conduit forms hold transport fluid mass with least or shallowest detention, retention mass height that is set at highest elevations for respective Set fluid mass inflows, outflows. For continually raised heavier fluids centroids toward a DCSS with entire fluid mass least or no rotations in PAP upright plane makes for highest mass and energy, especially transport fluid mass variable inflows with specific gravity variations mass, energy conservation.

Frictionless fluid least rotations consume least to insignificant amounts of energy modes. Globose-conduit systemic highest self-conserving energy modes retains, detains, and transports manipulated mass energy mass, area, and perimeter centroids as follows:

Two PAP points align upright plane symmetric globose-conduit forms flexible to rigid least Set rotated forms to a finite or infinitesimal PAP angles accuracy analogous to “positioning members” with forms having up to near infinitesimal “flow control means”;

Globose-conduits PP make paths of least resistance cross-section areas breadths for fluid free surface least elevations difference from PPLD forms at highest elevations; Sets contain retain detain, and transport nonuniform, nonhomogeneous, nonsteady classic area, perimeter least mass, height, fluid mass for least or no detrimental rotations;

Globose-conduit quintessential fundamental, evolutionary, natural, highest self-conserving self-preserving superiorities self-generated mass energy forms is as follows:

1. Globose-conduit mass inflows preferentially distribute transport energy modes into heaviest fluid mass PP, PPLD forms at highest elevations with respect to its summit.

2. Globose-conduit forms push highest specific gravity mass ahead of a transport fluid mass at three locations: a) under an End 2, b) prior to a summit, c) after a summit;

a. Under globose End 2 least conduit height, with a lowest PPLD form at highest elevation, with separations that need not exceed much inflows mass largest particle size;

b. With narrow breadths conduit transported heaviest mass risen centroid pushed in front, ahead of detention mass ahead of a First Sub-outlet by least fluid mass rotations;

c. Passed summit with transport fluid greater drop into pushed ahead heavier fluid mass similar to fluid mass Inlet inflows, accentuated by Industrial Sets heavy, transported fluid mass passed through a lower First, a higher Second Sub-outlet forms, respectively;

5. A globose detention in tandem rise behind a risen transported mass centroid;

4. Transported, transport fluid tandem raised, lowered respective mass centroids;

5. A much small transported mass in front of significantly larger detention mass;

6. Compact retention, detention highest mass centroids in respect to its summit;

7. Highest mass centroids a least distance, rotations from a respective summit, constitute a viscosity, boundary layer friction least fluid mass modes of energy losses;

8. A narrow conduit breadth at summit raises up globose detention pressure;

9. A globose-conduit, one-form, least energy modes demand raised detention pressure, heaviest mass centroid retains or detains, transfers mass energy highest modes;

Kinetic, potential is useful energy mode; least mass rotation is conserving both;

Conserving of both is because energy modes are least energy demand transfers;

Quantum mass energy modes are exchanges for inflows mass energy same sum;

10. A globose detention mass pant up pressures separate, dilute, or dissolve a transported mass in its path with raised centroid, least apart from transport mass centroid;

11. Open channel forms adeptly manipulate energy-modes gravity force caused;

12. Globose-conduit nonhomogeneous nonuniform nonsteady modes of energy mass, cross-section areas, perimeter centroids align for highest mass energy conserving;

13. Generic PAP, PPLD, PP lengths sum, conforming embodiments, evolve or devolve globose-conduit forms into round or entirely round conduit cross-sections and or globose spherical or spherical retained mass forms that rotate, mutate, transpose, transfer, make unique origin universe highest conserving mass energy phases, Sets, and domains;

14. Globose open channel basin-outlet spouts manipulate, adeptly amalgamate mass energy modes one-directional linear or circumferential globose or circumferential cross-section areas of retention, detention that otherwise requires three-elbows assembly; Globose, circumferential are highest self-preserving mass energy two strains of forms; A one-directional less than 180 degrees alignment is one within cosmos' gravity fields;

15. Self-conserved energy process among naturally evolved or man made forms constitute classic chains with globose-conduits as natural, quintessential dominant links.

16. Fluid mass forms of energy, composition, and physical properties highest self-conservation globose-conduit forms evolve into classical round forms and vice versa;

17. Classic globose-conduit detention PP lengths least sum, height mass energy absolutely dilutes, tears up, disintegrates, moves or transports high specific gravity mass; This conserves useful energy modes mass energy for a transport of such heaviest mass; Air as a fluid mass is controlled into out of open channel forms as an enclosed boundary;

18. Basin-outlets least Set includes Inlet forms inside, a conforming retention, a globose-conduit transported detention, and an Inlet fluid mass outside of its basin-outlet;

a. Conserving mass energy is inside mass energy modes enclosing boundaries; Mass energy modes stated inventions, principles, and methodologies requires respective boundary of physical, nuclear molecular, living cells chemical mass energy modes forms;

b. Contained modes mass energy forms require at least one enclosing boundary;

c. Globose-conduit open channel forms transport of fluids and solid particles of nonhomogeneous mass energy is comparable to round pipes, electrical wires transport of homogeneous mass, energy, and atomic subatomic round forms retained mass, energy;

d. Paths-of-passage lengths least sum amalgamates nonhomogeneous, nonsteady, nonuniform, mass-energy units viscosity, adhesion, cohesion and fluid structure interface perimeter boundary layer adhesion, friction into highest mass energy conserving forms;

e. Classic globose-conduit genome forms constitute classic perimeter form Sets;

Globose-conduit principles, methodologies are homogeneous mass applicable.

Partial suctions of globose-conduit smaller than ubiquitous permanent retention is safest quickest recovery of upper retention of highly conserved fluid mass and energy.

f. A rise in globose-conduit, basin-outlet PPLD band in tandem with narrower lower conduit cross-sections breadths is completely complimented by transitions regions least height wide globose breadths forms having essential height or greater elevations;

g. Mechanics of forms contain modes energy highest sum at highest elevations;

h. A retained fluid mass defines a lower retention, an upper retention and a detention form. An upper retention at rest makes a free surface. A detention makes a free surface that is higher than said free surface at rest;

i. Globose-conduit said fluid mass energy PP lengths least sum are one of forms forms for highest statistical-probability of nonhomogeneous, nonsteady, and nonuniform retention, detention least PAP angle, quanta mass least rotations. FESD forms are PP lengths least sum classic perimeter forms that contain, retain, detain, and transport fluid mass energy of globose-conduits, which themselves constitute FESD forms.

Domains of globose-conduit universe FESD forms with said PP lengths least sum surfaces restrict rotations of mass in three orthogonal planes, especially prominent among named makeup Troughs, Ridges, Partitions, globose End 2 and globose-inverse First End forms and undersurfaces, doming Cavities, Bridging-Wall, Fin and DCSS FESD forms. Troughs raise globose forms sides lowest surfaces wherein Ridge, Partition FESD forms raised PPLD lowest surfaces into two PPLD higher elevation forms. Troughs, Ridges and Partitions are globose conduit forms integral parts concepts that raise heaviest fluid mass centroid twice. Once, as a part of globose-conduit forms highest elevation lowest surface raised with a presence of such forms to constitute least fluid mass height form that makes narrower breadth two cross-sectional areas, to thus again raise nonhomogeneous heavier mass centroid. A narrower PPLD form initiates earlier lowest surfaces rise with narrower breadths constituting faster rise of lowest, lower surfaces.

Figures of globose upright, angled to about upright, angled, industrial, low angled, Inline, inverse and hybrid forms claim globose-conduit universe of Sets, forms, hybrids, migrations, mutations, entire G-C universe domains, genomes, along with classic forms classic perimeter Sets inventions, methodology, and principles, and concepts disclosed.

Energy and fluids mass finest elements algorithm computed PP lengths least sum perimeter boundaries constitute science academia infinitesimally exact fluid mass energy perimeters. Plugs, Caps Portals, and nozzles are replaceable by continued streamlined surfaces. Nozzles especially high inside an Inlet is tolerable as fluid free surfaces at this elevation is at or above said detained fluid mass essential elevation. Sidelong Sets make for one-directional PP lengths sum. A sidelong offset to an anti sidelong, a near upright Inlet is respectively closer to respective DCSS forms. PP and PAP aligned forms save mass-energy. Trough, Ridge, Trough-Ridge, Partition, or Trough-Ridge-Partition FESD removes and or manipulates excessive mass-energy PP bundles. FESD forms conserve fluid mass-energy by a reduction of mass or mass rotations or both.

The first application specifies gravitational field forms that contain, retain, detain, and transport modes of mass energy. Continuations, this application continues describing forms process to one that has mass and energy conservation laws, conforming conditions, to energy-modes transfers including boundary, perimeter, energy losses to define forms. No maximum or minimum boundary conditions restrict generic claims PP PAP, PPLD, conforming embodiments, other than universal laws of mass energy conservation, which allows for various conditions of various conforming boundaries to define modes of mass energy phases conserving conforming embodiment forms, Sets, and domains. The first application first paragraph embodies piping universe without an exception. Unrestricted mass modes of said piping universe and globose-conduit forms is one space universe. Globose-conduit perimeter forms are imposed boundary conditions for a quantified mass energy highest self-conservation self-preservation graphical visual illustration of useful, contained, quintessential, mass energy phases perimeter. Continuation applications revise restrict, by said generic claims boundary conditions, perimeters of the first paragraph of the first application to quantum mass PP lengths least sum computed mass energy highest conserving perimeters.

By imposing ecosystem universally most friendly boundary requirements, entirely releases, removes artificial, unnatural boundary conditions quantum mass PP quanta mass constitute entire universe, cosmos contained, retained, detained or transported phases of mass energy bodies with gravitational energy or force. Omnipotent potent contained one-mass energy forms constitute globose spherical, spherical perimeters gravitational field of same forms with intellectual boundary surface visualization enclosing gravitational force field energy. Orbiting mass energy modes phases detained by its omnipotent gravitational energy mass constitutes potential conduit forms. Analogous parallelism on atomic scale is nuclei mass energy spherical forms contained mass energy with orbiting electrons that constitute a perimeter form that allow inflow outflow of other electrons as an omnipotent atoms mass energy respective detention.

On microscopic, submicroscopic scale a mass energy inflows, outflows constitute an inlet, an outlet with a single cell, or a most primitive organism globose or cylindroid detention forms with cell membranes boundary as conforming conditions perimeters. A partitioned mass energy conservation subdivides into globose-conduit cells. Accepted omnipresent parallelisms among mass modes of energy forms by universal mass and energy conservation laws herein extend to nonhomogeneous, nonuniform, nonsteady mass energy respective phases of mass energy perimeter forms.

Globose-conduit classic forms contain detain and transport nonhomogeneous fluid comparable to subatomic, atomic; microscopic, submicroscopic; high pressure water pipe or electric wire classic forms, perimeters contained, detained, and delivered mass energy.

Straight lines constitute mass energy highest conserving path between two points. A straight-line path away from a rotating mass traces a circumferential path in respect to its starting point. A linear, a circumferential PAP constitutes two most conserving mass energy paths of quintessential, core, or natural disposition, each with perimeter boundary respective conforming conditions. A linear or a circumferential PAP of equal boundary conditions, PP lengths least sum, with equal quantum mass equal energy have an equal core, quintessential, perimeter form and vice versa, wherein least or equal is not exact. Globose-conduit and globose-circumferential universe domains of Sets, PAP angle paths constitute a finite linear increment in upright plane with counterpart orthogonal upright plane containing a quintessential core image of highest preserving mass energy natural disposition perimeter. Said image at best is statistical approximations derived with its exact form that is perfection beyond human skill, ability to compute or construct.

A PPLD form defines a conduit perimeter for containment of mass energy modes or mass energy perimeter dissipates into ecosystem, universe mass energy natural disposition boundary perimeter forms.

As with other modes of energy, globose-conduit perimeter forms universe extends from microbes' submicroscopic, atomic subatomic to a cosmos makeup or vice versa. As most conserving mass energy modes exchanges quintessential, core, natural disposition, globose-conduit forms are classic perimeters alongside spherical globose with parallelism to homogeneous mass energy round conductors. As created suitable boundary conditions allow, quintessential, core, natural disposition of mass energy self-conserving, preserving will result in globose-conduit perimeter forms. Unless its boundary perimeter condition, laminar mass perimeter, is maintained, a globose-conduit highest conserving mass energy quintessential, core, or natural disposition perimeter readily dissipates.

Globose-conduit Sets make spouts lower surfaces contained fluid mass-energy one-transformation half-mode cycle, kinetic to potential energy highest conservation and PPLD FESD least height and length forms much shorter than are those of ubiquitous art. A Nozzle FESD form may constitute a part of its End 2 undersurface form.

Spherical globose highest energy modes genome classic forms retain mass units constituting computed least resistance paths, said paths-of-passage, PP, lengths least sum. Inlet inflows provide fluid mass potential, kinetic energy modes with PP energy.

A PPLD width midpoint, said undersurfaces one point align tangentially for a Set of forms having a PAP direction horizontal orientation, PAP upright plane symmetry, and a basin-outlet rotation through a PAP angle in respect to the gravitational direction.

Energy transfers cycle contained potential and kinetic mass-energy modes. PPLD forms least height and length constitute PP least demand for transfer of energy-modes.

Potential to kinetic mode quantum mass transfers constitute units of mass PP three components length. Upright quantum mass-energy units contain the gravity acceleration multiple for computing quantum mass kinetic energy quanta sum that is PP lengths sum.

A fluid mass volume form with a center of mass located at a higher elevation or closer to a DCSS form constitutes quanta-mass conforming form PP lengths lower sum.

An upper retention quanta mass conforming retention constitutes a retained fluid surface-tension, adhesion height higher than a globose End 2, a globose-inverse First End undersurface, horizontal, radial, infinitesimal width highest finite increment.

A lower retention constitutes a region basin-outlet conduit spouts cross-sections forms gradual increase from PPLD width of band forms to said globose End 2, a globose-inverse First End undersurface, horizontal, radial, infinitesimal width highest increment.

A globose-conduit lower retention, smaller, short mass volume unified with a detention, an upper retention, dominant mass volume, least height conserves energy.

Basin-outlets, DCSS, PPLD widths of band, and drain lines smaller lower areas of rounded surfaces and narrower breaths than equivalent round areas breadths at a same rise from respective inverts constitutes FESD forms. Round or rounded cross-sections length segment constituting said PP lengths least sum constitutes an FESD form part.

An outlet FESD rounded cross-section, DCSS sub-outlets First Sub-outlet height constitutes a fluid elevation height that clears fluid mixture largest submerged particle.

A retained fluid mass free surface elevation differences vary with inflows and are enhanced or controlled by composite forms cross-sections of a DCSS or an outlet FESD, and various Sets FESD forms respective areas breadths, breaches, and heights.

Globose forms large lengths and breadths free surfaces areas minimize its rise. Outlet and DCSS FESD cross-sections continue lower area conduit forms through a First Sub-outlet height into larger Second Sub-outlet cross-sections, which also resists fluid free surface further rise conserving energy by transfer of energy-modes at a lower height.

Said PP lengths computed least sum is for statistically compiled particles ranges, volume specific gravity, and shape sizes of mass mixture.

Said Sets PPLD form retention volume “at-rest” is half as tall, of shorter length, and has a smaller to several folds smaller retained fluid volume than ubiquitous art forms.

Conforming embodiments, PAP, PP, PPLD least quantum mass PP lengths least sum mass energy enclosure constitutes interface surfaces least resistance PP, forms. Inlet inflows provide nonhomogeneous, nonuniform, nonsteady contained retained, detained, transported fluid mass potential kinetic energy-modes;

Quantum mass complete complement computed PP are least resistance forms Set.

Genome Sets PP lengths least sum makes conforming retention mass least height.

Globose conduit, globose-conduit, basin-outlet, G-C, cross-sections are made up of a lower smaller area rounded conduit form, a transition region intermediate area form, and an upper area rounded globose form for a compact composite curvilinear form.

A globose-conduits globose area height can vary from about 5% to 95% of entire cross-section height with its globose form area breadth varied up to three times a breadth of a vented pipe to which its conduit outlet descending spout connects.

A least mass half-cycle energy mode change conserves energy and fluid mass.

A least mass energy mode PP lengths least sum change is a Sets genome.

Sets may constitute genomes for specific fluid mixtures, only.

Forms of PPLD band make for PP lengths least sum, least retention, least height side-view “S”, “C”, or “S” and “C” forms, a PAP direction and a least angle, smoothest fluid surface interface forms, from basin lowest PPLD forms ending with a DCSS form.

A PAP makes an angle less than 180 degrees in respect to gravitational direction, entirely aligns Set forms upright plane symmetric from a basin blind side through at least a DCSS, and upwardly entirely to at least include a globose form springing points.

A summit is a DCSS lowest infinitesimal width finite horizontal increment, outlet ascending spouts and PPLD forms highest infinitesimal end furthest from its respective Inlet, and a fluid tension and adhesion height higher than an upper retention free surface “at-rest” elevations retaining conforming continual least fluid mass, volume, and height.

Globose-conduit paths-of-passage-of-least-energy-demand, PPLD, and PAP rotational angles less than 180 degrees that constitute least height basin-outlet PPLD for ascending lowest surfaces highest slopes smaller angles, inherently smaller angles shorter smaller slopes for a shorter entire length, with a smallest conforming retention fluid mass.

Globose-conduit forms constitute domains of generic and circumferential strain hybrids of horizontal and upright orthogonal planes rotated globose genus form; generic circumferential globose hybrid domains are claimed as forms of globose domains.

Migrations of globose Inlets End 2, globose-inverse outlets First End from basin-outlets blind side to an anti-sidelong location on opposite end of basin-outlet retention forms constitutes Sidelong, Sidelong Offset, Offset Centric, Centric, Anti Offset Centric, Anti Sidelong Offset, and Anti Sidelong Sets.

Illustrating and describing a domain Set, entire domain Sets, its hybrids and Sets migrations within entire G-C universe range constituted Sets genomes is claimed together with Sets inventions, principles, methodologies, and concepts for retained fluids mass and energy conserving by globose conduit forms Sets and their circumferential hybrids.

Basin-outlets basin upper retention constitutes largely one of five: truncated about largest cross-sections of globose, spheroidal, ellipsoidal, cylinder, or cylindroid forms of a short height that is shorter than a largest horizontal dimension of a respective basin.

A basin lowest surfaces makes largely one of following large forms: a rounded, an annular, a crescent, an about flat to doming annular, and an annular crescent, among PPLD FESD many geometries of single or various compositions of smaller forms.

An about upright Inlet and basin-outlet retention forms rotated into an upright PAP plane of symmetry by rotating its retained fluid form, and horizontal plane rotated about an upright axis, especially an Inlet upright axis, staying upright constitutes an angled form in its original position.

A basin-outlet conduit outlet spout ascends from a globose Set First End surface inflection, an outlet basin end cross-section, or a globose-inverse submerged spout form lower end inside a basin-Inlet retention of respective globose, globose-inverse forms.

Basin-outlets outlet spout cross-sections are made up largely by one of following FESD forms: a rounded, an elliptical, or a curvilinear geometrics composite areas form.

Outlets, DCSS, and Sub-outlets FESD forms constitute PAP upright plane aligned symmetric a lower, smaller, rounded conduit form, a transition region cross-sections, and an upper largest area largely a rounded, an elliptical, a parabolic or a curvilinear form.

Highly angled Set angle forms from a lower basin to basin-outlet intersections, to then rotate into about an upright upper end Inlet, and rotate a globose End 2, a globose-inverse First End, basin-outlet lowest surfaces close to near horizontal for respective basin-outlets spouts complete complementing, PP lengths least sum forms.

Flow-energy-surface-dispensators, FESD, PAP upright plane symmetric globose-conduit quanta mass, cross-sections, areas, shapes, heights, breaches, or entire breadths, as G-C forms, transform globose to conduit forms and vice versa. They make up conforming quanta mass least volume, rotations, perimeters, and PP lengths sum that constitutes the following forms:

A three-dimensional Set (TD), circumferential, axial or transverse Trough, Ridge, an Inlet upright Ridge a Trough, a Trough in a Trough, a Ridge, a Partition with/without a Window(s), a Troughs-Ridge, a Troughs-Ridge-Partition and a Window(s);

A Circumferential Trough, a Ridge, a Partition, a three-dimensional Window and a Troughs-Ridge and a Troughs-Ridge-Partition and a three-dimensional Window(s);

A Nozzle local highly directional spout forms;

A globose End 2, globose-inverse First End and PPLD counterpart forms of a Set;

A Bridging-Wall with Domed-Cavities about Inlet forms;

A Fin FESD forms dividing globose-conduit cross-sections upper retention;

A Trough, a Ridge, an upright Ridge, a Partition with/without a Window(s), a Trough in a Trough, a Troughs-Ridge, a Troughs-Ridge, a Troughs-Ridge-Partition with/without Window(s) upright plane axially symmetric forms;

An FESD manager enhanced control of fluid free surfaces height differences;

An FESD space manager exchange of air and fluid manages retention form free surface areas and elevations, thus cross-sections areas, height, breadth, breach and length;

Cavities; dome Cavities FESD;

A rounded End 2, First End; a flared; an infant boot; a Fin End 2 FESD form;

A Migration Dimension(s) 44, (44,44′);

A crescent PPLD conical form FESD;

Outlets, DCSS and globose-conduit cross-sections areas breadth, breach, and height FESD forms managed effects of retained fluid free surface elevations, elevation differences, as counterparts of FESD mangers' and FESD space managers' forms.

Flush Apparatus parts, entirely contained within walls of a Set with access to most Set's locations, separately or concurrently disinfect, flush, surface coat, repair or protect damaged surfaces. Flush Apparatus prefabricated pre-assemblies use design fluids and or gases, or air, jointly individually or, to a separate sequence and intervals or concurrently, to a surface location or entire Set with a single, a set, or a nozzles network, with tie-ins, or sets of tie-ins located conveniently about a Set.

A double wall inner space and gravitational direction compliant tubing show and warn expeditiously by dripping leak evidence that a wall failure has occurred.

Said Sets exact globose-conduit construction is beyond human creative skills.

A descending outlet spout Second End connects to a vented drainage line with a positive rigid connection, which is one of two connections that support a Set.

Connections are generally shown threaded or welded. Compression couplings and flexible installed in place rigid with or without gaskets, washers, or bushings, and locked or double treaded or said connections suitable mix constitutes globose Set connections.

A top quality highest accuracy highest pressure moldings of plastics, metals, and their composites and or semi-rigid materials that are adequately rigid or are with positive provisions for sufficient stiffness or a fabrication combination of above makes said Sets. One-way air nozzles are suction precluding measures. Forms constitute smallest mass and height known to stop suction and or venting. Forms are to crafts finite or scientific infinitesimal accuracy algorithm computed as needed.

Fluids and solids particles non-homogenous mixtures inflow through an End 1 into globose Set forms and by gravity force outflow through an outlet Exhaust.

Inventions restricted only to the highest conservation of fluid mass or energy genomes disclosed narrow highly defined scope of fluid mass, and energy conservation of the inventions, which unify fields of arts and sciences. This and continuation applications continue the first application specification and drawings scope narrowed to fluid mass energy conservation by defined globose retention genus forms and the first application FIG. 9 “laminar flow” and its stated description and specification “flow control means” herein FESD forms. Globose-conduit Sets originate with the first application open channel Set of FIG. 1-2. Globose-conduit forms said short height, in respect to figures length, is especially short for the first application FIG. 1-2 Set that connects to building code vented pipe constituting open channel construction. Its elliptical outlet descending form spout and channels about basin originates outlet FESD and DCSS FESD forms Figures herein show. The first application FIG. 1-2, 9, 12 stated “transition region” “means” that maintains “the transition region submerged” herein and continuation application numerous Figures define as upper, herein permanent retention extended upwardly from lower conduit form springing points and not taken higher than globose form springing points.

FIG. 1 Set of basin-outlet nonhomogeneous, nonuniform, nonsteady fluid mass forms, modifies said classic retention genome prior applications FIG. 1, shows globose-conduit parent form that uniquely originates globose-conduit universe domains of Sets. Each of said Sets retains, contains, detains, and transports fluid mass that subdivides into finite units of mass having said PP lengths least sum. Units of mass, PP length least sum algorithm, mathematically computes kinetic energy required for each mass unit to pass. Said least sum constitutes mass units times respective path lengths of entire fluid form with upright components having gravity multiple.

Shown Figures of this application are the second application drawings. Said Figures show open channel forms and are continuation from the first application Figures, especially said FIGS. 1-2, 9, and 12. Basin-outlet continuations of FIGS. 1-2, and 12 shown major axis upright elliptical outlet and DCSS FESD forms and a Trough, a Partition, and a Trough, a Ridge, a Partition of FIG. 12 and FIG. 9 shown upright Ridges, nozzles and diffuser FESD forms. Said FIG. 12 basin-outlet, globose-conduit forms show a capped tubing about basin blind side through upper basin-outlet casing. Enlarged, streamlined, said tubing constitutes a Bridging-Wall FESD, which with globose basin-outlet makes for domed Cavities FESD forms about Inlet. Capped at a specific detained fluid free surface elevation said tubing constitutes a space manager, SM, in respect to retained fluid free surface elevations. Said SM not capped but connected to a one-way air inflow having basin-outlet perforations constitutes SM that precludes suction.

FIG. 12 Set basin-outlet spout constitutes much larger cross-sections than those of a vented pipe and thus will not experience suction. SM outside air inflows connected to a Flush Apparatus is both, a Flush Apparatus and SM, and said perforations extended through walls of said Set constitute numerous Flush Apparatus assembles parts said continuation applications and herein Figures show. Globose-conduit computed classic cross-section areas, perimeter, surfaces interface boundary forces, and centroid locations for least or no rotations about fluid mass centroid constitutes said “flow control” mass and energy highest conservation.

Said classic perimeter PP mass laminar fluid finite segments constitutes viscosity, adhesion, fluid pressure internal and boundary layer related forces with no rotation of fluid mass, which is identical for homogeneous mass-energy. Classic perimeter globose-conduit nonhomogeneous mass energy forms with parallelism travel across arts, science fields analogous to classic, homogeneous, mass energy round forms. Classic perimeters mass no rotations or boundary friction constitutes translational energy mode ultimately conserved mass energy.

Ascending globose-outlet spout Sub-outlets make either a rounded, or an elliptical major axis upright, or a curvilinear cross-section area form that passes statistically most prevailing continual detention mass with detention free surface at said essential elevation height that also passes said largest sphere as single most unusual event. Globose-conduit classic forms constitute classic conduit forms that evolve or devolve from classic globose retention basin forms that also evolve or devolve into rounded, or curvilinear, or elliptical major axis upright forms. The first application FIGS. 1-2, and 12 cylindrical basin globose form constitutes cylindrical globose-conduit forms upright cross-sections behind, in front of its Inlet toward outlet, which transfer into elliptical major axis upright transposed into round Exhaust cross-section that are open channel forms applications, herein, continued.

Said generic claims fluid mass energy self-conserving self-preservations allow for computed accelerated aging whose energy modes among depicted Figures or as described constitute scope of inventions, methodologies and principles of globose-conduit forms. Classic globose-conduit spout rounded basic PP lengths least sum forms surfaces, a life span aged forms, or a specific event forms make up universe of globose-conduit forms. Least globose-conduit Set of basin-outlet contained fluid mass including an Inlet, and contained entire fluid mass rotate in space transposing mechanics of forms thus make globose-conduit universe strains, domains, Sets including partitions, hybrids, mutations. FIG. 3-5 Inline domain Sets primarily make up globose-inverse domain forms that with described mutations and partitioned into multiple-cells transfer into globose domain Sets. FIG. 1-2, Section A-A forms with shown ascending outlet spout rotated to 165 degrees PAP angle with a DCSS, descending upright spout as shown in FIG. 3 transposes globose-conduit Sidelong Set to one cell of said Partitioned Inline Set, which reassembled into a globose-inverse Set constitutes depicted Inline forms. FIG. 19, an Industrial Set of forms clockwise rotated to PAP angle of about 127 degrees by described universal joint rotation connection for End 1, transforms into Low PAP angle domain Sidelong Centric Set of highly angled forms, that does not include a descending spout holding Chamber. Said Industrial Set as one DCSS curvilinear form without Sub-outlets curving parts with an upright descending outlet spout transposes into said one cell Set of said Inline domain of forms. Said Industrial Set one cell Inline forms Inlet, basin, outlet ascending spouts that make a common surface of said double wall with a donut form hemispherical descending outlet spout, holding Chamber described with Industrial Set constitutes a hemispherical outline shown by Inline domain forms. Said Angled domains described rotations for a Set of forms constitute reference to deviations from upright forms.

Classic globose-conduit, FESD complete complement of forms constitutes cross-sections, breadths, fluid mass least rotations, least permanently retained fluid mass, least perimeter breadths interface surface lengths, for energy modes least mass-energy transfer. Hydrostatic pressure centroids of basin-outlet nonhomogeneous fluid gravity segregated, transported mass is more than ⅔ of a height below retained fluid free surface elevations.

Fluid mass inflows outflows PP lengths least sum of classic globose-conduit open channel forms complete complement is least upright distance from PPLD forms highest elevations to largest fluid free surfaces for retention with detention hydrostatic pressures.

Conduit Inlets, basin-outlets open channel classic Sets constitute least height, least retained, most detained transported fluid mass that preclude suction and or venting, least height forms, a PP lengths least sum, with conduit outlet spouts narrow lower breadths.

Globose-conduit open channel forms complete complement contains conforming quantum mass PP lengths least sum that transports quanta mass with a much shorter PP lengths sum than ubiquitous art forms, for rare events or to preclude a retention suction.

Outlet, DCSS FESD forms open channel hydrostatic pressure release is fluid mass path of least resistance, first application FIG. 9 Page 13, Line 1 “laminar flow” and Line 3 “flow control”. Nonhomogeneous fluids solids open channel genus classic perimeter of mass energy forms highest conservation genome forms with mass units PP lengths least sum has at least among variables specific gravity, highest elevations of entire length least height with classic breadths or breach, surface friction, FESD forms in gravity force field.

Classic globose-conduit open channel forms for nonhomogeneous fluid mass by PP lengths least sum computation, fluid mass path of least resistance, transform, transfer into highest energy, classic nonhomogeneous, natural disposition of hydrostatic pressure, least retained, mass-energy perimeter forms.

Globose-conduit forms transfers into known, classic mass energy forms confirms they are of classic genus. Conduit lowest surfaces rounded forms with PPLD horizontal width of band reflects upon nonhomogeneous high specific gravity fluid mass, sizes of largest solid particles, among other physical parameters. Globose upper surface forms reflect upon nonhomogeneous transport fluids physical parameters and cross-sections area required. Cross-section breadths especially transition region breadths reflect upon a nonhomogeneous retained mass least height form highest mass and energy conservation.

Elliptical horizontal major axis as fluid energy geometrics forms are subordinate to globose, rounded conduit forms and except for curvilinear forms parts do not normally make up FESD forms except for preference by these very applicable specific exceptions:

A basin lowest surface part under a globose End 2, a globose-inverse First End;

A conduit form of highly homogeneous frictionless, adhesionless fluid surfaces;

A globose-conduit FESD curvilinear “crown” form that reduces forms height;

A part of curvilinear specifically applied outlet, DCSS, and Inlet FESD forms.

Forgoing excludes entirely round forms that constitute parts or counterparts of PP lengths least sum FESD, and homogeneous, adhesionless, no cohesion fluid mass forms.

The first application FIG. 12 globose-conduit Set shown slanted circumferential channels inside basin discloses globose-conduit forms cross-sections behind and in front of its Inlet. Also shown are circumferential channels multiple passages that make trough, ridge, and partition FESD forms. FIG. 12 outlet elliptical cross-sections near summit is nearly entire height of a basin upright cylindrical globose form that toward basin blind side widens then narrows with globose upper part progressively shorter in height. With a First Sub-outlet short, less than a lower half of said elliptical cross-section height that for globose forms height large breadths makes up cross-sections areas numerous forms that can match or greatly exceed cross-sections area of aforesaid vented pipe. Said globose cross-section areas that are greater or that greatly exceed a vented pipe cross-sectional area are a part of globose-conduit Sets universe constituted basin-outlet numerous forms.

Flush Apparatus tie-in assemblies with check valves can act as a controlled air and or design fluid inflow into a Set to counter suction through said single or networks of nozzles or sense a low basin fluid level to start pumping air and or design fluid. Flush Apparatus design-fluids adept usage approximates near frictionless surfaces.

Forgoing describes ways to avoid suction. Tie-in apparatus to Flush Apparatus to control suction toward conservation of energy by one-way air inflows at fluid elevation and pressure below free surface “at rest” elevation is to start various air, fluid, and spray flushing when said level and pressure are low. Said Flush Apparatus is shown with the first application separated branch inlet 12′ tube. Herein, it is considered support apparatus assembly for conservation of fluid mass and energy. A branch inlet enlarged to bridge a basin blind side, Inlet breach makes a Bridging Wall FESD, or specific location placed, orientated an manager, space manager FESD form continued from the first application. Said FIG. 12 upright symmetrical cross-sections are globose conduit cross-sections of cylindrical form herein continued globose and cylindrical globose-conduit forms. Said globose-conduit form constitutes said Partition, Ridge, and Trough forms, wherein said sloping channels toward discharge increase upper globose form part, which is appropriate for drainage pipes and sewer lines construction. Granted patent shows a flexible drainage line with degrees of freedom generally unimpaired, a much smaller cross-sectional area, a narrower PPLD width of band close alignment to a linear PAP inherent of a laminar flow and flow control means for it. Said patent did not identify drainage line various varying shapes various end connections suction or venting. As constituent Set of said globose conduit universe the forgoing does with specificity either as a sewer line or a drain trap. Said FIG. 12 separate branch inlet, 12′, tube through basin's blind upper casing to proximity of basin lowest surface continuation applications Flush Apparatus accounts for its numerous functions with design fluids and gases including air. With its cap removed said branch inlet constitutes a Flush Apparatus tie-in and a major passageway, which can branch out inside walls of Sets for single or complex and advanced nozzle assemblies FIG. 13, 13a among other Flush Apparatus shown assemblies. Said tube larger size with nozzles constitutes bridging-wall FESD equipped with Flush Apparatus assemblies.

Said PP lengths least sum computed cross-sectional areas is algorithm computed statistical probability that solids and fluids mixture samples and elevations retention free surface probability combine into a statistical probability of both constituting frequency of occurrence bounded by standard deviations. Under said deviations among computed and actual conditions, Flush Apparatus penetrations do no effect primary functions of a Set.

This application is continuation from the first application filed Oct. 15, 1997 and first of Provisional Applications 60/123,153, FIGS. 1-115 filed Mar. 6, 1999 that “ . . . lead to, cause low energy demand, least amount of energy needed to pass the waste”.

The invention principles are susceptible of many different forms, which the drawings illustrate and specifications describe and invention samples disclose and are not limited to the illustrated examples. Having a drawing, one could make modifications or vary figures of the same without departing from the scope of the inventions.

### BRIEF DESCRIPTION OF DRAWINGS

FIG. 1 of the drawings is a side elevation cross-sectional view of angled near upright, basic sidelong globose forms Set inventions;

FIG. 1a of the drawings is a sectional view taken generally about line A-A of FIG. 1;

FIG. 2 of the drawings is a side elevation cross-sectional view of another angled near upright, basic sidelong globose forms Set inventions, showing several FESD forms;

FIG. 2a of the drawings is a sectional view taken generally about line. A-A of FIG. 2;

FIG. 3 of the drawings is a cross-sectional side elevation view of angled near upright Inline Centric globose forms Set inventions;

FIG. 4 of the drawings is a top view of a FIG. 3 invention;

FIG. 5 of the drawings is a cross-sectional side elevation view taken generally 90 degrees oriented from FIG. 3 cross-sectional view;

FIG. 6 of the drawings is a cross-sectional view shown in FIG. 5 angled near upright Inline Centric globose forms Set inventions showing a Flush Apparatus assembly invention;

FIG. 7 of the drawings is a cross-sectional side elevation view of angled Anti Sidelong globose forms Set inventions showing a Flush Apparatus assembly invention;

FIG. 8 of the drawings is a cross-sectional side elevation view of angled Centric globose-inverse forms Set inventions showing a Flush Apparatus assembly invention;

FIG. 9, FIG. 9a, FIG. 9b of the drawings is a cross-sectional view of basin Filler Members, 141, 143, 141, inventions shown respectively in FIG. 7, FIG. 8, FIG. 16 globose Sets inventions;

FIG. 10 of the drawings is a cross-sectional side elevation view of angled Anti-Sidelong globose forms Set inventions showing a Flush Apparatus assembly inventions;

FIG. 11 of the drawings is a cross-sectional side elevation view of angled Globose-inverse Centric forms Set inventions showing a Flush Apparatus assembly inventions;

FIG. 12 of the drawings is a cross-sectional view of a basin Filler Member 344 invention shown in FIG. 11 inventions;

FIG. 13 of the drawings is a cross-sectional view of a basin Plug (Capping) Member assembly of the globose genus forms inventions showing a Flush Apparatus assembly for near upright Sets such as shown in FIG. 19;

FIG. 13a of the drawings is a top view of basin-outlet basin lowest surface of a Plug or (Capping) Member of FIG. 13 inventions;

FIG. 14 of the drawings is a cross-sectional side elevation view of angled Anti Sidelong globose forms Set inventions with Flush Apparatus assembly inventions;

FIG. 15 of the drawings is a cross-sectional side elevation view of angled Globose-inverse Sidelong Set inventions and Flush Apparatus assembly inventions:

FIG. 16 of the drawings is a cross-sectional side elevation view of low-angled Globose-Anti-sidelong Cylindrical Set inventions showing Inlet Offset Anti-sidelong location inventions and Flush Apparatus inventions;

FIG. 17 of the drawings is a cross-sectional side elevation view of low-angled Globose-inverse Centric Cylindrical Set of forms inventions showing an Inlet Offset Anti-sidelong form including Flushing Apparatus assembly inventions;

FIG. 18 of the drawings is a cross-sectional elevation view of Globose-conduit, G-C, Set of forms inventions;

FIG. 19 of the drawings is a cross-sectional side elevation view of Globose Industrial Centric Cylindrical forms Set inventions showing Flush Apparatus assembly inventions;

### DETAIL DESCRIPTION OF THE DRAWINGS

The invention principles are susceptible of many different forms, which the drawings illustrate and specifications describe and invention samples disclose and are not limited to the illustrated examples. Having a drawing, one could make modifications or vary figures of the same without departing from the scope of the inventions.

This application is continuation from the first application filed Oct. 15, 1997 and first of Provisional Applications 60/123,153, FIGS. 1-115 filed Mar. 6, 1999 that “ . . . lead to, cause low energy demand, least amount of energy needed to pass the waste”.

Conforming embodiments continue as the first application specification, drawings “laminar”, “flow control”. PAP, PP, and PPLD geometrics make quantum paths surfaces interface forms conserve transported useful energy modes. A globose-conduit is such a form. Generic claims: PAP, path-angle-of-passage; PP, paths-of-passage; PPLD, path-of-passage-of-least-energy-demand, conforming-embodiments, the second application and the Amendment and Communication Response dated Aug. 11, 2000, Pages 50-55 define.

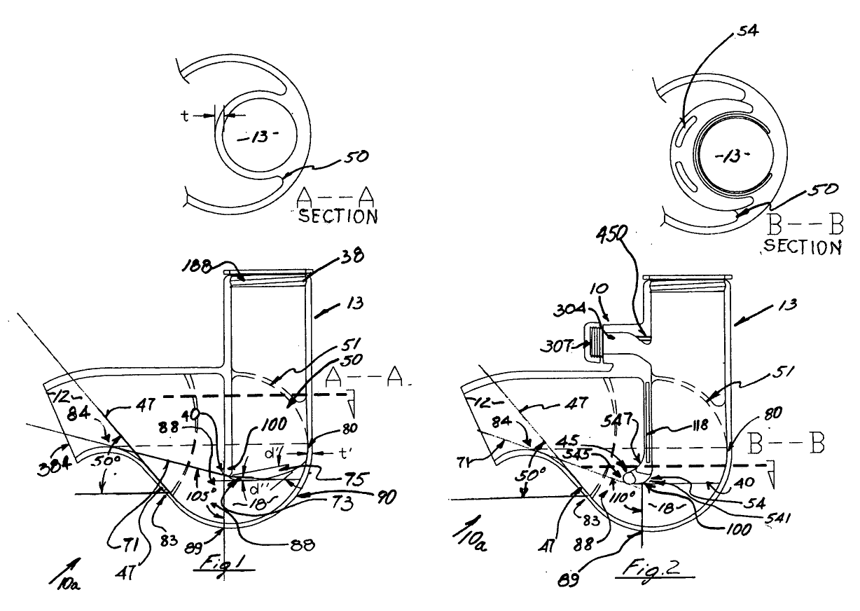

The first application first paragraph most broadly specifies containment forms of mass-energy. The continuation applications provide globose-conduit as a least Sets of contained, retained, detained and transported mass energy, figures illustrated inventions, principles, methodologies of most self-conserving, preserving mass energy quintessential, core, natural disposition, classic forms. Continuation applications mass-energy boundary as least mass forms is inside the first application, first paragraph fluid mass perimeter to arrive at classic perimeter forms of globose conduits. Nothing is added. The applications continuations depicts, describes unique genome form as origin of classic globose conduit Sets, also represented by the FIG. 1-2 of the first application that is extensively depicted, specified further with the continuation applications. Origin of listed FESD, flow-energy-surface-dispensators, for continuation applications, from the first application and entirely the second application illustrated, detailed is described toward the end of this introduction to drawings, henceforth as classic globose-conduit perimeters Mechanics of Forms.

Nonhomogeneous, nonsteady, nonuniform is an inflow mass-energy composition, a perimeter refers to globose-conduit cross-sections area boundary. Mass-energy, mass energy, unless stated otherwise refers to globose-conduit quantum, quanta contained fluid mass energy. Globose-conduit units of mass, quantum, are contained continually; also, transported, retained, contained mass of transported, contained, retained, detained, phases of mass energy. Quanta mass contains varying phase's amounts in variable percentages. Contained mass-energy inside globose-conduits open channel vented forms stratifies by specific gravity under atmospheric pressure. Globose-conduits core mechanics of forms make up this introduction to the drawings, which extends and is detailed description of the drawings part.

A containment boundary controlled, contained, retained, detained, transported air, gas, fluid nonhomogeneous, nonuniform, nonsteady mass-energy constitute a list PPLD widths of band, a lower conduit perimeters, and a contained fluid heights at a modes of energy phases highest sum constitutes globose-conduit forms.

Modes of energy phases sum with internal, especially boundary perimeter least rotations constitute globose-conduit universe, domains, classic forms Sets, or genomes.

Generic PAP, PPLD, PP lengths sum, conforming embodiments, evolve or devolve globose-conduit forms into round or entirely round conduit cross-sections and or globose spherical or spherical retained mass forms that rotate, mutate, transpose, transfer, make unique origin universe highest conserving mass energy phases, Sets, and domains.

A globose confines, retains, transports; a lower conduit confines, transports; and a detention least confines, transports constituted mechanics of forms mass energy phases.

Core mechanics of drawings, mechanics of forms, FESD forms, Flush Apparatus inventions, principles, methodologies highest quantum mass-energy quintessential, core, natural disposition globose-conduit classic perimeter forms with the following summary:

A. Microbes' submicroscopic, atomic subatomic to cosmos makeup as described;

B. Craft's ordinary scale implemented inventions, principles, and methodologies:

a. Inflows nonhomogeneous, nonsteady, nonuniform mass-energy stratifies with:
3. A globose-conduit detention, upper retention least transport fluid height;
4. Heaviest fluid topside, inside narrowest PPLD widths, conduit breadths, gravity separated nonsteady, nonuniform mass energy into following;

b. Detention one length, globose largest free-surface form steadies nonuniform, nonsteady mass energy with uniform atmospheric, detention pressures to a DCCS.

c. Narrow PPLD widths, forms' breadths confine heaviest fluid mass with:
4. Heaviest fluid mass modes of energy at highest elevations;
5. Confined heaviest fluid mass centroid raised by narrow breadths;
6. Mass-energy rotations, modes of energy losses minimized;

d. Mass-energy entirely inflows into a globose-conduit conduit contained mass;

e. Mass-energy mass inflows are topside PPLD forms surface into heavy fluid:
6. Separating, tearing, breaking, releasing heaviest fluid particles;
7. Heaviest particles that are narrow PPLD widths confined:
   d. With natural fluid mass quintessential, core, disposition forms;
   e. Displaced contained mass, by or with FESD surface forms;
   f. Heavy fluid mass least perimeter least adhesion friction losses:
      4. Least cross-sectional area;
      5. Least friction coefficient
      6. Inflows mass-energy centroids is below a heavier mass centroids computed for;
         c. Mass-energy, perimeter friction, and adhesion least losses;
         d. Centroids alignment rotations that tend to lift heavier mass;
      4. Flush Apparatus are adeptly fitted into globose-conduit forms;

i. Most of steady inflow outflow fluid mass is through a conduit form:
e. PPLD PP of a DCSS First Sub-outlet have highest mass velocity;
f. Inflows are entirely through a conduit Inlet;
g. A DCSS FESD form First Sub-outlet discharges continual outflow;
h. Rare, unusual events fluid passes through a DCSS globose form;

j. Most of energy modes losses occur with a lower one-half of lowest conduit:
6. Manipulations of cross-sectional areas forms minimize mass rotations;
7. Upper retention mainly a transport fluid has least or no friction losses;
8. Most energy loss occurs between lowest conduit springing points that extends from under an Inlet through an outlet DCSS to an Exhaust;
9. A PPLD form is at highest elevations in respect to its Inlet End 1; An End 1 is higher than a globose-conduit as a safety factor, convenience;
10. Shrunken PPLD is least height and length conforming:
   d. PAP least angle, with best alignment and symmetry;
   e. Least contained mass, least perimeter losses, PP lengths least sum;
   f. PP lengths least sum inventions, principles, methods, FESD forms:
      5. With algorithm computing up to smallest elements;
      6. Entire quanta subdivided mass computed PP lengths;
      7. With graphical prototypes scaled measurements;
      8. With laboratory testing confirmations;

k. Mechanics of forms mass-energy absolute highest conserving globose-conduit perimeter forms, conforming rotation least fluid mass classic genome Sets:
6. Mass least retained mass-energy globose, spherical form;
7. Retained mass-energy least surface perimeter globose, spherical form;
8. Least surface perimeter friction, adhesion mass-energy losses;
9. Heavier mass least retained mass-energy rounded conduit form:
   f. With statistical analysis of heavy fluid mass-energy inflows, rate;
   g. With conformance to PPLD width of band and length forms;
   h. Retained mass-energy least surface perimeter conduit form;
   i. Least surface perimeter friction, adhesion mass-energy losses;
   j. Amalgamated with upper retention that is mainly a transport fluid;
10. Least PAP angle, PP lengths, sum of, PPLD height and length forms;

i. Universe of Globose-conduit mechanics originated from unique genome form:
2. Retention genome graphical intellectual, inclusion, exclusion shown:
   c. Illustrates Retention unique genome of globose-conduit forms;
   d. Unique genome form originates universe domains;
2. Globose-conduits evolve or devolve conforming-conduit forms contained least mass into out of globose, spherical contained mass retention least surface form;
8. Amalgamated globose-conduit forms rotate, mutate, transpose, transfer to contain, retain, detain and transport highest conserving mass-energy modes made up of mass-energy contain, detained, transferred phases;
9. Globose conduit forms manipulated cross-sections areas manipulate raise a smaller heavy fluid mass centroid ahead of larger transport fluid mass, or vice versa detain transport fluid to pant-up hydrostatic pressure heavier fluid mass fluid mass confined discharge four times;
   d. Under an End 2 undersurface a least height separated from a PPLD lowest surface form at highest elevations;
   e. With gradual devolution from a globose to a rounded, or called for by statistical analysis of fluid mass composition, rate to a curvilinear globose-conduit conduit perimeter transition form;
   f. With a DCSS form First Sub-outlet conduit form with a higher energy, smaller heavy mass pushed ahead of a much larger globose detention transport fluid mass; A forth time is with Industrial forms DCSS areas manipulation with transport fluid discharge through Second Sub-outlet;
10. Globose-conduits are classic perimeters alongside globose, spherical, with parallelism to homogeneous round conductors as described;
   b. A globose-conduit's globose area height vary, from about 5% to about 95% of entire cross-section height, with its globose breadth up to many times greater than a vented pipe to which it connects (the first application shown up to three times greater).

Inventions, principles, methodologies quintessential highest self-preserving, self-conserving, core, natural mass energy modes dispositions is globose-conduit universally manipulated forms, Sets, and domains that constitute unique origin universe is as follows:

Quantum mass conforming PAP, PP, and PPLD energy demand self-preserving, self-compliance to mass energy, omnipotent force fields makes Sets' conforming forms. Globose-conduit energy conserving constitutes universe of conformed forms Sets, herein. Controlled vented gas, air as a fluid mass inflow, outflow into out of open channel forms.

Globose-conduit classic cross-section areas, perimeters, surface interface forces at boundaries, and mass centroids respective locations are computed for least or no rotations about fluid mass constitutes said “flow control” mass and energy highest conservation.

Basin-outlets least Set includes Inlet forms inside, a conforming retention mass, a globose form transported detention, and said Inlet fluid mass outside of said basin-outlet. Continued first application FIG. 1-2, 10-12 versions show conduit Inlet least height that is barely outside of a basin upper casing. A conforming and a detained fluid mass make up, retention mass. The former precludes venting or backups, the latter moves mass. Fluids free surface essential elevations pass largest size submerged particle through a First Sub-outlet and DCSS forms.

Inlet inflows provide paths-of-passage, PP, mass potential, kinetic energy modes sum. An Inlet End 2 separation from a PPLD form barely exceeds largest particle sizes. For drain traps, a globose End 2, a globose-inverse First End undersurface lowest point elevation is globose conduit springing points' elevation.

Transition region cross-section areas are from conduit to globose springing points. Cross-sections fluid structure interface perimeter are two symmetrical smooth curvilinear lines which connect lower conduit upper globose cross-section perimeter springing points ranging from a rounded cross-section to a globose area having springing points breadths a multi order magnitude wider than those of its counterpart conduit form springing points.

FESD forms within transition region make up permanent retention conduit forms, wherein permanent retention is a mass-volume that precludes venting of gas or backups.

Transition region fluid mass least rotations computed viscosity least friction, least breadth or height cross-section area forms having highest conserving modes of energy are listed FESD forms that seamlessly convert classic globose retention into conduit forms.

Generic claims' PPLD forms constitute a part or a counterpart to FESD forms.

Globose-conduit forms evolve or devolve into globose classic conduit retention as forms of original, unique globose universe genome transformed retention, detention Sets classic forms having surfaces slopes, transition region forms complete complement, with shallow slopes for retention or steeper slopes for detention forms. An End 2, a First End form, counterpart undersurfaces to respective basin-outlet forms, surfaces constitute fluid mass radial complete engagement of entire basin-outlet quantum mass, energy modes.

For purposes of presenting describing, depicting the following free falling fluid mass has an entire End 1 cross-sectional area without constituted hydrostatic pressure.

Globose-conduit conduit springing points constitutes an elevation no higher then conduit entire height. Rounded conduit forms may make a Trough, a Trough inside a Trough, or Troughs inside Troughs curvilinear forms, a Ridge, a Partition FESD lowest surface forms with sides slopes constituted transition region forms complete complement.

Especially Trough(s), Ridge(s) including upright, Partition(s), or indented Ridges as turning veins Troughs, along with End 2, First End basin lower surfaces, side surfaces includes Dimensions 44 spaced counterparts among listed FESD forms, for PAP upright plane symmetric fluid mass radial outflow, inflow into a basin-outlet. Ordinary trades or crafts fabrication scale to arts sciences microscopic near infinitesimal units of mass FESD forms complete engagement of globose-conduit retained, detained fluid mass constitutes a range of FESD forms complete complement. First and foremost globose-conduit forms constitute open channel conduit forms that contain, retain, detain and transport fluid mass energy with highest conservation of both, including rare events such as high hydrostatic pressures, a hundred year, or once in a lifetime storms.

For a PPLD form slope rise, in tandem, increases its area form side surface slopes into narrower breadths that with cross-sections height narrows transition region breadths, giving upper retention, globose form breadths curvilinear or elliptical upright major axis forms. Forgoing algorithm computing methodology carries out to a highest computational accuracy cross-sectional areas and perimeter fluid mass forms for least or no entire fluid mass rotations in PAP upright plane toward highest conserving of mass energy modes. A PAP upright plane horizontal orientation in space constitute absolute symmetry of forms up to DCSS springing points elevations having least or no detrimental retained, detained, transported fluid mass rotations constitutes in PAP upright plane symmetry said “flow control means” laminar fluid mass.

Globose is gravitational field energy modes, classic containment. Spherical, globose highest energy modes genome classic forms retain mass units constituting computed least resistance paths, said paths-of-passage, PP, lengths least sum that here applies to retained, detained, and transported nonsteady, nonhomogeneous, and nonuniform mass. Conduit forms must exist for transfer of energy modes. Generic claims PAP, PPLD, PP with PP lengths least sum, defines confined mass modes of energy transfer self-conservation with units of mass PP of least resistance make up of basin-outlet classic globose-conduit forms conformed embodiments, Sets. Said PP lengths least sum computes open channel fluid said centroid locations and least height classic forms for retained and transported fluid mass with least or no rotation forms, for ordinary design use, with infinitesimal elements designs for scientific purposes. Practical construction purposes, crafts finest tolerances constitute said finest units, least mass, lowest surfaces, slopes, shortest or least height, length, and said stated required construction implements stated principles that conserves fluid mass and energy.

Each breadth different width above PPLD width of band highest elevation makes on infinitesimal scale a stair step like change. A step constitutes summation of mass units widths that make least resistance paths of least elevations derived by said PP lengths least sum. Forgoing statistically compiled fluid mass properties, especially specific gravity of particles, into curvilinear forms computing methodology for influx of units of fluid mass constitutes each mass unit path of least resistance that algorithm amalgamates into entire mass PP with lengths least sum. Units of mass PP lengths least sum makes lower cross-sections a viable conduit area with a perimeter form. By definitions, inverts of globose-conduit forms, PPLD width of band horizontal segments, constitute highest elevations. A horizontal chord, breadths at respective elevations, by PP lengths least sum computing is a least transfer of kinetic to potential mode of energy, highest conservation for fluid mass and energy. Rising PPLD widths with length constitutes potential energy increase, while descending PPLD cross-sections respective breadths, conduit horizontal chords, lowering of elevations with length is potential to kinetic mode transfer highest energy conservation for statistically compiled fluid mass and energy composition. Foregoing methodology for cross-section areas, perimeter computed forms effects least fluid mass rotations in a PAP plane of symmetry, which requires exact areas and perimeter forms with length. With no PAP upright plane rotations, units of mass moves are confined by surrounding units of mass at respective elevations or move down, up governed by mass units' specific gravity. In chords, breadths, horizontal planes units of mass are confined by surrounding units of mass eventually confined by cross-sectional area form perimeter form which implements least or no rotations in PAP upright plane of symmetry, least or no rotations in horizontal planes for no fluid mass energy influx changes. Said changes require at least a change in retention free surface elevations and that also require areas, perimeter change effected by aforesaid computing for highest probability statistical fluid mass influx, outflow balance. This requires a continual slight narrowing of conduit forms lengthwise breadths with an even smaller transition region breadths increase toward a DCSS or next Inlet fluid mass influx, which constitutes immaterial change for crafts, trades fabrication. Upper globose and transition region cross-sections computed similarly makes complete complement of forms that constitute cross-sections classic areas and classic perimeter of entire globose-conduit Set of nonhomogeneous, nonuniform, nonsteady fluid mass FESD forms.

A PPLD constitutes globose-conduit unit of mass lowest path of least resistance for said globose form least retention mass, least fluid mass height conduit form highest elevation highest conservation of fluid mass energy conversion from kinetic to potential mode. Gravity force pulls higher specific gravity particles toward a path-of-passage-of-least-energy-demand, PPLD, with lighter particles moved to equal or low specific gravity mass higher elevations. Confined by narrowing of a globose, conduit ascending spout, heaviest particles are squeezed into a PPLD narrowest width highest slope single largest sphere that just passes through said spout rounded lowest surface area cross-section that is said PP lengths least sum FESD form. Surrounded by highest specific gravity transport fluid mass of highest viscosity said largest sphere pushed in back pulled by transport fluid drag while allowed to rotate in PPLD direction toward summit without rotations of entire fluid mass. Sub-outlets, First Sub-outlets, detention fluid free surfaces essential elevation height is said largest sphere passing through Sets submerged height, elevation at summit.

An End 2 undersurface is located at about one half of upper retention depth that with a free fall locates inflows mass centroid into a lowest ¼ of a basin retention depth. Ignoring viscosity friction, adhesion, at a DCSS form, velocity of water at depths below a fluid free surface equals the square root of twice gravity acceleration times a fluid depth. High specific gravity inflows, outflows fluid mass is entirely through lower conduit form of globose-conduit cross-sections. Globose-inverse First End located about one half of basin retention depth is entirely consistent with said heavier mass inflows, outflows.

Ordinary fluid mass retention outflows are mostly through a lower small conduit cross-sectional area of a globose-conduit composite, ahead of a larger detention mass. Unusual, out of ordinary fluid mass outflows pass through globose cross-sectional forms.

Heaviest mass centroid short height to a summit is most mass energy conserving. A globose-conduit shallowest retention also has heaviest fluid mass most raised centroid.

Globose-conduit least conforming retention mass of least height of least rotations is least magnitude potential, kinetic exchanges of energy modes. Kinetic potential energy mode exchange has rotational friction and viscosity losses. Compared to round or similar piping, globose-conduit Sets forms complete complement amalgamated, least mass, least conforming retention, least rotations multi raise retained mass centroids, PPLD forms to highest elevations for modes of mass energy highest conservation. Less is more; more is less; less energy transferred conserves mass, energy either one or both. Least rotations of least mass centroid at highest elevation a least height from fluid free surface set at highest elevations have Sets' forms highest conserving mass modes of energy. Narrowest conduit breadths move heaviest fluid mass higher into entire cross-sections form, raising its mass, area, perimeter centroids to highest elevations matched by globose breaths, PPLD forms, fluid mass highest elevations, energy modes highest conserving.

Least fluid mass least rotations constitute least rotational frictional, viscosity loss higher potential, kinetic energy exchanges magnitude, mass energy highest conservation. Globose-conduit conforming detention least height globose largest breadths, lengths raise entire mass centroid elevation eight times. Once for each of four horizontal direction that is in unison with the other three, repeated again four times for conforming globose mass retention at rest, with fluid free surface elevations as the governing reference for kinetic, potential modes exchanges least energy demand with PPLD forms at highest elevations. As a system amalgamated globose-conduits raise fluid mass centroids three times; once for each globose conduit forms raised mass centroids, once for highest PPLD elevations.

Globose-conduit sewer lines detention, basin-outlet least mass conforming retention has fluid mass centroids rotations least distance from fluid free surface, which makes for highest conserving mass energy modes balanced exchanges that inflicts a least abuse or damage to earth's ecosystem mass energy balance, as follows: Energy balanced modes for least mass least rotations conserves mass energy;

Detained larger mass at insignificant or no energy loss is conserving mass energy; globose forms detain transport fluid mass that counterpart conduit uses to transport mass;

Pent up hydrostatic pressure cause discharge of nonhomogeneous heaviest mass, particles; Pent up hydrostatic pressures are to fluid free surface essential elevations, only;

Globose-conduit conduit outlet, First Sub-outlet, DCSS greatly narrowed breadths with much larger globose breadths adeptly manipulates PP pent up hydrostatic pressures;

Detention large breadths, lengths mitigate nonsteady mass flows to a least change from highest conserving mass energy fluid free surface elevations, hydrostatic pressures.

Herewith listed, also referred to, FESD specific forms are part of FESD globose-conduit forms whose specific purpose is prevention or restriction of fluid mass rotations. For highest conservation of energy, exact transfer of kinetic to potential energy requires energy path-of-passage-of-least-demand, PPLD, for a unit of mass that passes a summit. For near frictionless transport fluid critical path lengths are those against gravity direction as then mass energy required contains 32.2(ft/sec. squared) multiple. Smallest entire mass makes for least mass that requires said multiple for highest conservation of energy. Such mass must preclude venting or backups found by nearly universal or ubiquitous empirical use. Least mass contained by most compact, least volume spherical modified to a globose form units of mass constituted PP lengths least height forms make said least mass forms. Nonhomogeneous fluid mass paths-of-passage, PP, lengths least sum contains horizontal components as well. Conduit inverts, fluid mass units energy paths-of-passage-of-least-demand (most energy required), PPLD, identical PP length forms are referred to as such.

Nonhomogeneous, nonsteady nonuniform least mass highest conserving energy modes fluid mass least rotations globose-conduit complete complement PP lengths least sum retention genome round, rounded, curvilinear forms has following transpositions:

Round or rounded areas transposed to a conduit, an intermediate, and a globose form area higher centroids of retained fluid mass potential and kinetic modes of energy;

Transposed round, rounded conduit cross-sections, fluid mass essential height as for a First Sub-outlet, constitutes fluid mass least rotations curvilinear least height form;

Least rotations curvilinear fluid mass forms raise centroids of following:
Fluid mass perimeter, FESD structure interface curvilinear surface, thus;
Viscosity, cohesion, adhesion, and solids surfaces friction centroid;
Boundary layer perimeter laminar respective forces centroid location, as
Transposed centroids, forces constitute one common centroid force with least rotations, for fluid mass varied compositions respective least height forms;

Breadths, breach least height FESD make for fluid mass forms least rotations;

Contained, retained, detained transported fluid mass-energy phases forms least PPLD width of band, lower conduit perimeter, and quintessential, core, self-conservation, self-preservation for a quanta mass form least height, a mass centroid highest elevations.

Wherefore, classic globose upper retention form and a classic lower conduit form constitute elevations of fluid free surfaces that is for a transfer of energy mode near or at highest elevations. A classic globose lower form amalgamates a lowest surface shrunk PPLD conduit form at highest elevations, which conserves most of fluid energy transfer to potential mode to transport highest specific gravity fluid mass specifically effected by said classic conduit to globose form transition region. Said PP lengths least sum of finite to infinitesimal retained fluid mass inherently constitutes self-conserved preserved energy highest conservation paths of least resistance, which make open channel transition region of globose-conduit fluid mass forms. Said globose-conduit transition region computing of forms forgoing figures, wherein globose-conduit conduit basin-outlet, Inlet fluid mass forms, may constitute an Inlet contained fluid mass outside a basin-outlet, especially fluid mass and Inlet forms that precludes suction or venting. Transition region forms conserve fluid mass energy with computed highest elevations of PPLD and fluid free surfaces least height difference constantly continually that with a conduit form fluid mass constitutes an essential height. Said PPLD constitutes lowest surface rounded form unless fluid mass highest specific gravity are highly uniform inflows that PP lengths least sum computes to a round form. Rounded lowest surface forms constitute highest elevation for a statistical continual least inflow rate that constitutes fluid mass detention wherein said inflows of a nonhomogeneous, nonsteady, nonuniform fluid is accounted for by lowest surfaces PPLD forms. For statistical standard deviations higher inflow rates rounded forms open into PP lengths least sum computed wide form of low slope sides surfaces or parabolic horizontal major axis forms. Highest elevations PPLD forms govern unless cross-sections breadth or breach computed PP lengths least sum mandates a PPLD lower form.

Shrunk PPLD forms rounded, elliptical upright major axis, or curvilinear globose-conduit forms makeup, transition region forms, PAP angles less than 180 degrees, and PP lengths least sum forms complete complement constitute claimed universe fundamentals:

PAP two points, as “surveyor stakes” that space align fluid mass energy forms with conduit, globose springing points constituted lower, upper transition region limits;

“Self-designed” conforming PP lengths with least sum, least fluid mass energy, resistance paths constituted fluid mass perimeter surfaces that are globose-conduit forms,

Said PP paths, as “self-designed” units of fluid mass paths that use least energy;

Said PPLD forms, as “self-designed primary paths” most efficient energy forms,

Said classic retention genome, as contained retained energy genomes “parent”;

Mass units' paths of gravity force least resistance is said PP mass energy modes quintessential highest conserving, self-preservation with natural disposition visible forms;

Most self-conserved preserved fluid mass energy self-generates least magnitude of energy modes full transfer most shrunk PPLD form, globose-conduit compact forms;

Said “parent” near spherical classic conforming retention amalgamates, its outlet conduit to make up highest conserving fluid mass energy globose-conduit Sets;

Said infinitesimal units of mass PAP symmetric orderly outflows, inflows into, out of classic retention genome form, as “old”, “new” units of fluid mass and energy;

Said fluid mass energy units, as “participants” in “parent” mass energy universe;

Said laminar flows mass units, as a “confined unit” for fluid mass energy forms;

Mass units PP lengths least sum makes least PAP angle unique Set symmetrical forms through a discharge-cross-section-surface, DCSS, and springing points elevations;

Globose-conduit forms are within “genus” conforming “citizens”, Sets, by PP lengths least sum fluid mass energy highest conserving forms that constitute its universe;

Lower globose basin globose forms amalgamate into a rounded or a curvilinear globose-conduit, First End, outlet, Sub-outlets, FESD, and DCSS FESD respective forms;

Paths-of-passage compute PP lengths least sum, globose-conduit, PPLD, FESD retention conforming least fluid mass least rotations PAP upright plane symmetric forms;

Classic genomes Set of forms conforming retention least mass least height is mass modes of energy highest conservation thus PP lengths (least resistance) least sum;

Quantum units of mass PP least sum amalgamates mass units' paths into least height shallowest retained mass genome forms mass energy modes highest conservation;

Genome Sets make for retained fluids least height, least mass potential, kinetic energy modes quantum mass units least sum amalgamate into fluid mass and forms Sets;

Said PP lengths least sum for a form constitutes a conforming or a genome form; genome forms complete complement conforming embodiments are genome Sets.

Embodiment forms PP lengths least sum causes nonhomogeneous fluid mass conforming permanent retention kinetic potential energy modes passing heaviest particle.

Heaviest particles, highest specific gravity mass PPLD least height, conforming least retention mass, height, and energy modes inflows transport PP mass; A quantum, an omnipotent mass, energy physical forces compute to a conforming embodiment forms;

PPLD units of mass paths to summit topside PPLD width of band surface forms make for least rise slopes for said mass units PP lengths least sum narrowest breadths;

Outlet FESD and DCSS forms PP lengths large breadth upper area cross-sections higher than globose forms springing points elevation limit fluid free surface rises to hold least height, least fluid mass kinetic energy transfer to potential energy mode;

Further fluid free surface rise potentially wastes both;

A greatest particle height constitutes a free-fluid surface detention essential elevation, PP lengths least sums lowest elevation and First Sub-outlet forms least height:

Essential detention free-surface elevations require no kinetic to potential energy energy-demand transfer required for continual mass and energy highest conservation;

Open channel globose-conduit forms nonhomogeneous fluid solids mixtures mass energy self-preservation containment, detainment, and transport is within one form.

Globose-conduit forms contain Inlet retention and forms, that altogether inside a basin-outlet constitutes a globose-conduit least mass-energy least Set of forms;

Quantum-mass PP complete complement computes Sets' least resistance forms.

Generic globose-conduit claims: PAP, path-angle-of-passage; PPLD, path-of-passage-of-least-energy-demand; PP, paths-of-passage with a least sum constitute fluid mass globose-conduit conforming embodiments self generated Sets. Globose universe conforming embodiments, Sets genus, is generic claim classic Sets conservation of mass and energy of fluids and solids mixtures that originate from said classic unique retention form genome. PP, paths-of-passage, lengths generic claim to algorithm computed least sum is energy balance for entire retention mass quantum mass upright components with gravity acceleration multiple, which through reiterative process arrives at fluid mass and structure forms interface ultimate Sets, genomes. Forgoing specified at least two points aligns Sets to a linear PAP least angle alignment and symmetry of forms. Genomes best construction of surface forms narrows the first application globose conduit construction and forms tolerances to commercial, industrial forms herein said complete complement of completely matched forms of Sets. Sciences, art fields nuclei or subatomic, microscopic or submicroscopic complete complement of forms is quintessential of globose-conduit potential, kinetic near infinitesimal quantum mass energy modes transfers perfection that is beyond human skill to create or duplicate.

Classical best known highest packed carriers of mass energy forms are electrons, protons, and neutrons, with round shape properties that continue into sub-atomic ranges. A round cross-section of an electrical wire, a water pipe is taken as best carrier of energy. Both need transport energy. First transports relatively no mass high-energy electrons, the latter transports mass with modes of energy that requires a mass weight supply. Gravity influences insignificantly the former but impacts the latter, especially nonhomogeneous, nonsteady, nonuniform mass. Globose-conduit nonhomogeneous mass, cross-section area and perimeter centroids continually at least infinitesimal at odds to gravitational direction alignment extends to quantum mass atomic subatomic or microbes structure substructure forms. Electrical wires, pure water pipes under voltage, hydrostatic respective pressures are mainly completely round cross-section areas and perimeters classic genome forms.

Globose-conduit conforming embodiments classic universe forms contain, retain, detain, transfer and conserve mass energy that transposes globose-conduit, open channel, nonhomogeneous to homogeneous high pressure round water pipe, electric wire or vice-versa or round, globose, spherical retained mass with PP lengths generic least sum claim.

Microbes microscopic, submicroscopic thin disk or short rod line like, single form cells contain, retain, transport, or detain submicroscopic ecosystem inflow, outflow mass constitute an Inlet, a basin-outlet forms of globose-conduits basic types least Sets make.

Solar system globose, spherical bodies align as if in, a detention mode, extremely thin disk like highest conservation of mass energy mode. Sun's radiation, solar system's gravitational pull maintains cosmos mass energy equilibrium. A thin disk alignment has highly precise equilibrium balance. The Sun with entire Solar System is highest modes of energy basin in equilibrium with Milky Way Galaxy mass energy. A body of the Milky Way Galaxy pulled into the Solar System with its gravity-controlled space makes an Inlet form, and when it exits, the Solar System an outlet form.

The Solar System, Milky Way Galaxy contains, retains, detains or transports for a highest conservation of its celestial bodies' energy modes. Globose-conduit forms mass energy modes phases highest conservation makes globose-conduit forms universe from a microbes' submicroscopic, atomic subatomic to cosmos makeup wherein the Milky Way Galaxy is a miniscule part.

Clearly celestial bodies travel paths of least resistance paths-of-passage, PP, that is highest mass energy conservation from cosmos to Milky Way Galaxy, to Solar System, to Earth with each body path length accounting for mass energy losses within the cosmos mass energy equilibrium. A stationary body has exhausted in space its modes of energy except for gravity that burdens it in tandem with gravity, rotations of the cosmos thus to contract only, unless it can overcome pent up compression with escape paths through a perimeter confirming to cosmos gravity, mass, energy balance. Thus, the cosmos, Milky Way, Solar System bodies constitute PP of least energy, least energy demand, least length whose PP lengths least sum for the Solar System, Milky Way, Cosmos constitutes mass energy quintessential highest self-conservation, self-preservation. Around solid celestial bodies, nuclei respective gravity, electron energy fields constitute invisible, least energy required, natural disposition to dissipate mass-energy that are frictional no energy loosing boundaries on scale beyond human skill to create.

Centroids least separation of heaviest mass, detention transport fluid mass needs less transport fluid mass and its energy. Two, three dimensional FESD forms of globose conduits much wider breadths larger area compared to entirely round or otherwise similar conduit forms hold transport fluid mass with least or shallowest detention, retention mass height that is set at highest elevations for respective Set fluid mass inflows, outflows. For continually raised heavier fluids centroids toward a DCSS with entire fluid mass least or no rotations in PAP upright plane makes for highest mass and energy, especially transport fluid mass variable inflows with specific gravity variations mass, energy conservation.

Frictionless fluid least rotations consume least to insignificant amounts of energy modes. Globose-conduit systemic highest self-conserving energy modes retains, detains, and transports manipulated mass energy mass, area, and perimeter centroids as follows:

Two PAP points align upright plane symmetric globose-conduit forms flexible to rigid least Set rotated forms to a finite or infinitesimal PAP angles accuracy analogous to “positioning members” with forms having up to near infinitesimal “flow control means”;

Globose-conduits PP make paths of least resistance cross-section areas breadths for fluid free surface least elevations difference from PPLD forms at highest elevations; Sets contain retain detain, and transport nonuniform, nonhomogeneous, nonsteady classic area, perimeter least mass, height, fluid mass for least or no detrimental rotations;

Globose-conduit quintessential fundamental, evolutionary, natural, highest self-conserving self-preserving superiorities self-generated mass energy forms is as follows:

1. Globose-conduit mass inflows preferentially distribute transport energy modes into heaviest fluid mass PP, PPLD forms at highest elevations with respect to its summit.

2. Globose-conduit forms push highest specific gravity mass ahead of a transport fluid mass at three locations: a) under an End 2, b) prior to a summit, c) after a summit;

a. Under globose End 2 least conduit height, with a lowest PPLD form at highest elevation, with separations that need not exceed much inflows mass largest particle size;

b. With narrow breadths conduit transported heaviest mass risen centroid pushed in front, ahead of detention mass ahead of a First Sub-outlet by least fluid mass rotations;

c. Passed summit with transport fluid greater drop into pushed ahead heavier fluid mass similar to fluid mass Inlet inflows, accentuated by Industrial Sets heavy, transported fluid mass passed through a lower First, a higher Second Sub-outlet forms, respectively;

5. A globose detention in tandem rise behind a risen transported mass centroid;

4. Transported, transport fluid tandem raised, lowered respective mass centroids;

5. A much small transported mass in front of significantly larger detention mass;

6. Compact retention, detention highest mass centroids in respect to its summit;

7. Highest mass centroids a least distance, rotations from a respective summit, constitute a viscosity, boundary layer friction least fluid mass modes of energy losses;

9. A narrow conduit breadth at summit raises up globose detention pressure;

9. A globose-conduit, one-form, least energy modes demand raised detention pressure, heaviest mass centroid retains or detains, transfers mass energy highest modes;

Kinetic, potential is useful energy mode; least mass rotation is conserving both;

Conserving of both is because energy modes are least energy demand transfers;

Quantum mass energy modes are exchanges for inflows mass energy same sum;

11. A globose detention mass pant up pressures separate, dilute, or dissolve a transported mass in its path with raised centroid, least apart from transport mass centroid;

11. Open channel forms adeptly manipulate energy-modes gravity force caused;

12. Globose-conduit nonhomogeneous nonuniform nonsteady modes of energy mass, cross-section areas, perimeter centroids align for highest mass energy conserving;

13. Generic PAP, PPLD, PP lengths sum, conforming embodiments, evolve or devolve globose-conduit forms into round or entirely round conduit cross-sections and or globose spherical or spherical retained mass forms that rotate, mutate, transpose, transfer, make unique origin universe highest conserving mass energy phases, Sets, and domains;

14. Globose open channel basin-outlet spouts manipulate, adeptly amalgamate mass energy modes one-directional linear or circumferential globose or circumferential cross-section areas of retention, detention that otherwise requires three-elbows assembly; Globose, circumferential are highest self-preserving mass energy two strains of forms; A one-directional less than 180 degrees alignment is one within cosmos' gravity fields;

15. Self-conserved energy process among naturally evolved or man made forms constitute classic chains with globose-conduits as natural, quintessential dominant links.

16. Fluid mass forms of energy, composition, and physical properties highest self-conservation globose-conduit forms evolve into classical round forms and vice versa;

17. Classic globose-conduit detention PP lengths least sum, height mass energy absolutely dilutes, tears up, disintegrates, moves or transports high specific gravity mass; This conserves useful energy modes mass energy for a transport of such heaviest mass; Air as a fluid mass is controlled into out of open channel forms as an enclosed boundary;

18. Basin-outlets least Set includes Inlet forms inside, a conforming retention, a globose-conduit transported detention, and an Inlet fluid mass outside of its basin-outlet;

a. Conserving mass energy is inside mass energy modes enclosing boundaries; Mass energy modes stated inventions, principles, and methodologies requires respective boundary of physical, nuclear molecular, living cells chemical mass energy modes forms;

b. Contained modes mass energy forms require at least one enclosing boundary;

c. Globose-conduit open channel forms transport of fluids and solid particles of nonhomogeneous mass energy is comparable to round pipes, electrical wires transport of homogeneous mass, energy, and atomic subatomic round forms retained mass, energy;

d. Paths-of-passage lengths least sum amalgamates nonhomogeneous, nonsteady, nonuniform, mass-energy units viscosity, adhesion, cohesion and fluid structure interface perimeter boundary layer adhesion, friction into highest mass energy conserving forms;

e. Classic globose-conduit genome forms constitute classic perimeter form Sets;

Globose-conduit principles, methodologies are homogeneous mass applicable.

Partial suctions of globose-conduit smaller than ubiquitous permanent retention is safest quickest recovery of upper retention of highly conserved fluid mass and energy.

f. A rise in globose-conduit, basin-outlet PPLD band in tandem with narrower lower conduit cross-sections breadths is completely complimented by transitions regions least height wide globose breadths forms having essential height or greater elevations;

g. Mechanics of forms contain modes energy highest sum at highest elevations;

h. A retained fluid mass defines a lower retention, an upper retention and a detention form. An upper retention at rest makes a free surface. A detention makes a free surface that is higher than said free surface at rest;

i. Globose-conduit said fluid mass energy PP lengths least sum are one of forms for highest statistical-probability of nonhomogeneous, nonsteady, and nonuniform retention, detention least PAP angle, quanta mass least rotations. FESD forms are PP lengths least sum classic perimeter forms that contain, retain, detain, and transport fluid mass energy of globose-conduits, which themselves constitute FESD forms.

Domains of globose-conduit universe FESD forms with said PP lengths least sum surfaces restrict rotations of mass in three orthogonal planes, especially prominent among named makeup Troughs, Ridges, Partitions, globose End 2 and globose-inverse First End forms and undersurfaces, doming Cavities, Bridging-Wall, Fin and DCSS FESD forms. Troughs raise globose forms sides lowest surfaces wherein Ridge, Partition FESD forms raised PPLD lowest surfaces into two PPLD higher elevation forms. Troughs, Ridges and Partitions are globose conduit forms integral parts concepts that raise heaviest fluid mass centroid twice. Once, as a part of globose-conduit forms highest elevation lowest surface raised with a presence of such forms to constitute least fluid mass height form that makes narrower breadth two cross-sectional areas, to thus again raise nonhomogeneous heavier mass centroid. A narrower PPLD form initiates earlier lowest surfaces rise with narrower breadths constituting faster rise of lowest, lower surfaces.

Figures of globose upright, angled to about upright, angled, industrial, low angled, Inline, inverse and hybrid forms claim globose-conduit universe of Sets, forms, hybrids, migrations, mutations, entire G-C universe domains, genomes, along with classic forms classic perimeter Sets inventions, methodology, and principles, and concepts disclosed.

Energy and fluids mass finest elements algorithm computed PP lengths least sum perimeter boundaries constitute science academia infinitesimally exact fluid mass energy perimeters. Plugs, Caps Portals, and nozzles are replaceable by continued streamlined surfaces. Nozzles especially high inside an Inlet is tolerable as fluid free surfaces at this elevation is at or above said detained fluid mass essential elevation. Sidelong Sets make for one-directional PP lengths sum. A sidelong offset to an anti sidelong, a near upright Inlet is respectively closer to respective DCSS forms. PP and PAP aligned forms save mass-energy. Trough, Ridge, Trough-Ridge, Partition, or Trough-Ridge-Partition FESD removes and or manipulates excessive mass-energy PP bundles. FESD forms conserve fluid mass-energy by a reduction of mass or mass rotations or both.

The first application specifies gravitational field forms that contain, retain, detain, and transport modes of mass energy. Continuations, this application continues describing forms process to one that has mass and energy conservation laws, conforming conditions, to energy-modes transfers including boundary, perimeter, energy losses to define forms. No maximum or minimum boundary conditions restrict generic claims PP PAP, PPLD, conforming embodiments, other than universal laws of mass energy conservation, which allows for various conditions of various conforming boundaries to define modes of mass energy phases conserving conforming embodiment forms, Sets, and domains. The first application first paragraph embodies piping universe without an exception. Unrestricted mass modes of said piping universe and globose-conduit forms is one space universe. Globose-conduit perimeter forms are imposed boundary conditions for a quantified mass energy highest self-conservation self-preservation graphical visual illustration of useful, contained, quintessential, mass energy phases perimeter. Continuation applications revise restrict, by said generic claims boundary conditions, perimeters of the first paragraph of the first application to quantum mass PP lengths least sum computed mass energy highest conserving perimeters.

By imposing ecosystem universally most friendly boundary requirements, entirely releases, removes artificial, unnatural boundary conditions quantum mass PP quanta mass constitute entire universe, cosmos contained, retained, detained or transported phases of mass energy bodies with gravitational energy or force. Omnipotent potent contained one-mass energy forms constitute globose spherical, spherical perimeters gravitational field of same forms with intellectual boundary surface visualization enclosing gravitational force field energy. Orbiting mass energy modes phases detained by its omnipotent gravitational energy mass constitutes potential conduit forms. Analogous parallelism on atomic scale is nuclei mass energy spherical forms contained mass energy with orbiting electrons that constitute a perimeter form that allow inflow outflow of other electrons as an omnipotent atoms mass energy respective detention.

On microscopic, submicroscopic scale a mass energy inflows, outflows constitute an inlet, an outlet with a single cell, or a most primitive organism globose or cylindroid detention forms with cell membranes boundary as conforming conditions perimeters. A partitioned mass energy conservation subdivides into globose-conduit cells. Accepted omnipresent parallelisms among mass modes of energy forms by universal mass and energy conservation laws herein extend to nonhomogeneous, nonuniform, nonsteady mass energy respective phases of mass energy perimeter forms.

Globose-conduit classic forms contain detain and transport nonhomogeneous fluid comparable to subatomic, atomic; microscopic, submicroscopic; high pressure water pipe or electric wire classic forms, perimeters contained, detained, and delivered mass energy.

Straight lines constitute mass energy highest conserving path between two points. A straight-line path away from a rotating mass traces a circumferential path in respect to its starting point. A linear, a circumferential PAP constitutes two most conserving mass energy paths of quintessential, core, or natural disposition, each with perimeter boundary respective conforming conditions. A linear or a circumferential PAP of equal boundary conditions, PP lengths least sum, with equal quantum mass equal energy have an equal core, quintessential, perimeter form and vice versa, wherein least or equal is not exact. Globose-conduit and globose-circumferential universe domains of Sets, PAP angle paths constitute a finite linear increment in upright plane with counterpart orthogonal upright plane containing a quintessential core image of highest preserving mass energy natural disposition perimeter. Said image at best is statistical approximations derived with its exact form that is perfection beyond human skill, ability to compute or construct.

A PPLD form defines a conduit perimeter for containment of mass energy modes or mass energy perimeter dissipates into ecosystem, universe mass energy natural disposition boundary perimeter forms.

As with other modes of energy, globose-conduit perimeter forms universe extends from microbes' submicroscopic, atomic subatomic to a cosmos makeup or vice versa. As most conserving mass energy modes exchanges quintessential, core, natural disposition, globose-conduit forms are classic perimeters alongside spherical globose with parallelism to homogeneous mass energy round conductors. As created suitable boundary conditions allow, quintessential, core, natural disposition of mass energy self-conserving, preserving will result in globose-conduit perimeter forms. Unless its boundary perimeter condition, laminar mass perimeter, is maintained, a globose-conduit highest conserving mass energy quintessential, core, or natural disposition perimeter readily dissipates.

Globose-conduit Sets make spouts lower surfaces contained fluid mass-energy one-transformation half-mode cycle, kinetic to potential energy highest conservation and PPLD FESD least height and length forms much shorter than are those of ubiquitous art. A Nozzle FESD form may constitute a part of its End 2 undersurface form.

Spherical globose highest energy modes genome classic forms retain mass units constituting computed least resistance paths, said paths-of-passage, PP, lengths least sum. Inlet inflows provide fluid mass potential, kinetic energy modes with PP energy.

A PPLD width midpoint, said undersurfaces one point align tangentially for a Set of forms having a PAP direction horizontal orientation, PAP upright plane symmetry, and a basin-outlet rotation through a PAP angle in respect to the gravitational direction.

Energy transfers cycle contained potential and kinetic mass-energy modes. PPLD forms least height and length constitute PP least demand for transfer of energy-modes.

Potential to kinetic mode quantum mass transfers constitute units of mass PP three components length. Upright quantum mass-energy units contain the gravity acceleration multiple for computing quantum mass kinetic energy quanta sum that is PP lengths sum.

A fluid mass volume form with a center of mass located at a higher elevation or closer to a DCSS form constitutes quanta-mass conforming form PP lengths lower sum.

An upper retention quanta mass conforming retention constitutes a retained fluid surface-tension, adhesion height higher than a globose End 2, a globose-inverse First End undersurface, horizontal, radial, infinitesimal width highest finite increment.

A lower retention constitutes a region basin-outlet conduit spouts cross-sections forms gradual increase from PPLD width of band forms to said globose End 2, a globose-inverse First End undersurface, horizontal, radial, infinitesimal width highest increment.

A globose-conduit lower retention, smaller, short mass volume unified with a detention, an upper retention, dominant mass volume, least height conserves energy.

Basin-outlets, DCSS, PPLD widths of band, and drain lines smaller lower areas of rounded surfaces and narrower breaths than equivalent round areas breadths at a same rise from respective inverts constitutes FESD forms. Round or rounded cross-sections length segment constituting said PP lengths least sum constitutes an FESD form part.

An outlet FESD rounded cross-section, DCSS sub-outlets First Sub-outlet height constitutes a fluid elevation height that clears fluid mixture largest submerged particle.

A retained fluid mass free surface elevation differences vary with inflows and are enhanced or controlled by composite forms cross-sections of a DCSS or an outlet FESD, and various Sets FESD forms respective areas breadths, breaches, and heights.

Globose forms large lengths and breadths free surfaces areas minimize its rise. Outlet and DCSS FESD cross-sections continue lower area conduit forms through a First Sub-outlet height into larger Second Sub-outlet cross-sections, which also resists fluid free surface further rise conserving energy by transfer of energy-modes at a lower height.

Said PP lengths computed least sum is for statistically compiled particles ranges, volume specific gravity, and shape sizes of mass mixture.

Said Sets PPLD form retention volume “at-rest” is half as tall, of shorter length, and has a smaller to several folds smaller retained fluid volume than ubiquitous art forms.

Conforming embodiments, PAP, PP, PPLD least quantum mass PP lengths least sum mass energy enclosure constitutes interface surfaces least resistance PP, forms. Inlet inflows provide nonhomogeneous, nonuniform, nonsteady contained retained, detained, transported fluid mass potential kinetic energy-modes;

Quantum mass complete complement computed PP are least resistance forms Set.

Genome Sets PP lengths least sum makes conforming retention mass least height.

Globose conduit, globose-conduit, basin-outlet, G-C, cross-sections are made up of a lower smaller area rounded conduit form, a transition region intermediate area form, and an upper area rounded globose form for a compact composite curvilinear form.

A globose-conduits globose area height can vary from about 5% to 95% of entire cross-section height with its globose form area breadth varied up to three times a breadth of a vented pipe to which its conduit outlet descending spout connects.

A least mass half-cycle energy mode change conserves energy and fluid mass.

A least mass energy mode PP lengths least sum change is a Sets genome.

Sets may constitute genomes for specific fluid mixtures, only.

Forms of PPLD band make for PP lengths least sum, least retention, least height side-view “S”, “C”, or “S” and “C” forms, a PAP direction and a least angle, smoothest fluid surface interface forms, from basin lowest PPLD forms ending with a DCSS form.

A PAP makes an angle less than 180 degrees in respect to gravitational direction, entirely aligns Set forms upright plane symmetric from a basin blind side through at least a DCSS, and upwardly entirely to at least include a globose form springing points.

A summit is a DCSS lowest infinitesimal width finite horizontal increment, outlet ascending spouts and PPLD forms highest infinitesimal end furthest from its respective Inlet, and a fluid tension and adhesion height higher than an upper retention free surface “at-rest” elevations retaining conforming continual least fluid mass, volume, and height.

Globose-conduit paths-of-passage-of-least-energy-demand, PPLD, and PAP rotational angles less than 180 degrees that constitute least height basin-outlet PPLD for ascending lowest surfaces highest slopes smaller angles, inherently smaller angles shorter smaller slopes for a shorter entire length, with a smallest conforming retention fluid mass.

Globose-conduit forms constitute domains of generic and circumferential strain hybrids of horizontal and upright orthogonal planes rotated globose genus form; generic circumferential globose hybrid domains are claimed as forms of globose domains.

Migrations of globose Inlets End 2, globose-inverse outlets First End from basin-outlets blind side to an anti-sidelong location on opposite end of basin-outlet retention forms constitutes Sidelong, Sidelong Offset, Offset Centric, Centric, Anti Offset Centric, Anti Sidelong Offset, and Anti Sidelong Sets.

Illustrating and describing a domain Set, entire domain Sets, its hybrids and Sets migrations within entire G-C universe range constituted Sets genomes is claimed together with Sets inventions, principles, methodologies, and concepts for retained fluids mass and energy conserving by globose conduit forms Sets and their circumferential hybrids.

Basin-outlets basin upper retention constitutes largely one of five: truncated about largest cross-sections of globose, spheroidal, ellipsoidal, cylinder, or cylindroid forms of a short height that is shorter than a largest horizontal dimension of a respective basin.

A basin lowest surfaces makes largely one of following large forms: a rounded, an annular, a crescent, an about flat to doming annular, and an annular crescent, among PPLD FESD many geometries of single or various compositions of smaller forms.

An about upright Inlet and basin-outlet retention forms rotated into an upright PAP plane of symmetry by rotating its retained fluid form, and horizontal plane rotated about an upright axis, especially an Inlet upright axis, staying upright constitutes an angled form in its original position.

A basin-outlet conduit outlet spout ascends from a globose Set First End surface inflection, an outlet basin end cross-section, or a globose-inverse submerged spout form lower end inside a basin-Inlet retention of respective globose, globose-inverse forms.

Basin-outlets outlet spout cross-sections are made up largely by one of following FESD forms: a rounded, an elliptical, or a curvilinear geometrics composite areas form.

Outlets, DCSS, and Sub-outlets FESD forms constitute PAP upright plane aligned symmetric a lower, smaller, rounded conduit form, a transition region cross-sections, and an upper largest area largely a rounded, an elliptical, a parabolic or a curvilinear form.

Highly angled Set angle forms from a lower basin to basin-outlet intersections, to then rotate into about an upright upper end Inlet, and rotate a globose End 2, a globose-inverse First End, basin-outlet lowest surfaces close to near horizontal for respective basin-outlets spouts complete complementing, PP lengths least sum forms.

Flow-energy-surface-dispensators, FESD, PAP upright plane symmetric globose-conduit quanta mass, cross-sections, areas, shapes, heights, breaches, or entire breadths, as G-C forms, transform globose to conduit forms and vice versa. They make up conforming quanta mass least volume, rotations, perimeters, and PP lengths sum that constitutes the following forms:

A three-dimensional Set (TD), circumferential, axial or transverse Trough, Ridge, an Inlet upright Ridge a Trough, a Trough in a Trough, a Ridge, a Partition with/without a Window(s), a Troughs-Ridge, a Troughs-Ridge-Partition and a Window(s);

A Circumferential Trough, a Ridge, a Partition, a three-dimensional Window and a Troughs-Ridge and a Troughs-Ridge-Partition and a three-dimensional Window(s);

A Nozzle local highly directional spout forms;

A globose End 2, globose-inverse First End and PPLD counterpart forms of a Set;

A Bridging-Wall with Domed-Cavities about Inlet forms;

A Fin FESD forms dividing globose-conduit cross-sections upper retention;

A Trough, a Ridge, an upright Ridge, a Partition with/without a Window(s), a Trough in a Trough, a Troughs-Ridge, a Troughs-Ridge, a Troughs-Ridge-Partition with/without Window(s) upright plane axially symmetric forms;

An FESD manager enhanced control of fluid free surfaces height differences;

An FESD space manager exchange of air and fluid manages retention form free surface areas and elevations, thus cross-sections areas, height, breadth, breach and length;

Cavities; dome Cavities FESD;

A rounded End 2, First End; a flared; an infant boot; a Fin End 2 FESD form;

A Migration Dimension(s) 44, (44,44′);

A crescent PPLD conical form FESD;

Outlets, DCSS and globose-conduit cross-sections areas breadth, breach, and height FESD forms managed effects of retained fluid free surface elevations, elevation differences, as counterparts of FESD mangers' and FESD space managers' forms.

Flush Apparatus parts, entirely contained within walls of a Set with access to most Set's locations, separately or concurrently disinfect, flush, surface coat, repair or protect damaged surfaces. Flush Apparatus prefabricated pre-assemblies use design fluids and or gases, or air, jointly individually or, to a separate sequence and intervals or concurrently, to a surface location or entire Set with a single, a set, or a nozzles network, with tie-ins, or sets of tie-ins located conveniently about a Set.

A double wall inner space and gravitational direction compliant tubing show and warn expeditiously by dripping leak evidence that a wall failure has occurred.

Said Sets exact globose-conduit construction is beyond human creative skills.

A descending outlet spout Second End connects to a vented drainage line with a positive rigid connection, which is one of two connections that support a Set.

Connections are generally shown threaded or welded. Compression couplings and flexible installed in place rigid with or without gaskets, washers, or bushings, and locked or double treaded or said connections suitable mix constitutes globose Set connections.

A top quality highest accuracy highest pressure moldings of plastics, metals, and their composites and or semi-rigid materials that are adequately rigid or are with positive provisions for sufficient stiffness or a fabrication combination of above makes said Sets.

One-way air nozzles are suction precluding measures. Forms constitute smallest mass and height known to stop suction and or venting. Forms are to crafts finite or scientific infinitesimal accuracy algorithm computed as needed.

Fluids and solids particles non-homogenous mixtures inflow through an End 1 into globose Set forms and by gravity force outflow through an outlet Exhaust.

The forgoing is not inventions restricted only to the highest conservation of fluid mass or energy genomes disclosed by a narrow highly defined scope of fluid mass, and energy conservation of the inventions, which unify fields of arts and sciences.

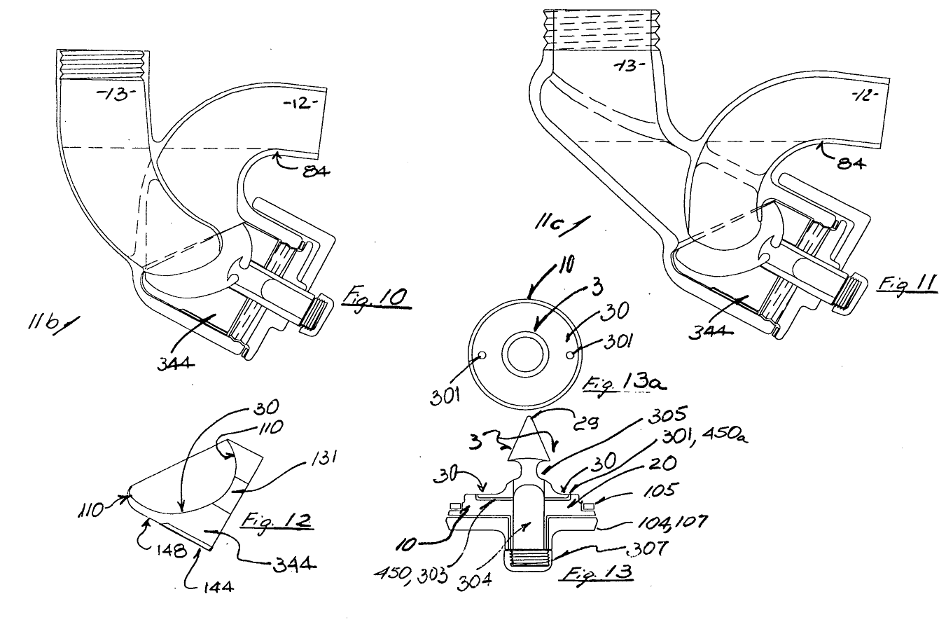

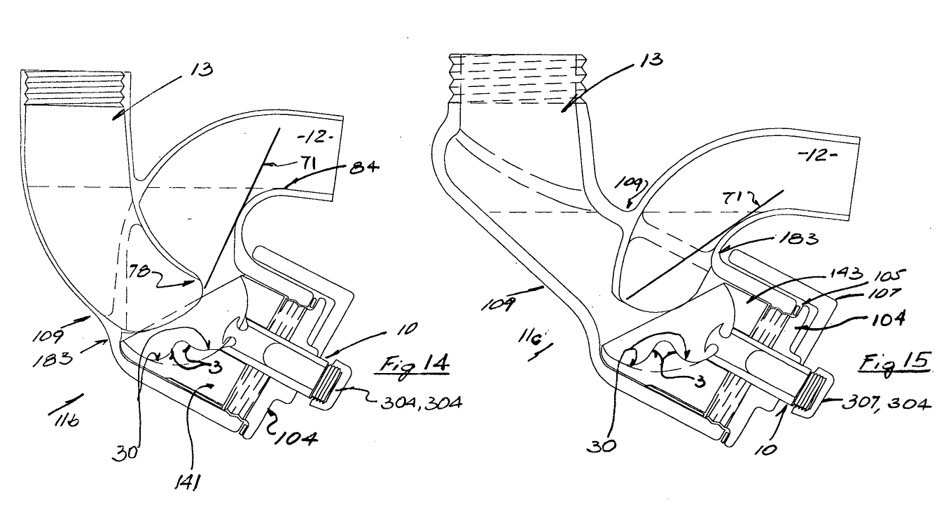

This and continuation applications continue the first application specification and drawings scope narrowed to fluid mass energy conservation by defined globose retention genus forms and the first application FIG. 9 “laminar flow” and its stated description and specification “flow control means” herein FESD forms. Globose-conduit Sets originate with the first application open channel Set of FIG. 1-2. Globose-conduit forms said short height, in respect to figures length, is especially short for the first application FIG. 1-2 Set that connects to building code vented pipe constituting open channel construction. Its elliptical outlet descending form spout and channels about basin originates outlet FESD and DCSS FESD forms Figures herein show. The first application FIG. 1-2, 9, 12 stated “transition region” “means” that maintains “the transition region submerged” herein and continuation application numerous Figures define as upper, herein permanent retention extended upwardly from lower conduit form springing points and not taken higher than globose form springing points.

FIG. 1 Set of basin-outlet nonhomogeneous, nonuniform, nonsteady fluid mass forms, modifies said classic retention genome prior applications FIG. 1, shows globose-conduit parent form that uniquely originates globose-conduit universe domains of Sets. Each of said Sets retains, contains, detains, and transports fluid mass that subdivides into finite units of mass having said PP lengths least sum. Units of mass, PP length least sum algorithm, mathematically computes kinetic energy required for each mass unit to pass. Said least sum constitutes mass units times respective path lengths of entire fluid form with upright components having gravity multiple.

Shown Figures of this application are the second application drawings. Said Figures show open channel forms and are continuation from the first application Figures, especially said FIGS. 1-2, 9, and 12. Basin-outlet continuations of FIGS. 1-2, and 12 shown major axis upright elliptical outlet and DCSS FESD forms and a Trough, a Partition, and a Trough, a Ridge, a Partition of FIG. 12 and FIG. 9 shown upright Ridges, nozzles and diffuser FESD forms. Said FIG. 12 basin-outlet, globose-conduit forms show a capped tubing about basin blind side through upper basin-outlet casing. Enlarged, streamlined, said tubing constitutes a Bridging-Wall FESD, which with globose basin-outlet makes for domed Cavities FESD forms about Inlet. Capped at a specific detained fluid free surface elevation said tubing constitutes a space manager, SM, in respect to retained fluid free surface elevations. Said SM not capped but connected to a one-way air inflow having basin-outlet perforations constitutes SM that precludes suction.

FIG. 12 Set basin-outlet spout constitutes much larger cross-sections than those of a vented pipe and thus will not experience suction. SM outside air inflows connected to a Flush Apparatus is both, a Flush Apparatus and SM, and said perforations extended through walls of said Set constitute numerous Flush Apparatus assembles parts said continuation applications and herein Figures show. Globose-conduit computed classic cross-section areas, perimeter, surfaces interface boundary forces, and centroid locations for least or no rotations about fluid mass centroid constitutes said “flow control” mass and energy highest conservation.

Said classic perimeter PP mass laminar fluid finite segments constitutes viscosity, adhesion, fluid pressure internal and boundary layer related forces with no rotation of fluid mass, which is identical for homogeneous mass-energy. Classic perimeter globose-conduit nonhomogeneous mass energy forms with parallelism travel across arts, science fields analogous to classic, homogeneous, mass energy round forms. Classic perimeters mass no rotations or boundary friction constitutes translational energy mode ultimately conserved mass energy.

Ascending globose-outlet spout Sub-outlets make either a rounded, or an elliptical major axis upright, or a curvilinear cross-section area form that passes statistically most prevailing continual detention mass with detention free surface at said essential elevation height that also passes said largest sphere as single most unusual event. Globose-conduit classic forms constitute classic conduit forms that evolve or devolve from classic globose retention basin forms that also evolve or devolve into rounded, or curvilinear, or elliptical major axis upright forms. The first application FIGS. 1-2, and 12 cylindrical basin globose form constitutes cylindrical globose-conduit forms upright cross-sections behind, in front of its Inlet toward outlet, which transfer into elliptical major axis upright transposed into round Exhaust cross-section that are open channel forms applications, herein, continued.

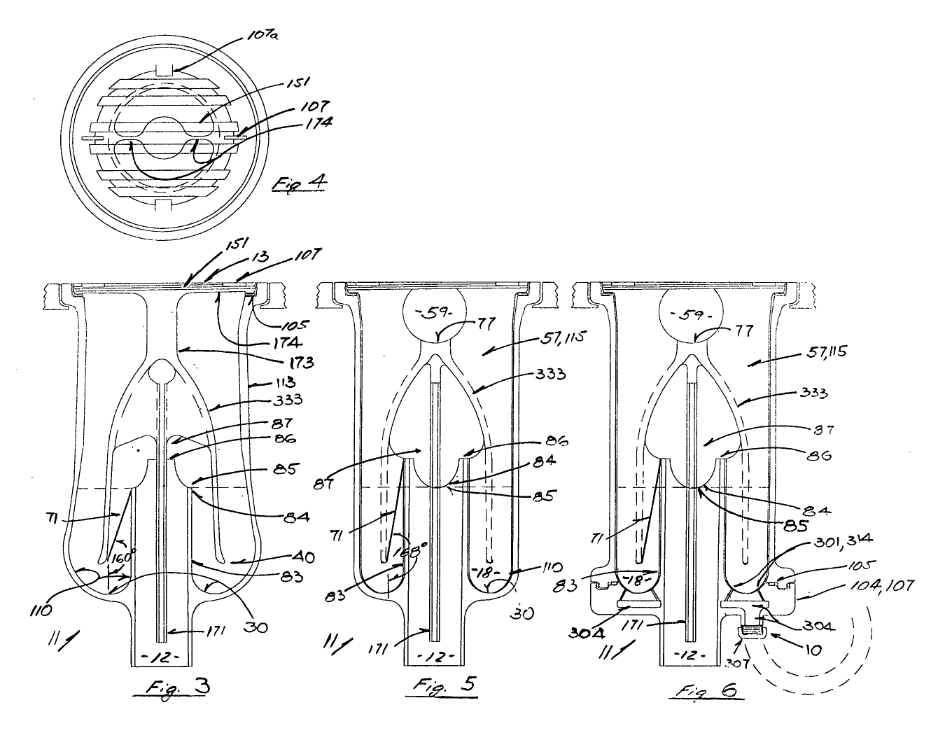

Said generic claims fluid mass energy self-conserving self-preservations allow for computed accelerated aging whose energy modes among depicted Figures or as described constitute scope of inventions, methodologies and principles of globose-conduit forms. Classic globose-conduit spout rounded basic PP lengths least sum forms surfaces, a life span aged forms, or a specific event forms make up universe of globose-conduit forms. Least globose-conduit Set of basin-outlet contained fluid mass including an Inlet, and contained entire fluid mass rotate in space transposing mechanics of forms thus make globose-conduit universe strains, domains, Sets including partitions, hybrids, mutations. FIG. 3-5 Inline domain Sets primarily make up globose-inverse domain forms that with described mutations and partitioned into multiple-cells transfer into globose domain Sets. FIG. 1-2, Section A-A forms with shown ascending outlet spout rotated to 165 degrees PAP angle with a DCSS, descending upright spout as shown in FIG. 3 transposes globose-conduit Sidelong Set to one cell of said Partitioned Inline Set, which reassembled into a globose-inverse Set constitutes depicted Inline forms. FIG. 19, an Industrial Set of forms clockwise rotated to PAP angle of about 127 degrees by described universal joint rotation connection for End 1, transforms into Low PAP angle domain Sidelong Centric Set of highly angled forms, that does not include a descending spout holding Chamber. Said Industrial Set as one DCSS curvilinear form without Sub-outlets curving parts with an upright descending outlet spout transposes into said one cell Set of said Inline domain of forms. Said Industrial Set one cell Inline forms Inlet, basin, outlet ascending spouts that make a common surface of said double wall with a donut form hemispherical descending outlet spout, holding Chamber described with Industrial Set constitutes a hemispherical outline shown by Inline domain forms. Said Angled domains described rotations for a Set of forms constitute reference to deviations from upright forms.

Classic globose-conduit, FESD complete complement of forms constitutes cross-sections, breadths, fluid mass least rotations, least permanently retained fluid mass, least perimeter breadths interface surface lengths, for energy modes least mass-energy transfer. Hydrostatic pressure centroids of basin-outlet nonhomogeneous fluid gravity segregated, transported mass is more than ⅔ of a height below retained fluid free surface elevations.

Fluid mass inflows outflows PP lengths least sum of classic globose-conduit open channel forms complete complement is least upright distance from PPLD forms highest elevations to largest fluid free surfaces for retention with detention hydrostatic pressures.

Conduit Inlets, basin-outlets open channel classic Sets constitute least height, least retained, most detained transported fluid mass that preclude suction and or venting, least height forms, a PP lengths least sum, with conduit outlet spouts narrow lower breadths.

Globose-conduit open channel forms complete complement contains conforming quantum mass PP lengths least sum that transports quanta mass with a much shorter PP lengths sum than ubiquitous art forms, for rare events or to preclude a retention suction.

Outlet, DCSS FESD forms open channel hydrostatic pressure release is fluid mass path of least resistance, first application FIG. 9 Page 13, Line 1 “laminar flow” and Line 3 “flow control”. Nonhomogeneous fluids solids open channel genus classic perimeter of mass energy forms highest conservation genome forms with mass units PP lengths least sum has at least among variables specific gravity, highest elevations of entire length least height with classic breadths or breach, surface friction, FESD forms in gravity force field.

Classic globose-conduit open channel forms for nonhomogeneous fluid mass by PP lengths least sum computation, fluid mass path of least resistance, transform, transfer into highest energy, classic nonhomogeneous, natural disposition of hydrostatic pressure, least retained, mass-energy perimeter forms.

Globose-conduit forms transfers into known, classic mass energy forms confirms they are of classic genus. Conduit lowest surfaces rounded forms with PPLD horizontal width of band reflects upon nonhomogeneous high specific gravity fluid mass, sizes of largest solid particles, among other physical parameters. Globose upper surface forms reflect upon nonhomogeneous transport fluids physical parameters and cross-sections area required. Cross-section breadths especially transition region breadths reflect upon a nonhomogeneous retained mass least height form highest mass and energy conservation.

Elliptical horizontal major axis as fluid energy geometrics forms are subordinate to globose, rounded conduit forms and except for curvilinear forms parts do not normally make up FESD forms except for preference by these very applicable specific exceptions:

A basin lowest surface part under a globose End 2, a globose-inverse First End;

A conduit form of highly homogeneous frictionless, adhesionless fluid surfaces;

A globose-conduit FESD curvilinear “crown” form that reduces forms height;

A part of curvilinear specifically applied outlet, DCSS, and Inlet FESD forms.

Forgoing excludes entirely round forms that constitute parts or counterparts of PP lengths least sum FESD, and homogeneous, adhesionless, no cohesion fluid mass forms.

The first application FIG. 12 globose-conduit Set shown slanted circumferential channels inside basin discloses globose-conduit forms cross-sections behind and in front of its Inlet. Also shown are circumferential channels multiple passages that make trough, ridge, and partition FESD forms. FIG. 12 outlet elliptical cross-sections near summit is nearly entire height of a basin upright cylindrical globose form that toward basin blind side widens then narrows with globose upper part progressively shorter in height. With a First Sub-outlet short, less than a lower half of said elliptical cross-section height that for globose forms height large breadths makes up cross-sections areas numerous forms that can match or greatly exceed cross-sections area of aforesaid vented pipe. Said globose cross-section areas that are greater or that greatly exceed a vented pipe cross-sectional area are a part of globose-conduit Sets universe constituted basin-outlet numerous forms.

Flush Apparatus tie-in assemblies with check valves can act as a controlled air and or design fluid inflow into a Set to counter suction through said single or networks of nozzles or sense a low basin fluid level to start pumping air and or design fluid. Flush Apparatus design fluids adept usage approximates near frictionless surfaces.

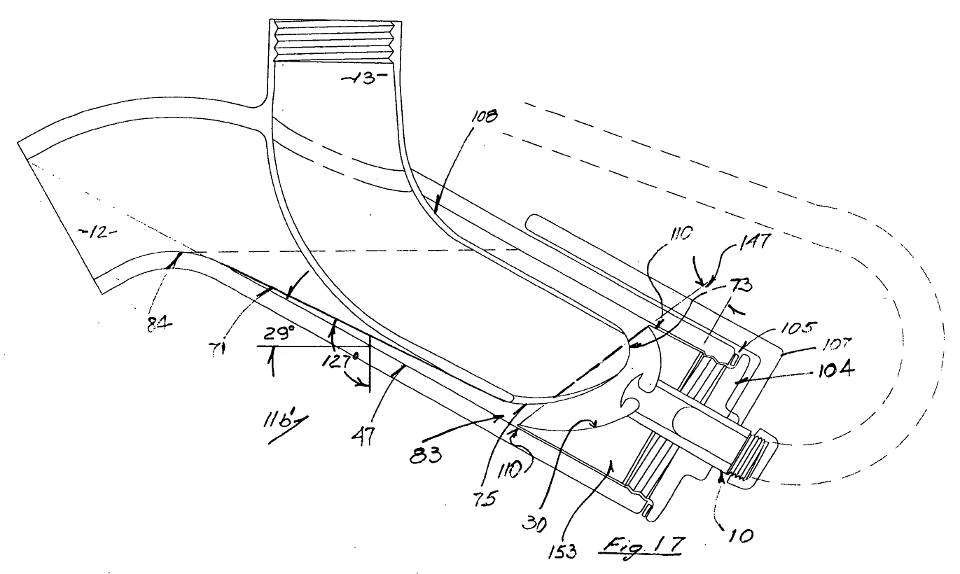

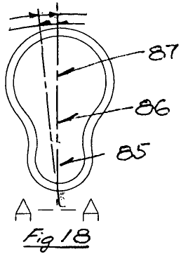

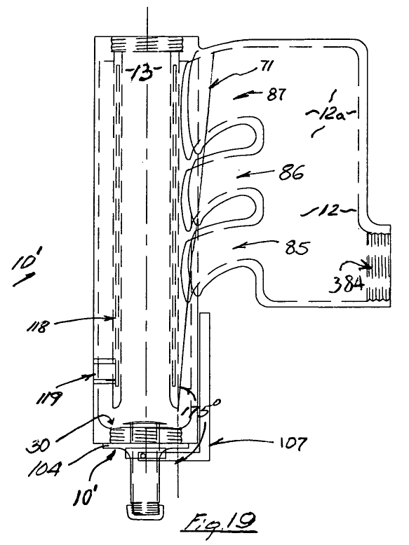

Forgoing describes ways to avoid suction. Tie-in apparatus to Flush Apparatus to control suction toward conservation of energy by one-way air inflows at fluid elevation and pressure below free surface “at rest” elevation is to start various air, fluid, and spray flushing when said level and pressure are low. Said Flush Apparatus is shown with the first application separated branch inlet 12′ tube. Herein, it is considered support apparatus assembly for conservation of fluid mass and energy. A branch inlet enlarged to bridge a basin blind side, Inlet breach makes a Bridging Wall FESD, or specific location placed, orientated an manager, space manager FESD form continued from the first application. Said FIG. 12 upright symmetrical cross-sections are globose conduit cross-sections of cylindrical form herein continued globose and cylindrical globose-conduit forms. Said globose-conduit form constitutes said Partition, Ridge, and Trough forms, wherein said sloping channels toward discharge increase upper globose form part, which is appropriate for drainage pipes and sewer lines construction. Granted patent shows a flexible drainage line with degrees of freedom generally unimpaired, a much smaller cross-sectional area, a narrower PPLD width of band close alignment to a linear PAP inherent of a laminar flow and flow control means for it. Said patent did not identify drainage line various varying shapes various end connections suction or venting. As constituent Set of said globose conduit universe the forgoing does with specificity either as a sewer line or a drain trap. Said FIG. 12 separate branch inlet, 12′, tube through basin's blind upper casing to proximity of basin lowest surface continuation applications Flush Apparatus accounts for its numerous functions with design fluids and gases including air. With its cap removed said branch inlet constitutes a Flush Apparatus tie-in and a major passageway, which can branch out inside walls of Sets for single or complex and advanced nozzle assemblies FIG. 13, 13a among other Flush Apparatus shown assemblies. Said tube larger size with nozzles constitutes bridging-wall FESD equipped with Flush Apparatus assemblies.

Said PP lengths least sum computed cross-sectional areas is algorithm computed statistical probability that solids and fluids mixture samples and elevations retention free surface probability combine into a statistical probability of both constituting frequency of occurrence bounded by standard deviations. Under said deviations among computed and actual conditions, Flush Apparatus penetrations do no effect primary functions of a Set.

FIG. 1 of the drawings shows a Globose Sidelong invention Set 10a cross-sectional side view taken generally about PAP upright plane of symmetry. A near upright inflow Inlet, 13, makes a rounded lower end annular form, an End 2, 40, an upper end, an End 1, 38. A basin-outlet makes a near spherical globose basin form, 18, a narrow finite length horizontal widths merged into a band side elevation viewed as a shrunk “S” PPLD form started from a basin rounded lowest spot, 89, aforesaid outlet form ends in a summit, 84, narrowest width of band of a DCSS lowest horizontal segment form that is orthogonal to said summit and PPLD form. Basin-outlet outlet, 12, forms consist of an ascending spout that makes up said PPLD form from an outlet First End, 83, surface inflection into said summit DCSS and into an outlet descending spout from said DCSS into an outlet Second End, Exhaust, 384, round form. Sets invention basin-outlet of a classic retention genome mutated form amalgamates forms into complete complement, mechanics of forms. Inlet sides and globose near hemispherical basin constitute narrow breach, said upper retention short height cross-sectional area, Cavities FESD, 50, conduit forms that merge by basin's narrowing into said outlet conduit ascending spout First End. Said End 1 topside of said End 2 undersurface above a short height, 88, under Inlet conduit form that stars with said undersurface, basin blind side common surface and is generally topside said basin PPLD rounded lowest surface spot location closes to said outlet DCSS. PPLD forms make for retained and inflow fluid, nonhomogeneous, nonuniform, nonsteady, mass energy forms that statistically constitutes highest transfer from kinetic to potential energy mode by PP lengths least sum till entire retention of finite units of mass at rest is replaced by random infinitesimal mass, energy, inflows. Fluid energy mass detention is topside of permanent retention which the forgoing defined as fluid mass free surface at rest, 1. Permanent and detention retention free-surface elevations, largest breadth and longest length elevations, for computed finest approximation of PP lengths least sum constitute successive shortest height elevations difference from said lowest PPLD FESD round spot to having highest PP, said springing points elevations, upper symmetry limits. Globose End 2 and globose-inverse First End forms are entirely submerged in a conduit to globose transition region rounded surface area forms breadth transitions, globose to conduit intermediate regions below upper retention. Transition regions, at most, are from lower conduit, 88, springing points to DCSS springing points. Said ascending outlet conduit rounded spout ascends from a First End surface inflection, 83, to said summit, DCSS, to descend as a descending spout to an outlet Second End Exhaust, 384. Said End 2 in aside elevation view a convex undersurface sustains short conduit height separation from said basin lower, lowest forms counterpart FESD surfaces that from said basin blind side structurally prepare for kinetic to potential energy said modal change. Said change start with said PPLD rounded lowest spot under said End 2 undersurface that by PP length least sum is shortest distance to end at said DCSS narrowest, highest width of band summit. Said PPLD globose generic “S” highly shrunk, highly forward slanted form constitutes a PAP angle of 105 degrees.

Said open channel mechanics of forms for a potential to kinetic energy half mode change by said PPLD narrow width of band form is most suitable for a laminar flow and flow control means stated by the first application. Other half part of energy mode cycle is potential to kinetic energy change that starts with said End 1 inflow. Upright sections that cut through basin clear of Inlet consist of said upper area short height globose form, lower area conduit form having at most a transitions region least height from said conduit to globose springing points, respectively conduit height midpoints globose largest breadth points. Said three make up said globose-conduit, G-C cross-sections area forms that said FIG. 12 of the first application shows and are continued here, in pending applications as globose, cylindrical versions of globose-conduit generic, classic cross-section area forms.

Globose-conduit cross-sections upper globose lower conduit forms allow varying breadths, breaches respective length restricted by permanent retention, free surface forms at rest, and globose-conduit classic forms genomes least mass least height that constitutes energy, mass highest conservation generated by said classic short height compact forms.

Globose-conduit nonhomogeneous nonuniform nonsteady inflows of fluids mass specific gravity and gradation of solid particles generate fluid detention mass with highest hydrostatic pressures and classic conduit forms amalgamated into classic perimeter forms conserve inflows generated energy and pressures HIGHEST amount to transport its mass.

Said End 1 cross-section net area of the first application FIG. 1-2, 9, 12 and herein this Figure shown is a multiple smaller than either area of its respective DCSS or Second End Exhaust. Wherefore hydrostatic pressure in a container of said fluid mass mixture to cause its almost always round and thus its round counterpart End 1 net area to run full but not under a hydrostatic pressure causes in turn a rise of retained fluid free surface into its detention range. Said rounded DCSS lower area FESD form resembles or as necessary is a First Sub-outlet herein an oblong, pointed egg end, form that keeps widening through a height midpoint counter rotated into DCSS springing points for a globose upper part of its cross-section. Said fluid mass inflow quantity that causes End 1 entire net area to run full causes fluid mass surface elevation proximate DCSS springing points. Said Second End Exhaust round cross-section equivalent in area to said DCSS cross-section area is under a potential hydrostatic pressure drop that extends to DCSS and, in this example, is less than half full of mass fluid. This off course allows for hydrostatic pressures in said fluid mass container. To account for any hydrostatic pressure in fluid mass a modified form of this DCSS upper transition enlarged breadths into said globose form breadths is enlarged up to three times a vented pipe breadth to which it connects, the first application FIG. 1-2, 12 show with circumferential channels FESD forms. Said DCSS classic forms, FIGS. 3, 5, and 18, here, wherein the latter Figure shows globose form breadth that is increased for a DCSS required area. Further, a one way air inflow nozzle, relief of suction, in globose crown eliminates suction for extreme quantities of fluid mass passing through said basin.

Said basin blind side shows a surface inflection, 80, said rounded surface having said basin and PPLD lowest surface, 89, a PPLD highest slope 50 degrees, 47, for a PAP angled leg, 47, of 105 degrees. Said undersurface shows convex form about a blind side end, a front end, 75, 73, respectively d′, d″. Kinetic to potential energy modal change extends to said summit. Said PPLD “S” form smooth surface and PPLD PP are interface of fluid mass and structure thin boundary layer separated. Clearly the former is structure. For difference in forms the two are same, except an infinitesimal scaled fluid PPLD PP is topside of PPLD structure form and as such are considered herein. FIG. 1 illustrates basic mechanics of forms of globose-conduit universe. A curvilinear perimeter cross-sections compact composite that shows enlarged breadth globose upper form similar to or larger than shown by FIG. 3,5 DCSS least height First, 85, Second, 86, Third, 87, Sub-outlet as such cross-sections areas forms is typical, with PP lengths least sum upright lengths 32 times multiplied. Said DCSS constitute an outlet and a summit FESD forms. FIG. 1 is a basic Set shown without a Flush apparatus assembly that inside and integral part of walls constitute globose-conduit surfaces maintenance highest conserving of mass and energy.

A threaded End 1 connects positively to a fluid solids mixtures source. Continued from the first application, Inlet form constitutes a short height.

Section A-A of FIG. 1 shows a partial section top view generally taken about Line A-A illustrating narrow breach conduit forms on Inlet sides inside described basin Sidelong form having narrow breach Cavities FESD, 50. An Inlet and an End 2 FESD form vary consistent with basin-outlet retention form genome and their location in respect to summit cross-section form, especially as outlet and DCSS FESD counterpart forms. A typical fluid reservoir round drain Inlet form matches. Inlet non-round forms are planned.

FIG. 2 of the drawings is a globose universe Globose Sidelong, Form 10a, side elevation cross-sectional view taken generally about a PAP upright plane symmetry with mechanics of forms generally described and illustrated with FIG. 1 for angled near upright Set. Said Inlet End 2, 40, constitutes an Infant-Boot, 45, FESD form to extend length and width of said lower conduit FESD form, 88, and further shorten seamlessly cross-sections forms conduit height, narrow breadth inside said lower basin globose hemispherical form. Said conduit cross-sections orthogonal to its PPLD form are Inlet, End 2 separated area from an upper retention likewise said of a short height form. A basin and an End 2 FESD forms constitute rounded streamlined control surfaces, said PP lengths least sum, shortest of separations, counterpart FESD forms that subdivide fluid mass into narrow breadths or short heights or both having smaller fluid mass forms or remove a basin-outlet not needed retention fluid mass. Said End 2, with or without Nozzle FESD forms do all of forgoing; its FESD form displaced fluid mass makes for smaller retained fluid mass and smaller PP lengths sums which conserves both fluid mass and energy. This Set is especially suited to pass high specific gravity fine grained, gap graded to large, solid particles, which require higher quantity of transport fluid for passage that is provided by shown elongated Nozzle FESD forms, 54. A PAP angled leg, 71, has angle of about 110 degrees, 71. Said PPLD shrunk “S” form is highly forwarded slanted having a maximum slope pitch, 47, of about 50 degrees. A Flush Apparatus invention constitutes a tie-in, shown as capped, that in service connects to an outside source of design fluid under pressure to implement surface cleaning designed functions that is integral part of conserving fluid mass and energy. Flush Apparatus and plug member assemblies are other Figures enumerated, mechanics of forms introduction to the drawings described.

Specified mechanics of forms, forgoing stated explained, especially FIG. 1 specific forms extend and apply herein, as well as to other illustrated figures.

Section B-B generally taken about Line B-B of FIG. 2 shows a top view of said Infant Boot, sides conduit forms of narrow breach as Sidelong form Cavities FESD, 50, elongated Nozzles, 54, and an Inlet double wall form. Introduction description details apply herein and incorporated into foregoing fully describe this globose forms illustrated Set. Globose alike forms are exchangeable ranging from generic and basic globose-conduit forms of rounded transitions to compact composites.

FIG. 3 of the drawings, a cross-section side elevation view taken generally about a PAP symmetry plane, shows globose universe Globose Inline Centric inventions, Set 11, about upright as mechanics of forms and FIG. 1 explain. An Inlet, 13, has an inner, 333, hollow conical largely a surface of revolution Partition form, that encloses conduit spouts upright outlet forms, with a lower end a flared rounded End 2 FESD forms. Basin outlet forms constitute largely a globose hemispherical composite shortest two PAP angled legs, 71, one on each diametrically opposite side of said Inlet, outlet with PAP angles, 71, of about 160 degrees. An outer Inlet, 113, form extends from said basin-outlet, with a slight narrowing of rounded cross-sections areas into an End 1 positively connected, supported about said End 1 by a blind flange of fluids and waste particles mixture container. Basin lower surface rounded valley sides, 110, and lowest surface narrow width of band PPLD FESD forms are annular FESD forms under, around an outlet, 12, ascending, descending spout, respectively. Basin-outlet spout forms constitute a narrow and then a widened and narrowed breach and area annular cross-sections of said Inlet into outlet ascending spout, which constitutes an FESD manger forms inventions that varies velocity of fluid mass as it negotiates a sharp turn. Said outlet upright spout outside surface and a hollow conical form inner surface constitute ascending outlet spout decreasing breach cross-sections and area outlet FESD form from a First End, 83, said End 2 into a First, 85, a Second, 86, and a Third Sub-outlet, 87, DCSS FESD forms. Said DCSS three-dimensional surface FESD form dwarfs First Sub-outlets areas with two summits, 84, and PPLD forms, PAP aligned symmetric. Said outlet as a rounded form Partition FESD manager splits ascending spout breach and rising spouts cross-sectional areas, narrows otherwise wide breadths through a significantly large PAP angle, and as an FESD removes a detrimental space under Inlet for PP lengths lower least sum. This constitutes short among shortest PAP and aligned, rounded surfaces counterpart forms for an End 2 FESD to a basin lowest surface, a PPLD FESD, and a DCSS FESD forms. Said descending outlet spout is a three-dimensional and Partition FESD manager form because of said management of retention forms breach and cross-sections that separates fluid inflows into two, DCSS FESD Sub-outlet forms. Said outlet centric, a perforated upright tubing, 171, side plates welded to said hollow conical form with a space gap under apex constitutes a three-dimensional Partition FESD conduit round form and perforations as two-dimensional Window FESD forms to control suction. Said outlet FESD two DCSS FESD Sub-outlets constitute counterparts surfaces to Inlet cross-sections and said End 2 FESD undersurface and. Said hollow conical form Partition FESD ends into a post, 173, form. Inlet outlet FESD counterparts constitute basin-outlet conduit spout side surfaces lower basin surface and PPLD FESD counterpart forms. An Inlet conical form with an outlet spout inside and moved across retention form constitutes Sets mutations. An outlet moved across Inlet retention constitutes mutation in respect to an Inlet with outlets designations or conversely constitutes Inlets designations. Two sets of mutations exist, one inside basin the other inside Inlet that must account for PP lengths sum for an angled Inlet and an outlet, an angled Inlet with a counter rotated outlet, and an angled Inlet, and an angled outlet that constitute respective PP lengths least sum forms. A horizontal plane rotation eliminates duplication of Sets that are not space directional and rotational degrees of freedom limited, but said breadth, breach, and height are. Globose Inline Set forms make-up numerous domains. This Set as a globose cylindrical hybrid has globose lower and cylindrical upper forms. Inline Sets with multiple Partition managers are planned. A one Partition manager FESD form FIG. 5 shows. An Inlet form around an outlet First End inside basin constitutes a globose-inverse hybrid wherein Inline Sets are globose, globose-inverse hybrids that partition into sidelong Sets as described, planned with typical globose, globose inverse sidelong forms. Inline Sets also mutate from centric to sidelong Sets and by partitioning into multiple cells to counter suction Sets can readily accommodate a larger descending spout than a vented pipe to which it connects. Said End 2 FESD flares into a basin cross-section constituting a narrow breach that with a sharp turn inherently radially narrows into and through an ascending outlet spout. Said conical form is three-dimensional Partition FESD form, whose hallow upper end encloses three-dimensional DCSS form topside outlet ascending, descending conduit forms. A one way air inflow through a hollow conical form said post and its brace from or outside of said Inlet into basin makes an FESD space manager. A length of said outlet descending spout controls suction magnitude and should suction develop is not sufficient to lift entire fluid mass in said Inlet, basin-outlet and thus cause venting through Inlet. One may think that suction is acceptable or desirable as atmospheric supplements hydrostatic pressure to pass fluid mass. This is not necessarily viable because suction is typically caused by an out of ordinary and excessive use of transport fluid mass. Properly selected Inline domain Sets function well with or without suction to conserve fluid mass and energy. Said perforated tubing allows for incremental length engagement of suction. Sidelong outlet Inline Sets allow an air inflow one way nozzle near said apex, crown of outlet spout forms, at or near top of a descending spout. This stops suction with atmospheric pressure air mass inflows that transport fluid mass, as an FESD space manager, SM, that allows air inflows should said perforated tubing, 171, suction exceed permitted fluid mass suction force. Said Inlet upper part is a cylindrical globose form topside of globose Inlet and basin-outlet conduit spouts which amalgamate fluid mass into one globose form. A front view of said DCSS shows a circumferential Ridge three-dimensional FESD form rising from summit which continued rising as such makes a Ridge-Partition FESD form ending as a Partition FESD form. Said Partition is likewise a circumferential three-dimensional Window FESD. Said FIG. 5 Partition is a two-dimensional Partition FESD form and said First Sub-outlet is a Trough FESD form with sides as an uppermost edge constituting one sided Ridge FESD forms. Said Inlet, DCSS FESD elevation view shows a circumferential three-dimensional G-C, globose-conduit, FESD form with respective breach, breadth, and cross-section area with said Partition inside and said Trough, Ridge, Partition above outlet spout forms, best shown by FIG. 5. The First Application FIG. 12 illustrates forgoing circumferential FESD forms, G-C, globose-conduit cross-sections therein shown in an elevation side view that PAP direction orthogonal constitute three-dimensional FESD forms converting a conduit Inlet to a globose-conduit basin-outlet to a conduit outlet FESD forms. Globose-conduit universe forms are said PP lengths leas sum amalgamated globose retention and conduit transport fluid mass forms into one perimeter forms universe of forms with fluid mass in retention and energy transport constitute highest conserving forms that amalgamate into said conforming embodiments of Sets. Said two amalgamated by PP lengths least sum constitutes fluid mass and energy in retention and transport highest conservation. Said FIG. 12 separate branch inlet 12′ capped at known fluid surface and set air pressure, that will resist free surface changes from said elevation. Such FESD, SM, space manger and forms are part of planned and separate forms that as such can extended horizontally. Said DCSS one or two FESD Sub-outlet forms constitute a circumferential hybrid basin-outlet form. Said post is fixed in place by a flange brace, 174, a brass gasket, 105, a strainer, 151, and keys, 107, 107a, treaded about an End 1. Connections and strainers known in art are planned for positive rigid connections. An End 1 connects to a flange of said fluid mixtures container with a forced pressure fit, welded, and treaded flanges are among rigid connections planned. Said optional air inflow into said conical Partition constitutes a one-way nozzle back up contingency. A basin-outlet, holding Chamber FESD space manager for domains of Inline Sets is planned. Various PP lengths least sum for this hemispherical Set forms is planned by varying breach, breadth, diameter with added partition(s) to one FIG. 5 depicts. The first application Set FIG. 1-2, 12 shown cylindrical three-dimensional FESD forms are two partitioned outlet forms partial circumferential fluid mass direction FESD forms. Said first application circumferential forms and FIG. 9 multiple veins are herein FESD Partitions forms that FIG. 5 shows.

FIG. 4 of the drawings shows a top view of Globose and Cylindrical Inline Centric Sets inventions FIG. 4-6 depict. A round End 1 shows generally a round Inlet form that reflects drain opening in a container of said fluids, solids mixture. A crescent opening is planned to match a rounded crescent End 1 FESD forms inflows close to outer perimeter centroids of inflow area and fluid mass for PP least lengths smallest sum to DCSS forms. Inlets lengths, heights, cross-section dimensions constitute counterpart forms to PPLD respective bands entire forms infinitesimal widths whose rounded lower surface lowest, horizontal segments constitute PAP upright plane symmetric basin-outlet spouts through DCSS globose form springing points that includes at least a respective End 2. Said FESD forms counterpart relationship tie up constitutes said finest algorithm computing derived respective Set forms fluid mass and energy highest conserving by PP length least sum for any Inlet fluid free surface elevation make up globose conduit universe domains of forms. As FIG. 1 explains counterpart FESD relationship need not exceed height of a basin-outlet spout DCSS globose springing points, a respective Inlet detained fluid mass free surface elevation. Otherwise a globose strainer basket of a larger globose basin-outlet, globose-conduit FESD ascending, descending spouts is required or transport fluid is a wastewater. Said wastewater recouped mass energy transfers said universe Industrial domains Sets do.

FIG. 5 of the drawings, a cross-section side elevation view generally taken about a PAP plane of symmetry of a Globose Inline Centric Cylindrical SET 11A, which shows a two dimensional Partition, 57, 115, FESD manager form that splits Set forms into about equal halves. A similar cylindroid Inline form is planned. A two-dimensional rounded upper Partition Window, 59, FESD form doubles cross-sections breach about, through an Inlet upper end. In operation, fluid rising in one of retention forms to a Window height, inflows into retention with a lower free surface. A Partition FESD manager is a freely supported form about its sides with or without a locking flange brace. A Partition FESD Window edge ranges from sharp to fine rounded and conical post forms feather into said edge form. A DCSS FESD form front elevation view, circumferential three-dimensional G-C FESD forms topside and outlet conduit forms FIG. 4 depicts.

FIG. 6 of the drawings is a cross-section side elevation view generally shown in FIG. 5 further depicting a Flushing Apparatus assembly consisting of a Capping Member, 104, 107, a tie-in, 10, a circumferential major, 304, passageway, sub-nozzles, 301, set, 314. A Capping Member, 104, 107, includes an upright outlet, 12, form, a basin lowest surface and PPLD FESD form, and said Flush Apparatus, which keeps said basin-outlet with least friction lower lowest surfaces. Where complete disengagement and removal of basin lower surface is required said outlet Second End welds to a treaded universal joint connection to said vented pipe. A Partition FESD manager removal from underneath a container of fluids solids mixture is available by its support off basin lower surface only.

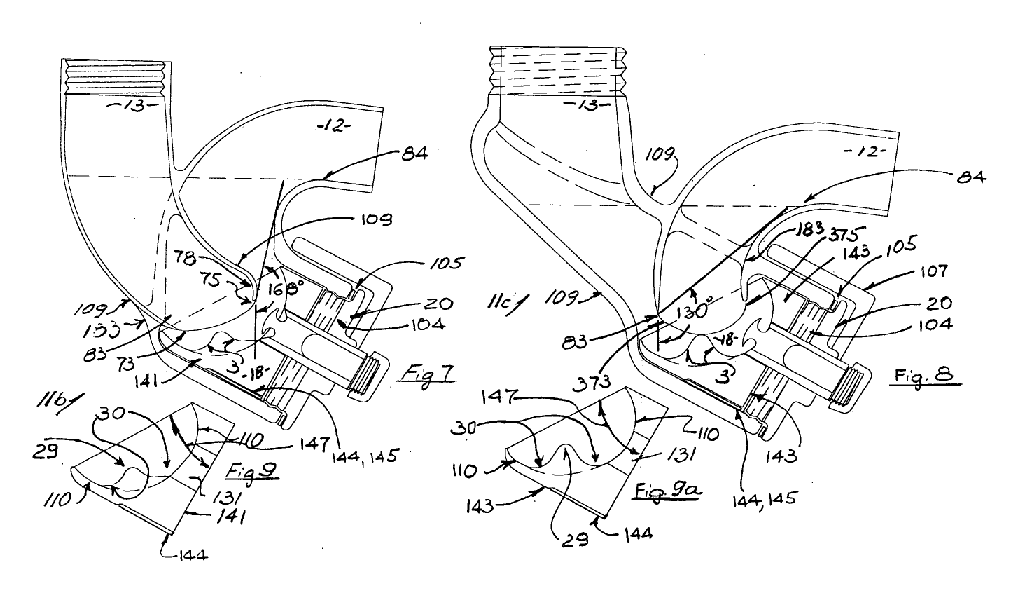

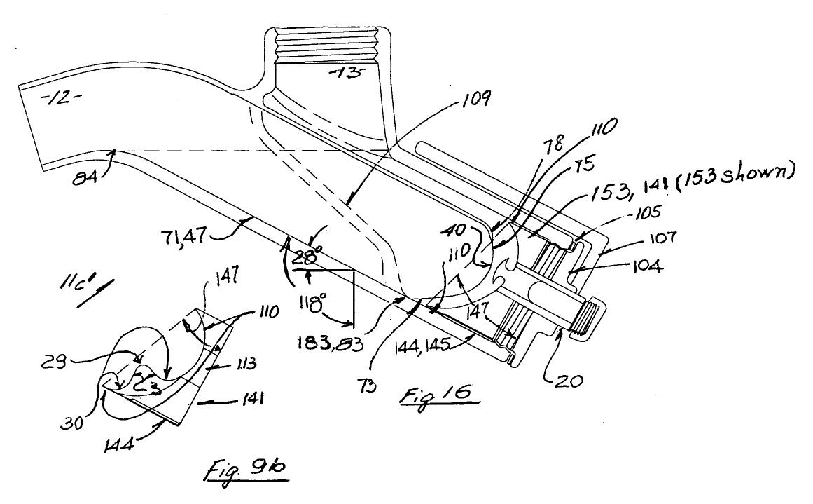

FIGS. 9, 9a, 9b, and 12 of the drawings show a side elevation cross-sectional view of a basin lower surface respective Filler Member 141, 144, 344, and, 141 taken generally about PAP plane of symmetry and PPLD crescent, annular, rounded, and crescent FESD forms, respectively. Said Members interchange for composition, quantity, and quality of fluid mass a designated Set passes. FIG. 7, FIG. 8, and FIG. 16, depict such an interchange.

FIGS. 7, 10, and 14 of the drawings are cross-sectional side elevation views taken generally about PAP symmetry plane of Globose Angled Sidelong inventions Sets 11b. Said highly angled forms are angled from a lower basin. From a basin-outlet intersection an Inlet upper end rotates to near upright having said End 1. A globose Set forms End 2, a basin-outlet lowest surface, and its outlet forms counter rotate to complete complement of FESD forms. Sets nearly upright Inlet upper end constitutes nearly an entire End 1 cross-section area topside retention free surface at rest, permanent retention. A globose-conduit spout and said angled conduit Inlet that significantly diverge from a globose lower basin common location constitute a First End, 83, about said End 2 and, nevertheless, make for one length upper retention form of said Inlet and outlet spout retained fluid forms. Said Inlet conduit upright component length transforms potential to kinetic energy and counter rotated said basin outlet lowest surface, PPLD, form toward upper retention, and said PP lengths least sum, least upright components conserves most of said fluid mass energy. An outlet elliptical upright major axis spout FESD form extends through a DCSS, 84, FESD form into an outlet Exhaust round form, as explained with FIG. 1. Mechanics of forms entirely apply as for upright Sets, prior Figures, and especially FIGS. 1-4 explanation of complementing forms that implement outlet and DCSS FESD forms to said open channel construction extended through an outlet FESD generally arched form to said Second End. The first application FIG. 12 two sloping channels about a deeper and more than twice as wide basin at its largest breadth converge into its Second End round form as large if not larger than said vented pipe. Described mechanics of forms complement of forms prior Figures describe this, also. A convex profile of said End 2 FESD forms and counterpart globose basin PPLD FESD by said rotations nearly horizontal transfer mass, its energy with highest conservation from said Inlet into said basin-outlet forms. Sets PAP angles because of rotated First End, basin-outlet outlet spouts lowest surfaces are only about 168 degrees. Upper retention two conduit forms retained fluid mass as forgoing stated is short of an elevation that separates forms, which retains fluid at rest compact mass. A rounded basin rounded annular valley lowest surface, 30, lowest spot respective rounded, crescent form with valley outer, inner sides FESD, 3, about a conical rounded apex, 29, where it is shown, make up said PPLD width of band. Basin surfaces lowest PPLD forms are blind side located and constitute PPLD, End 2 FESD counterpart forms short height separation. Flush Apparatus and plug member assemblies are other Figures enumerated, mechanics of forms introduction to the drawings described.

FIGS. 8,11, and 15 of the drawings are cross-sectional side elevation views taken generally about PAP symmetry plane of Globose-inverse Angled Centric, Centric, and Sidelong, 11c, 11c, and, 11cc, Sets, respectively, related to globose highly angled Sets.

Said highly angled forms are angled from a lower basin. From a basin-outlet intersection an Inlet upper end rotates to near upright having its End 1. A globose-inverse First End, a basin-outlet lowest surface, and its outlet forms counter rotate to complete complement of FESD forms. Sets nearly upright Inlet upper end constitutes nearly an entire End 1 cross-section area topside retention free surface at rest, permanent retention. A globose-conduit spout and said angled conduit Inlet that significantly diverge from a globose lower basin common location constitute said End 2 about a First End, 83, and, nevertheless, make for one length upper retention form of said Inlet and outlet spout retained fluid forms. Said Inlet conduit upright component length transforms potential to kinetic energy and counter rotated said basin outlet lowest surface, PPLD, form toward upper retention, and said PP lengths least sum, least upright components conserves most of said fluid mass energy. An arched rounded or elliptical, upright major axis, spout outlet FESD form passed a DCSS, 84, FESD form ends with an Exhaust round form as FIG. 1 stated. Mechanics of forms entirely apply as for upright Sets, prior Figures, and especially FIGS. 1-4 explanation of complementing forms that implement outlet and DCSS FESD forms to said open channel construction extended through an outlet FESD generally arched form to said Second End. The first application FIG. 12 two sloping channels about a deeper and more than twice as wide basin at its largest breadth converge into its Second End round form as large if not larger than said vented pipe. Described mechanics of forms, complement of forms, prior Figures describe. Said First End FESD convex profile of forms and counterpart rounded globose basin PPLD FESD forms by said rotation near horizontal forms transfer mass, its energy with highest conservation from said Inlet into said basin-outlet forms. PAP angles because of rotated First End, basin-outlet outlet spouts lowest surfaces are only about 130 degrees. Upper retention two conduit forms retained fluid mass as forgoing stated is short of an elevation that separates forms, which retains fluid at rest compact mass. A rounded basin rounded annular valley lowest surface, 30, lowest spot respective rounded, crescent form with valley outer, inner sides FESD, 3, about a conical rounded apex, 29, where it is shown, make up said PPLD width of band. Basin surfaces lowest PPLD forms are blind side located and constitute PPLD, End 2 FESD counterpart forms short height separation. Outlet spouts with curvilinear DCSS FESD forms are planned counterpart to said PPLD FESD consistent with mechanics of forms for globose Sets and domains. FIG. 7, FIG. 10, and FIG. 14 show FIG. 9, FIG. 12, and FIG. 9 Filler Member, 141, 344, and 141, respectively. Filler Members are interchangeable and are a part a Plug Member, 104, with a key, 144, a gasket, 105, and includes a Flush Apparatus assembly. FIG. 10 of the drawings replaces a Filler Member, 141, shown in FIG. 7. Filler Member, 344, makes rounded basin lower surfaces, 30, with sides, 3, and a PPLD FESD rounded lowest spot form. FIG. 14 of the drawings substitutes an End 2 FESD form for on FIG. 7 shows as another End 2 FESD angled convex rounded form. Flush Apparatus assembly respective parts are similar to identical also depicted in FIG. 13 and FIG. 13a. Flush Apparatus and plug member assemblies are other Figures enumerated, mechanics of forms introduction to the drawings described.

FIG. 13 of the drawings shows a side elevation cross-sectional view of a basin lower surface Plug Member, 104, and Flush Apparatus assemblies taken generally about a PAP plane of symmetry showing the following:

A handle, 107, a Filler Member, 20, a basin lowest surface valley, 30, PPLD FESD forms, a valley rounded inner side, 3, a conical form, 29, and a gasket, 105;

A Flush Apparatus, 10, assembly, has a treaded tie-in shown with a cap, 307, a major passageway, 304, a sub-passageway, 303, a sub-nozzle, 301, and a major nozzle, 305. Assemblies parts are exchangeable based on fluid mass composition and quality.

FIG. 13a of the drawings is a top view of a basin lower surface and PPLD FESD form of a Plug Member and Flush Apparatus assembly FIG. 13 shows.

FIG. 16, 17 of the drawings is a cross-sectional elevation side view taken generally about a PAP symmetry plane of a Globose-inverse Low PAP Angle Sidelong, a Globose Low PAP Angle Centric, inventions Set 11ca, 11BC, of respectively highly angled forms that angle from a lower basin. From a basin-outlet intersection an Inlet upper end rotates to near upright having its End 1. A globose-inverse First End and a globose End 2 convex form side view shown with partially near horizontal form and basin-outlet lowest surfaces respective counterpart forms complete complement of FESD forms. Said Inlet upper end about upright constitutes most of an entire End 1 cross-section area topside retention free surface and entirely with its small rise. A cylindrical globose-conduit, said upright Inlet conduit significantly diverge from a globose lower basin common location globose End 2 about a First End, 83, globose-inverse First End about End 2, respectively. Said Inlet and basin-outlet spout permanent retention is one short height cylindrical thus a globose form, which narrows into outlet ascending, descending spouts. Said Inlet conduit upright length transforms potential to kinetic energy. Said rotated basin, Inlet, and outlet lowest surfaces transfers kinetic energy from respective End 2 into respective outlet form and least height and breadth, breach forms constitute said PP lengths least sum, least upright components conserves most of said fluid mass energy toward intended discharge. An outlet elliptical upright major axis or a rounded spout FESD form arches into a DCSS, 84, FESD form to an outlet Exhaust round form as explained with prior Figures and mechanics of forms that entirely apply. As for upright Sets, prior Figures, and especially FIGS. 1-4 explanations of complementing forms, implements outlet and DCSS FESD forms to said open channel construction extended through an outlet FESD generally arched form to said Second End. Said PAP angle through a basin-outlet outlet spout is 117-118 degrees only. Said rounded basin rounded lowest surface, 30, or a substitute plug member crescent form constitutes a PPLD FESD lowest spot, which starts said PPLD width of band. From basin respective sidelong locations constitutes said short height separation to respective First End, End 2 FESD form. Flush Apparatus and plug member assemblies are other Figures enumerated, mechanics of forms introduction to the drawings described. An inlet upright end shown anti-sidelong offset is planned for stated known mutations of an Inlet in respect to an outlet and vice versa with a range that exists for entire universe.

FIG. 18 of the drawings shows a G-C, globose conduit, “kidney”, globose-conduit cross-section form, made up of a lower smaller area rounded conduit, 85, form, a rounded transition surfaces intermediate, 86, area, and an upper area rounded, 87, globose form, a compact composite area curvilinear form about as shown, PAP upright plane symmetric. Said composite forms constitute nonhomogeneous fluid mass nonuniform and nonsteady transport without entire fluid mass finite length horizontal plane rotation frictional forces, with hydrostatic and gravitational weight pressures friction forces primarily translational transport constituting said PP lengths least sum for said length. Said finite length entirely translation transport of fluid mass constitutes classic globose-conduit form and its classic perimeter form. A G-C DCSS FESD form, a composite of three dimensional DCSS forms generally separated into three sub-outlets forms, or one compact composite of forms is a generic basic conduit FESD form to transport a fluid waste mixtures that constitutes said classic forms. Among various fluid mass energy transport or transitions of forms, it is a generic building block to change conduits to globose forms and vice versa that transform potential to kinetic energy forms and vice versa. Said G-D FESD form is highest energy conservation that based on fluid mass properties by PP lengths least sum transfers into to a rounded, an elliptical, or a curvilinear form, wherein for an entirely pure fluid mass we know the form under hydrostatic pressure is entirely round. Properties of fluid mass must include not only its composition but quantity and its duration also. Thus, G-C transfers of forms of energy are most energy efficient. Clearly one form conserves most energy for a specific use compared to other forms. G-C FESD forms conserve potential energy modal change transfer to kinetic energy and vice versa for transported fluid mass mixtures that pass through drain traps drainage lines and or sewers. Said globose-conduit universe of forms has a specific classic form with its classic perimeter form for a specific cross-section at a specific location that is statistical data probabilities computed for fluid mass composition, quality and quantity, as depicted by Figures such as FIG. 1, 3 DCSS.

Conduit inverts PPLD forms infinitesimal length cross-sections segments of finite horizontal length constitute highest elevations for retained fluid mass having least height. First Sub-outlet forms constitute continual inflow rounded conduit form detention, sewer and drainage lines continual retention that by statistical probabilities qualify as permanent retention having said PP lengths least sum highest fluid free surface elevation, respective breadth and depth that pass particles largest sizes. A basic detention free surface elevation constitutes least fluid mass height passing largest submerged size solid particle. Conduit springing points are located higher because they initiate transition, intermediate regions out of ordinary fluid mass inflows wherein said composition, quality, and quantity change constitute said PP length least sum that constitutes fluid free surface highest elevation for a respective event cross-section breadth, such as sewers storm water runoff. For extreme events, such as a 100-year storm, said runoff is primarily a huge clean rainwater quantity, wherein solid particles segregated toward fluid mass lower elevations requires an upper perimeter of about globose forms, PP lengths least sum computed. From said conduit to globose forms springing points constitutes transition region wherein said PP least sum of highest fluid free surface elevations constitutes computed breadth classic curvilinear form conduit, intermediate, and globose classic perimeter forms. Said sewer construction is an example, only. Described method has perimeter algorithm computed forms that provides near exact highly specific perimeter forms fluid mass and energy highest conservation for including highly specific events, with fluids gaseous state exceptions applications noted.

This form is angled, based on infinitesimally angled PAP plane of symmetry. It is shown as extended from having a PPLD form rising slope with detention phases highest confined globose-conduit globose form for pant-up hydrostatic pressure, a transport fluid highest conserving that extends from a basin-outlet conduit spout. A globose-conduit's globose area heights vary, from about 5% to about 95% of entire cross-section height, with globose breadths up to many times greater than a vented pipe to which it connects. The first application FIG. 12 globose basin channels show such relation, which is no limitation of globose-conduit universe. The patent shown flexible drainage line is a very high pressure molded, herein, one of depicted Sets, of sufficient rigidity, form and size that connects to shown pipe, and itself is replaced by a separate branch inlet.

FIG. 19 of the drawings is a cross-sectional side elevation view generally taken about a PAP symmetry plane of a Globose Industrial Centric Cylindrical Set, Form 10′, hybrid of an upright globose cylindrical form, intended for industrial drain lines that may discharge at high hydrostatic pressures. Said form contains significantly larger retention, detention volume within said universe domains of forms. Inline upright forms are easily rotated into angled hybrid Industrial forms with outlet ascending spouts outlet three Sub-outlets, which extends an “S” PPLD FESD form to a First Sub-outlet, 85, summit, 84. A holding Chamber, 12a, retention free surface elevation higher than summit makes a fluid free surface one length form that complies to said basin greater breadth than a permanent upper retention height. A Second Sub-outlet spout ascends curving into a DCSS FESD form rounded area, 86. A Third Sub-outlet spout largest of three spouts ascends to about an Inlet End 1 elevation and a DCSS FESD form area, 87. Sub-outlets, as one curvilinear major-axis upright DCSS, forms are planned. Highest location one-way nozzle air inflow into said Chamber constitutes a basin-outlet, holding Chamber FESD space manager that is planned. Plug, Flush Apparatus assembly such as one shown in FIG. 13 permits shown Chamber to extend lower than a basin lowest surface. Shown cylindrical, said Chamber circumferential donut figure about a basin-outlet Inlet form is planned. A donut holding Chamber globose form with an Exhaust form on an opposite side from said DCSS FESD forms is planned and constitutes circumferential globose Inline hybrid form. A holding Chamber fluid mass free surface during high discharges that about matches one in basin-outlet moderates basin-outlet fluctuations caused by hydrostatic pressure high fluctuation in an Inlet, 13, inflows from a container of said fluid mass mixtures. With said air inflow volume, inside said Chamber, of retained fluid mass and its discharge quantity is function of shown Exhaust, 384, area and free surface elevation wherein large retained fluid mass and its discharge are countering basin-outlet, Inlet fluid free surface hydrostatic pressure variations. An outlet DCSS form constituted of two Sub-outlets form is planned. Shown Inlet connected directly to a fluid mass container through a universal water tight joint can allow for PAP, 71, angle alignment based on fluid mass and energy composition, quality, and quantity and thus highest mass and energy conservation, PP lengths least sum, based on least upright components. As shown FIG. 19 clockwise rotation reduces shown PAP angle of 175 degrees. In operation higher specific gravity solids are passed through said First Sub-outlet with large quantities of transport medium passed through Second, Third Sub-outlet wherein in process transport medium mass potential energy is again utilized to pass solid particles through said holding Chamber and a vented pipe to which it connects. Globose-conduit industrial Sets three tier FESD DCSS form respective Inlet, basin-outlet three free surface height elevations coordinated by three Sub-outlets respective elevations and areas constitute said DCSS, summit, said First, Second, Third, and holding Chamber invert, springing points and crown constituted coordinated cross-section area forms. For highest conserving of mass and energy mechanics of forms PP lengths least sum compute globose-conduit universe forms relationships of forms and Sub-outlets that are planned.

A double wall Inlet inner space, 118, with a downwardly pitched, 119, tubing through said basin-outlet form constitutes an immediate leak notice and a warning of a partial wall failure

Hybrid Industrial Sets exist and are planned for each domain Set with an FESD outlet ascending spout said FESD DCSS multiple Sub-outlet forms or Sub-outlets one composite form as Inline Set Figures show, with a descending spout that can constitute a holding Chamber, including circumferential donut shaped Chamber, forgoing describes. For Industrial, Inline hybrids a sidelong Partitioned Inlet, basin-outlet with an ascending spout said FESD DCSS Industrial forms constitutes a sidelong descending spout, which can constitute a circumferential donut shaped holding Chamber about entire Set.

Wherefore, depicted Figures disclosed universe of nonhomogeneous, nonuniform, nonsteady highest conserving fluid mass Sets that contain, retain, detain and transport and which constitute said globose-conduit universe of classic forms, classic perimeter forms.

Wherefore, nonhomogeneous, nonuniform, nonsteady highest conservation fluid mass retention, detention, and transport said PP lengths least sum globose-conduit forms universe is Figures exemplified where PAP angle graphically illustrates PP lengths least sum. A translational transport constitutes said classic forms frictionless perimeter forms.

Mass blocks translational transports with no perimeter friction constitute absolute highest energy conserving for solid mass and are equivalent to frictionless boundary layer fluid mass transports with no internal fluid viscosity frictional losses, for a laminar fluid mass transport called for in the first application. By accepting frictional boundary layer energy losses said PP lengths least sum algorithm computes fluid form and perimeter for least energy loss due to gravitational effects on nonhomogeneous fluid mass and for a statistical probability of fluid mass anticipated variability with varied cross-section forms, specifically breadths. Infinite number of globose conduit forms represented by only one highest conserving fluid mass energy amount form constitutes said PP lengths least sum. Again, one arrives at said classic forms for nonuniform quality, nonhomogeneous fluid mass and nonsteady hydrostatic pressures that vary with fluid free surface elevation that is different from round conduits construction. Existing sewer lines crucial part of open channel energy conservation is just one of infinite number of globose-conduit perimeter forms that said PP length least sum identifies for a specific location specific statistical data for specific events. Forgoing again arrives at highest fluid free surface and invert elevations for globose conduit forms least height of varying numerous breadths and or breach, for fluid mass least height forms highest conservation of mass and energy.

Globose conduit forms by said generic claims evolve devolve into or out of class round forms, transpose into or out of classic conduit or classic globose spherical retention forms, transfer among Sets of globose, globose-inverse, hybrids, and mutations domains that constitute mass and energy highest conservation universe of unique origin.

FESD forms and their perimeter forms restrict fluid mass rotations. Partitions, and Widows, Ridges, and Troughs FESD forms are especially suited for sewer construction.

1. Globose-conduit universe conduit spouts conforming embodiments and drainage line forms complete complement of completely matched Sets retain compact composite fluid mass forms that conserve energy and fluid mass; a Set consists of an inflow Inlet rotated from angled to near upright and a globose conduit spout basin-outlet; a quanta mass form of a least height and highest elevations constitutes quantum mass algorithm computed paths-of-passage, PP, lengths least sum complete complement; a submerged undersurface of an Inlet lower end, an End 2, an outlet ascending spout lower end, a First End, makes a globose, a globose-inverse Set, respectively; a one fluid mass, one length one free-surface upper, globose forms composite conforming, retention least quanta mass above said End 2 or First End undersurface submerges a transition region from a lower conduit to an upper globose form; forms of FESD, especially outlet and Sub-outlet cross-sections lower smaller areas short heights narrow breadths, PPLD band narrowest widths, open channel quanta mass surface breach and breadth large areas complete complement of forms avoids retained fluid suction with PAP angles less than 180 degrees; a globose-conduit pout lower small conduit, transition region, and upper large globose areas cross-sections retain smaller quanta mass than an ubiquitous art form; a continual quanta mass transport, especially heavy fluids that has first priority right-of-way along with a raised mass centroid through four different cross-sections manipulated areas, is entirely through cross-sections of a lowest small conduit area narrow breadth narrowest PPLD width of band short slopes, height, and length; retention conforming mass cross-sections area complete complement, least height composites make varied highest elevations breadths; a migrations of an End 2 or a First End from a basin-outlet sidelong to an anti-sidelong location makes up domain Sets; globose and circumferential strain forms mutations make hybrid Sets; drainage line manipulated cross-sections areas complete complement varied breadths constitute a lower small conduit, a transition region, and an upper globose areas compact composite; thus, a fluid smaller mass repeatedly, indefinitely replaced, lifted, and moved through a shorter height and distances conserves infinite mass and energy amount; Flush Apparatus assemblies adeptly pre-assembled retain permanent retention or flush, sterilize, or coat surfaces of parts, forms, or a Set;
globose-conduit units of mass, quantum, are contained continually transported, retained, contained mass of transported, contained, retained, detained, phases of mass energy varying phase's amounts inside globose-conduits open channel vented forms;
a containment boundary controlled, contained, retained, detained, transported air, gas, and a nonhomogeneous, nonuniform, nonsteady fluids mass-energy conforming least mass, a PPLD least widths of band forms, a fluid mass globose-conduit perimeters, and a contained fluids least heights having a modes of energy phases highest sum;
mass-energy phase modes sum with internal, especially boundary perimeter least rotations constitute globose-conduit universe, domains, classic forms Sets, or genomes;
generic PAP, PPLD, PP lengths least sum, conforming embodiments, evolve or devolve globose-conduit forms into round or entirely round conduit cross-sections and or globose spherical or spherical retained mass forms that rotate, mutate, transpose, transfer, highest conserving mass energy phases sum as unique origin universe, Sets, and domains;
a globose form confines, retains, transports; a lower conduit confines, transports; and a detention least transports, confines as mass energy phases mechanics of forms;
core or mechanics of forms, FESD forms, Flush Apparatus inventions, principles, methodologies highest quantum mass-energy quintessential, core, natural disposition are globose-conduit classic perimeter forms, Sets, and domains with the following summary:
microbes' submicroscopic, atomic subatomic to cosmos makeup as described;
craft's ordinary scale implemented inventions, principles, and methodologies:
a; inflows nonhomogeneous, nonsteady, nonuniform mass-energy stratifies with:
5. a globose-conduit detention, upper retention least transport-fluid height;
6. heaviest fluid topside, inside narrowest PPLD widths, conduit breadths, gravity separated nonsteady, nonuniform mass energy into following;
b; detention one length, globose largest free-surface form steadies nonuniform, nonsteady mass energy with uniform atmospheric, detention pressures to a DCCS;
c; narrow PPLD widths, forms' breadths confine heaviest fluid mass with:
7. heaviest fluid mass modes of energy at highest elevations;
8. confined heaviest fluid mass centroid raised by narrow breadths;
9. mass-energy rotations, modes of energy losses minimized;
d; mass-energy entirely inflows into a globose-conduit conduit contained mass;
e; mass-energy mass inflows are topside PPLD forms surface into heavy fluid:
11. separating, tearing, breaking, releasing heaviest fluid particles;
12. heaviest particles that are narrow PPLD widths confined:
g. with natural fluid mass quintessential, core, disposition forms;
h. displaced contained mass, by or with FESD surface forms;
i. heavy fluid mass least perimeter least adhesion friction losses:
7. least cross-sectional area;
8. least friction coefficient
9. inflows mass-energy centroids is below a heavier mass centroids computed for;
e. mass-energy, perimeter friction, and adhesion least losses;
f. centroids alignment rotations that tend to lift heavier mass;
4; Flush Apparatus are adeptly fitted into globose-conduit forms;
l. most of steady inflow outflow fluid mass is through a conduit form:
i. PPLD PP of a DCSS First Sub-outlet have highest mass velocity;
j. inflows are entirely through a conduit Inlet;
k. a DCSS FESD form First Sub-outlet discharges continual outflow;
l. rare, unusual events fluid passes through a DCSS globose form;
m. most of energy modes losses occur with a lower one-half of lowest conduit:
11. manipulations of cross-sectional areas forms minimize mass rotations;
12. upper retention mainly a transport fluid has least or no friction losses;
13. most friction losses a lower conduit surface, conduit springing points confined from under an Inlet extended to an outlet DCSS, an Exhaust;
14. a PPLD form is at highest elevations in respect to its Inlet End 1; an End 1 higher than a globose-conduit is a safety factor, convenience;
15. shrunken PPLD is least height and length conforming:
g. PAP least angle, with best alignment and symmetry;
h. least contained mass, least perimeter losses, PP lengths least sum;
i. PP lengths least sum inventions, principles, methods, FESD forms:
9. with algorithm computing up to smallest elements;
10. entire quanta subdivided mass computed PP lengths;
11. with graphical prototypes scaled measurements;
12. with laboratory testing confirmations;
n. mechanics of forms mass-energy absolute highest conserving globose-conduit perimeter forms, conforming rotation least fluid mass classic genome Sets:
11. globose, spherical form conforming mass retained mass-energy;
12. retained mass-energy least surface perimeter globose, spherical form;
13. least surface perimeter friction, adhesion mass-energy losses;
14. heavier mass least retained mass-energy rounded conduit form:
k. with statistical analysis of heavy fluid mass-energy inflows, rate;
l. with conformance to PPLD width of band and length forms;
m. retained mass-energy least surface perimeter conduit form;
n. least surface perimeter friction, adhesion mass-energy losses;
o. amalgamated with upper retention mainly a low friction fluid;
15. least PAP angle, PP lengths, sum of, PPLD height and length forms;
i; universe of Globose-conduit mechanics originated from unique genome form:
3. retention genome graphical intellectual, inclusion, exclusion shown:
e. illustrates retention unique genome of globose-conduit forms;
f. unique genome form originates universe domains;
2. globose-conduits evolve devolve conforming-conduit forms contained least mass into out of globose, spherical contained mass retention least surface form;
as conforming contained least mass-energy by conduit forms from globose, spherical retained mass least surface forms;
13. amalgamated globose-conduit forms rotate, mutate, transpose, transfer to contain, retain, detain and transport highest conserving mass-energy modes made up of mass-energy contain, detained, transferred phases;
14. globose conduit forms manipulated cross-sections areas manipulate, raise a smaller heavy fluid mass centroid ahead of larger transport fluid mass, or vice versa detain transport fluid by pant-up hydrostatic pressures heavier fluid mass confined discharge four times:
g. under an End 2 undersurface a least height separated from a PPLD lowest surface form at highest elevations;
h. with gradual devolution from a globose to a rounded or called for by statistical analysis of fluid mass composition, rate to a curvilinear globose-conduit conduit perimeter transition form;
i. with a DCSS form First Sub-outlet conduit form with a higher energy, smaller heavy mass pushed ahead of a much larger globose detention transport fluid mass; industrial forms DCSS areas manipulation with transport fluid discharge through Second Sub-outlet and or globose breadths upper DCSS forms;
15. globose-conduits are classic perimeters alongside globose, spherical, with parallelism to homogeneous round conductors as described;
c. a globose-conduit's globose area height vary, from about 5% to about 95% of entire cross-section height, globose breadth manipulated up to orders of magnitude greater than a vented pipe to which it connects (the first application shown up to three times greater);
inventions, principles, methodologies quintessential highest self-preserving, self-conserving, core, natural mass energy modes dispositions is globose-conduit universally manipulated forms, Sets, and domains that constitute unique origin universe is as follows:
quantum mass conforming PAP, PP, and PPLD energy demand self-preserving, self-compliance to mass energy, omnipotent force fields makes Sets' conforming forms; controlled vented gas, air, and fluid mass inflow outflow into out of open channel forms;
globose-conduit classic cross-section areas, perimeters, surface interface forces at boundaries, and mass centroids respective locations are computed for least or no rotations about fluid mass constitutes said “flow control” mass and energy highest conservation;
basin-outlets least Set includes Inlet forms inside, a conforming retention mass, a globose form transported detention, and said Inlet fluid mass outside of said basin-outlet; a conforming and a detained fluid mass make up retention mass; the former precludes venting or backups, the latter moves mass; fluids free surface essential elevations pass largest size submerged particle through a First Sub-outlet and DCSS forms;
inlet inflows provide paths-of-passage, PP, mass potential, kinetic energy modes sum; an Inlet End 2 separation from a PPLD form barely exceeds largest particle sizes; for drain traps, a globose End 2, a globose-inverse First End undersurface lowest point elevation is globose conduit springing points' elevation;
transition region cross-section areas are from conduit to globose springing points; cross-sections fluid structure interface perimeter are two symmetrical smooth curvilinear lines which connect lower conduit upper globose cross-section perimeter springing points ranging from a rounded cross-section to a globose area having springing points breadths a multi order magnitude wider than those of its counterpart conduit form springing points;
FESD forms within transition region make up permanent retention conduit forms, wherein permanent retention is a mass-volume that precludes venting of gas or backups;
transition region fluid mass least rotations computed viscosity least friction, least breadth or height cross-section area forms having highest conserving modes of energy are listed FESD forms that seamlessly convert classic globose retention into conduit forms;
generic claims' PPLD forms constitute a part or a counterpart to FESD forms;
globose-conduit conduit springing points constitutes an elevation no higher then conduit entire height; rounded conduit forms may make a Trough, a Trough inside a Trough, or Troughs inside Troughs curvilinear forms, a Ridge, a Partition FESD lowest surface forms with sides slopes constituted transition region forms complete complement;
especially Trough(s), Ridge(s) including upright, Partition(s), or indented Ridges as turning veins Troughs, along with End 2, First End basin lower surfaces, side surfaces includes Dimensions 44 spaced counterparts among listed FESD forms, for PAP upright plane symmetric fluid mass radial outflow, inflow into a basin-outlet; ordinary trades or crafts fabrication scale to arts sciences microscopic near infinitesimal units of mass FESD forms complete engagement of globose-conduit retained, detained fluid mass constitutes a range of FESD forms complete complement; globose-conduit forms constitute open channel conduit forms that contain, retain, detain and transport fluid mass energy with highest conservation of both, including rare events such as high hydrostatic pressures;
for a PPLD form slope rise, in tandem, increases its area form side surface slopes into narrower breadths that with cross-sections height narrows transition region breadths, giving upper retention, globose form breadths curvilinear or elliptical upright major axis forms; forgoing algorithm computing methodology carries out to a highest computational accuracy cross-sectional areas and perimeter fluid mass forms for least or no entire fluid mass rotations in PAP upright plane toward highest conserving of mass energy modes; a PAP upright plane horizontal orientation in space constitute absolute symmetry of forms up to DCSS springing points elevations having least or no detrimental retained, detained, transported fluid mass rotations constitutes in PAP upright plane symmetry said “flow control means” laminar fluid mass;
spherical, globose highest energy modes genome classic forms retain mass units constituting computed least resistance paths, said paths-of-passage, PP, lengths least sum that here applies to retained, detained, and transported nonsteady, nonhomogeneous, and nonuniform mass; conduit forms must exist for transfer of energy modes;
generic claims PAP, PPLD, PP with PP lengths least sum, defines confined mass modes of energy transfer self-conservation with units of mass PP of least resistance make up of basin-outlet classic globose-conduit forms conformed embodiments, Sets;
said PP lengths least sum computes open channel fluid said centroid locations and least height classic forms for retained and transported fluid mass with least or no rotation forms, for ordinary design use, with infinitesimal elements designs for scientific purposes; crafts finest tolerances constitute said finest units, least mass, lowest surfaces, slopes, shortest or least height, length, and said stated required construction;
by definitions, inverts of globose-conduit forms, PPLD width of band horizontal segments, constitute highest elevations; a horizontal chord, breadths at respective elevations, by PP lengths least sum computing is a least transfer of kinetic to potential mode of energy, highest conservation for fluid mass and energy;
cross-section areas, perimeter computed forms effects least fluid mass rotations in a PAP plane of symmetry; in chords, breadths, horizontal planes units of mass are confined by surrounding units of mass eventually confined by cross-sectional area form perimeter form which implements least or no rotations in PAP upright plane symmetry, least or no rotations in horizontal planes; said changes require at least a change in retention free surface elevations and that require areas, perimeter change; upper globose and transition region cross-sections computed similarly makes complete complement of forms that constitute cross-sections classic areas and perimeter fluid mass FESD forms;
a PPLD constitutes globose-conduit unit of mass lowest path of least resistance for said globose form least retention mass, height conduit form highest elevation highest conservation of fluid mass energy conversion from kinetic to potential mode; confined by narrowing of a globose, conduit ascending spout, heaviest particles are squeezed into a PPLD narrowest width highest slope single largest sphere that just passes through spout rounded lowest surface area cross-section that is said PP lengths least sum FESD form; surrounded by highest specific gravity transport fluid mass of highest viscosity largest sphere is pushed in back pulled by transport fluid drag while allowed to rotate in PPLD direction toward summit without rotations of entire fluid mass; sub-outlets, First Sub-outlets, detention fluid free surfaces essential elevation height is said largest sphere passing through Sets submerged height, elevation at summit;
an End 2 undersurface is located at about one half of upper retention depth that with a free fall locates inflows mass centroid into a lowest ¼ of a basin retention depth; high specific gravity inflows, outflows fluid mass is entirely through lower conduit form of globose-conduit cross-sections; globose-inverse First End located about one half of basin retention depth is entirely consistent with said heavier mass inflows, outflows;
ordinary fluid mass retention outflows are mostly through a lower small conduit cross-sectional area of a globose-conduit composite, ahead of a larger detention mass; unusual, out of ordinary fluid mass outflows pass through globose cross-sectional forms;
heaviest mass centroid short height to a summit is most mass energy conserving; a globose-conduit shallowest retention also has heaviest fluid mass most raised centroid;
globose-conduit least conforming retention mass of least height of least rotations is least magnitude potential, kinetic exchanges of energy modes; kinetic potential energy mode exchange has rotational friction and viscosity losses; globose-conduit Sets forms complete complement amalgamated, least mass, least conforming retention, least rotations multi raise retained mass centroids, PPLD forms to highest elevations for modes mass energy highest conservation; less energy transferred conserves mass, energy either one or both; least rotations of least mass centroid at highest elevation a least height from fluid free surface set at highest elevations have Set-forms highest conserving mass modes of energy; narrowest conduit breadths move heaviest fluid mass higher into entire cross-sections form, raising its mass, area, perimeter centroids to highest elevations matched by globose breaths, PPLD forms, mass highest elevations, energy modes highest conserving;
least fluid mass least rotations constitute least rotational frictional, viscosity loss higher potential, kinetic energy exchanges magnitude, mass energy highest conservation; globose-conduit conforming detention least height globose largest breadths, lengths raise entire mass centroid elevation eight times; once for each of four horizontal direction that is in unison with the other three, repeated again four times for conforming globose mass retention at rest, with fluid free surface elevations as the governing reference for kinetic, potential modes exchanges least energy demand with PPLD forms at highest elevations; as a system amalgamated globose-conduits raise fluid mass centroids three times; once for each globose conduit forms raised mass centroids, once for highest PPLD elevations;
globose-conduit sewer lines detention, basin-outlet least mass conforming retention fluid mass centroids rotations are least distance from fluid free surface, which makes for highest conserving mass energy modes balanced exchanges, as follows: Energy balanced modes for least mass least rotations conserves mass energy;
a detained larger mass at insignificant or no energy loss is conserving mass energy; globose forms detain transport fluid mass that counterpart conduit uses to transport mass;
pent up hydrostatic pressures cause discharge of nonhomogeneous heaviest mass, particles; pent up hydrostatic pressures are to fluid free surface essential elevations, only;
a globose-conduit conduit outlet, First Sub-outlet, DCSS narrowed breadths with much larger globose breadths adeptly manipulate PP pent up hydrostatic pressures;
detention large breadths, lengths mitigate nonsteady mass flows to a least change from highest conserving mass energy fluid free surface elevations, hydrostatic pressures;
herewith listed, also referred to, FESD specific forms are part of FESD globose-conduit forms whose specific purpose is prevention or restriction of fluid mass rotations; for highest conservation of energy, exact transfer of kinetic to potential energy requires energy path-of-passage-of-least-demand, PPLD, for a unit of mass that passes a summit; mass must preclude venting or backups found by nearly universal or ubiquitous empirical use; least mass contained by most compact, least volume spherical modified to a globose form units of mass constituted PP lengths least height forms make said least mass forms;
nonhomogeneous, nonsteady nonuniform least mass highest conserving energy modes fluid mass least rotations globose-conduit complete complement PP lengths least sum retention genome round, rounded, curvilinear forms has following transpositions:
round or rounded areas transposed to a conduit, an intermediate, and a globose form area higher centroids of retained fluid mass potential and kinetic modes of energy;
transposed round, rounded conduit cross-sections, fluid mass essential height as for a First Sub-outlet, constitutes fluid mass least rotations curvilinear least height form;
least rotations curvilinear fluid mass forms raise centroids of following:
fluid mass perimeter, FESD structure interface curvilinear surface, thus;
viscosity, cohesion, adhesion, and solids surfaces friction centroid;
boundary layer perimeter laminar respective forces centroid location, as
transposed centroids, forces constitute one common centroid force with least rotations, for fluid mass varied compositions respective least height forms;
breadths, breach least height FESD make for fluid mass forms least rotations;
contained, retained, detained transported fluid mass-energy phases forms least PPLD width of band, lower conduit perimeter, and quintessential, core, self-conservation, self-preservation for a quanta mass form least height, a mass centroid highest elevations; a classic globose upper retention and lower conduit form constitute elevations of fluid free surfaces that is for a transfer of energy mode near or at highest elevations; said PP lengths least sum of finite to infinitesimal retained fluid mass inherently constitutes self-conserved preserved energy highest conservation paths of least resistance, which make open channel transition region of globose-conduit fluid mass forms; globose-conduit transition region computing of forms forgoing figures, wherein globose-conduit conduit basin-outlet, Inlet fluid mass forms, may constitute an Inlet contained fluid mass outside a basin-outlet, especially fluid mass and Inlet forms that precludes suction or venting; transition region forms conserve fluid mass energy with computed highest elevations of PPLD and fluid free surfaces least height difference constantly continually that with a conduit form fluid mass constitutes an essential height; rounded lowest surface forms constitute highest elevation for a statistical continual inflow rate that constitutes fluid mass detention wherein said inflows of a nonhomogeneous, nonsteady, nonuniform fluid is accounted for by lowest surfaces PPLD forms; for statistical standard deviations higher inflow rates rounded forms open into PP lengths least sum computed wide form of low slope sides surfaces or parabolic horizontal major axis forms; highest elevations PPLD forms govern unless cross-sections breadth or breach computed PP lengths least sum mandates a PPLD lower form;
shrunk PPLD forms rounded, elliptical upright major axis, or curvilinear globose-conduit forms makeup, transition region forms, PAP angles less than 180 degrees, and PP lengths least sum forms complete complement constitute claimed universe fundamentals:
PAP two points, as “surveyor stakes” that space align fluid mass energy forms with conduit, globose springing points constituted lower, upper transition region limits;
“self-designed” conforming PP lengths with least sum, least fluid mass energy, resistance paths constituted fluid mass perimeter surfaces that are globose-conduit forms,
said PP paths, as “self-designed” units of fluid mass paths that use least energy;
said PPLD forms, as “self-designed primary paths” most efficient energy forms,
said classic retention genome, as contained retained energy genomes “parent”;
mass units' paths of gravity force least resistance is said PP mass energy modes quintessential highest conserving, self-preservation with natural disposition visible forms;
most self-conserved preserved fluid mass energy self-generates least magnitude of energy modes full transfer most shrunk PPLD form, globose-conduit compact forms;
said “parent” near spherical classic conforming retention amalgamates, its outlet conduit to make up highest conserving fluid mass energy globose-conduit Sets;
said infinitesimal units of mass PAP symmetric orderly outflows, inflows into, out of classic retention genome form, as “old”, “new” units of fluid mass and energy;
said fluid mass energy units, as “participants” in “parent” mass energy universe;
said laminar flows mass units, as a “confined unit” for fluid mass energy forms;
mass units PP lengths least sum makes least PAP angle unique Set symmetrical forms through a discharge-cross-section-surface, DCSS, and springing points elevations;
globose-conduit forms are within “genus” conforming “citizens”, Sets, by PP lengths least sum fluid mass energy highest conserving forms that constitute its universe;
lower globose basin globose forms amalgamate into a rounded or a curvilinear globose-conduit, First End, outlet, Sub-outlets, FESD, and DCSS FESD respective forms;
paths-of-passage compute PP lengths least sum, globose-conduit, PPLD, FESD retention conforming least fluid mass least rotations PAP upright plane symmetric forms;
classic genomes Set of forms conforming retention least mass least height is mass modes of energy highest conservation thus PP lengths (least resistance) least sum;
quantum units of mass PP least sum amalgamates mass units' paths into least height shallowest retained mass genome forms mass energy modes highest conservation;
genome Sets make for retained fluids least height, least mass potential, kinetic energy modes quantum mass units least sum amalgamate into fluid mass and forms Sets;
said PP lengths least sum for a form constitutes a conforming or a genome form; genome forms complete complement conforming embodiments are genome Sets;
embodiment forms PP lengths least sum causes nonhomogeneous fluid mass conforming permanent retention kinetic potential energy modes passing heaviest particle;
heaviest particles, highest specific gravity mass PPLD least height, conforming least retention mass, height, and energy modes inflows transport PP mass; a quantum, an omnipotent mass, energy physical forces compute to a conforming embodiment forms;
PPLD units of mass paths to summit topside PPLD width of band surface forms make for least rise slopes for said mass units PP lengths least sum narrowest breadths;
outlet FESD and DCSS forms PP lengths large breadth upper area cross-sections higher than globose forms springing points elevation limit fluid free surface rises to hold least height, least fluid mass kinetic energy transfer to potential energy mode;
a greatest particle height constitutes a free-fluid surface detention essential elevation PP lengths least sums lowest elevation and First Sub-outlet forms least height:
essential detention free-surface elevations require no kinetic to potential energy energy-demand transfer required for continual mass and energy highest conservation;
open channel globose-conduit forms nonhomogeneous fluid solids mixtures mass energy self-preservation containment, detainment, and transport is within one form;
globose-conduit forms contain Inlet retention and forms, that altogether inside a basin-outlet constitutes a globose-conduit least mass-energy least Set of forms;
quantum-mass PP complete complement computes Sets' least resistance forms;
generic globose-conduit claims: PAP, path-angle-of-passage; PPLD, path-of-passage-of-least-energy-demand; PP, paths-of-passage with a least sum constitute fluid mass globose-conduit conforming embodiments self generated Sets; globose universe conforming embodiments, Sets genus, is generic claim classic Sets conservation of mass and energy of fluids and solids mixtures that originate from said classic unique retention form genome; PP, paths-of-passage, lengths generic claim to algorithm computed least sum is energy balance for entire retention mass quantum mass upright components with gravity acceleration multiple, which through reiterative process arrives at fluid mass and structure forms interface ultimate Sets, genomes; forgoing specified at least two points aligns Sets to a linear PAP least angle alignment and symmetry of forms; sciences art fields nuclei or subatomic, microscopic or submicroscopic complete complement forms is quintessential of globose-conduit potential, kinetic near infinitesimal quantum mass energy modes transfers perfection that is beyond human skill to create or duplicate;
microbes microscopic, submicroscopic thin disk or short rod line like, single form cells contain, retain, transport, or detain submicroscopic ecosystem inflow, outflow mass constitute an Inlet, a basin-outlet forms of globose-conduits basic types least Sets make;
a body of the Milky Way Galaxy pulled into the Solar System with its gravity-controlled space makes an Inlet form, and when it exits, the Solar System an outlet form;
globose-conduit forms mass energy modes phases highest conservation makes globose-conduit forms universe from a microbes' submicroscopic, atomic subatomic to cosmos makeup wherein the Milky Way Galaxy is a miniscule part;
clearly celestial bodies travel paths of least resistance paths-of-passage, PP, that is highest mass energy conservation from cosmos to Milky Way Galaxy, to Solar System, to Earth with each body path length accounting for mass energy losses within the cosmos mass energy equilibrium;
centroids least separation of heaviest mass, detention transport fluid mass needs less transport fluid mass and its energy; two, three dimensional FESD forms of globose conduits much wider breadths larger area compared to entirely round or otherwise similar conduit forms hold transport fluid mass with least or shallowest detention, retention mass height that is set at highest elevations for respective Set fluid mass inflows, outflows; for continually raised heavier fluids centroids toward a DCSS with entire fluid mass least or no rotations in PAP upright plane makes for highest mass and energy, especially transport fluid mass variable inflows with specific gravity variations mass, energy conservation;
globose-conduit systemic highest self-conserving energy modes retains, detains, and transports manipulated mass energy mass, area, and perimeter centroids as follows:
globose-conduits PP make paths of least resistance cross-section areas breadths for fluid free surface least elevations difference from PPLD forms at highest elevations; Sets contain retain detain, and transport nonuniform, nonhomogeneous, nonsteady classic area, perimeter least mass, height, fluid mass for least or no detrimental rotations;
globose-conduit quintessential fundamental, evolutionary, natural, highest self-conserving self-preserving superiorities self-generated mass energy forms is as follows:
1; globose-conduit mass inflows preferentially distribute transport energy modes into heaviest fluid mass PP, PPLD forms at highest elevations with respect to its summit;
2; globose-conduit forms push highest specific gravity mass ahead of a transport fluid mass at three locations: a) under an End 2, b) prior to a summit, c) after a summit;
a; under globose End 2 least conduit height, with a lowest PPLD form at highest elevation, with separations that need not exceed much inflows mass largest particle size;
b; with narrow breadths conduit transported heaviest mass risen centroid pushed in front, ahead of detention mass ahead of a First Sub-outlet by least fluid mass rotations;
c; passed summit with transport fluid greater drop into pushed ahead heavier fluid mass similar to fluid mass Inlet inflows, accentuated by Industrial Sets heavy, transported fluid mass passed through a lower First, a higher Second Sub-outlet forms, respectively;
5; a globose detention in tandem rise behind a risen transported mass centroid;
4; transported, transport fluid tandem raised, lowered respective mass centroids;
5; a much small transported mass in front of significantly larger detention mass;
6; compact retention, detention highest mass centroids in respect to its summit;
7; highest mass centroids a least distance, rotations from a respective summit, constitute a viscosity, boundary layer friction least fluid mass modes of energy losses;
10. a narrow conduit breadth at summit raises up globose detention pressure;
9; a globose-conduit, one-form, least energy modes demand raised detention pressure, heaviest mass centroid retains or detains, transfers mass energy highest modes;
kinetic, potential is useful energy mode; least mass rotation is conserving both;
conserving of both is because energy modes are least energy demand transfers;
quantum mass energy modes are exchanges for inflows mass energy same sum;
12. a globose detention mass pant up pressures separate, dilute, or dissolve a transported mass in its path with raised centroid, least apart from transport mass centroid;
11; open channel forms adeptly manipulate energy-modes gravity force caused;
12; globose-conduit nonhomogeneous nonuniform nonsteady modes of energy mass, cross-section areas, perimeter centroids align for highest mass energy conserving;
13; generic PAP, PPLD, PP lengths sum, conforming embodiments, evolve or devolve globose-conduit forms into round or entirely round conduit cross-sections and or globose spherical or spherical retained mass forms that rotate, mutate, transpose, transfer, make unique origin universe highest conserving mass energy phases, Sets, and domains;
14; globose open channel basin-outlet spouts manipulate, adeptly amalgamate mass energy modes one-directional linear or circumferential globose or circumferential cross-section areas of retention, detention that otherwise requires three-elbows assembly; globose, circumferential are highest self-preserving mass energy two strains of forms; a one-directional less than 180 degrees alignment is one within cosmos' gravity fields;
15; self-conserved energy process among naturally evolved or man made forms constitute classic chains with globose-conduits as natural, quintessential dominant links;
16; fluid mass forms of energy, composition, and physical properties highest self-conservation globose-conduit forms evolve into classical round forms and vice versa;
17; classic globose-conduit detention PP lengths least sum, height mass energy absolutely dilutes, tears up, disintegrates, moves or transports high specific gravity mass; this conserves useful energy modes mass energy for a transport of such heaviest mass; air as a fluid mass is controlled into out of open channel forms as an enclosed boundary;
18; basin-outlets least Set includes Inlet forms inside, a conforming retention, a globose-conduit transported detention, and an Inlet fluid mass outside of its basin-outlet;
a; conserving mass energy is inside mass energy modes enclosing boundaries; mass energy modes stated inventions, principles, and methodologies requires respective boundary of physical, nuclear molecular, living cells chemical mass energy modes forms;
b; contained modes mass energy forms require at least one enclosing boundary;
c; globose-conduit open channel forms transport of fluids and solid particles of nonhomogeneous mass energy is comparable to round pipes, electrical wires transport of homogeneous mass, energy, and atomic subatomic round forms retained mass, energy;
d; paths-of-passage lengths least sum amalgamates nonhomogeneous, nonsteady, nonuniform, mass-energy units viscosity, adhesion, cohesion and fluid structure interface perimeter boundary layer adhesion, friction into highest mass energy conserving forms;
e; classic globose-conduit genome forms constitute classic perimeter form Sets;
globose-conduit principles, methodologies are homogeneous mass applicable;
partial suctions of globose-conduit smaller than ubiquitous permanent retention is safest quickest recovery of upper retention of highly conserved fluid mass and energy;
f; a rise in globose-conduit, basin-outlet PPLD band in tandem with narrower lower conduit cross-sections breadths is completely complimented by transitions regions least height wide globose breadths forms having essential height or greater elevations;
g; mechanics of forms contain modes energy highest sum at highest elevations;
h; a retained fluid mass defines a lower retention, an upper retention and a detention form; an upper retention at rest makes a free surface; a detention makes a free surface that is higher than said free surface at rest;
i; globose-conduit said fluid mass energy PP lengths least sum are one of forms for highest statistical-probability of nonhomogeneous, nonsteady, and nonuniform retention, detention least PAP angle, quanta mass least rotations; FESD forms are PP lengths least sum classic perimeter forms that contain, retain, detain, and transport fluid mass energy of globose-conduits, which themselves constitute FESD forms;
domains of globose-conduit universe FESD forms with said PP lengths least sum surfaces restrict rotations of mass in three orthogonal planes, especially prominent among named makeup Troughs, Ridges, Partitions, globose End 2 and globose-inverse First End forms and undersurfaces, doming Cavities, Bridging-Wall, Fin and DCSS FESD forms; Troughs raise globose forms sides lowest surfaces wherein Ridge, Partition FESD forms raised PPLD lowest surfaces into two PPLD higher elevation forms; Troughs, Ridges and Partitions are globose conduit forms integral parts concepts that raise heaviest fluid mass centroid twice; once, as a part of globose-conduit forms highest elevation lowest surface raised with a presence of such forms to constitute least fluid mass height form that makes narrower breadth two cross-sectional areas, to thus again raise nonhomogeneous heavier mass centroid; a narrower PPLD form initiates earlier lowest surfaces rise with narrower breadths constituting faster rise of lowest, lower surfaces;
figures of globose upright, angled to about upright, angled, industrial, low angled, Inline, inverse and hybrid forms claim globose-conduit universe of Sets, forms, hybrids, migrations, mutations, entire G-C universe domains, genomes, along with classic forms classic perimeter Sets inventions, methodology, and principles, and concepts disclosed; Trough, Ridge, Trough-Ridge, Partition, or Trough-Ridge-Partition FESD removes and or manipulates excessive mass-energy PP bundles;
by imposing ecosystem universally most friendly boundary requirements, entirely releases, removes artificial, unnatural boundary conditions quantum mass PP quanta mass constitute entire universe, cosmos contained, retained, detained or transported phases;
globose-conduit classic forms contain detain and transport nonhomogeneous fluid comparable to subatomic, atomic; microscopic, submicroscopic; high pressure water pipe or electric wire classic forms, perimeters contained, detained, and delivered mass energy;
a linear or a circumferential PAP of equal boundary conditions, PP lengths least sum, with equal quantum mass equal energy have an equal core, quintessential, perimeter form and vice versa, least or equal, not exact; globose-conduit, globose-circumferential universe domains of Sets, PAP angle paths constitute a finite linear increment in upright plane with counterpart orthogonal upright plane containing a quintessential core image of highest preserving mass energy natural disposition perimeter approximations derived; a PPLD form defines a conduit perimeter for containment of mass energy modes or mass energy perimeter dissipates into ecosystem natural disposition boundary perimeter forms;
as with other modes of energy, globose-conduit perimeter forms universe extends from microbes' submicroscopic, atomic subatomic to a cosmos makeup or vice versa; as most conserving mass energy modes exchanges quintessential, core, natural disposition, globose-conduit forms are classic perimeters alongside spherical globose with parallelism to homogeneous mass energy round conductors; as created suitable boundary conditions allow, quintessential, core, natural disposition of mass energy self-conserving, preserving will result in globose-conduit perimeter forms;
globose-conduit Sets make spouts lower surfaces contained fluid mass-energy one-transformation half-mode cycle, kinetic to potential energy highest conservation and PPLD FESD least height and length forms much shorter than are those of ubiquitous art; a Nozzle FESD form may constitute a part of its End 2 undersurface form;
spherical globose highest energy modes genome classic forms retain mass units constituting computed least resistance paths, said paths-of-passage, PP, lengths least sum;
a PPLD width midpoint, said undersurfaces one point align tangentially for a Set of forms having a PAP direction horizontal orientation, PAP upright plane symmetry, and a basin-outlet rotation through a PAP angle in respect to the gravitational direction;
potential to kinetic mode quantum mass transfers constitute units of mass PP three components length; upright quantum mass-energy units contain the gravity acceleration multiple for computing quantum mass kinetic energy quanta sum that is PP lengths sum;
a fluid mass volume form with a center of mass located at a higher elevation or closer to a DCSS form constitutes quanta-mass conforming form PP lengths lower sum;
an upper retention quanta mass conforming retention constitutes a retained fluid surface-tension, adhesion height higher than a globose End 2, a globose-inverse First End undersurface, horizontal, radial, infinitesimal width highest finite increment;
a lower retention constitutes a region basin-outlet conduit spouts cross-sections forms gradual increase from PPLD width of band forms to said globose End 2, a globose-inverse First End undersurface, horizontal, radial, infinitesimal width highest increment;
a globose-conduit lower retention, smaller, short mass volume unified with a detention, an upper retention, dominant mass volume, least height conserves energy;
basin-outlets, DCSS, PPLD widths of band, and drain lines smaller lower areas of rounded surfaces and narrower breaths than equivalent round areas breadths at a same rise from respective inverts constitutes FESD forms; round or rounded cross-sections length segment constituting said PP lengths least sum constitutes an FESD form part;
an outlet FESD rounded cross-section, DCSS sub-outlets First Sub-outlet height constitutes a fluid elevation height that clears fluid mixture largest submerged particle;
a retained fluid mass free surface elevation differences vary with inflows and are enhanced or controlled by composite forms cross-sections of a DCSS or an outlet FESD, and various Sets FESD forms respective areas breadths, breaches, and heights;
globose forms large lengths and breadths free surfaces areas minimize its rise; outlet and DCSS FESD cross-sections continue lower area conduit forms through a First Sub-outlet height into larger Second Sub-outlet cross-sections, which also resists fluid free surface further rise conserving energy by transfer of energy-modes at a lower height;
said PP lengths computed least sum is for statistically compiled particles ranges, volume specific gravity, and shape sizes of mass mixture;
said Sets PPLD form retention volume “at-rest” is half as tall, of shorter length, and has a smaller to several folds smaller retained fluid volume than ubiquitous art forms;
conforming embodiments, PAP, PP, PPLD least quantum mass PP lengths least sum mass energy enclosure constitutes interface surfaces least resistance PP, forms; Inlet inflows provide nonhomogeneous, nonuniform, nonsteady contained retained, detained, transported fluid mass potential kinetic energy-modes;
quantum mass complete complement computed PP are least resistance forms Set;
genome Sets PP lengths least sum makes conforming retention mass least height;
globose conduit, globose-conduit, basin-outlet, G-C, cross-sections are made up of a lower smaller area rounded conduit form, a transition region intermediate area form, and an upper area rounded globose form for a compact composite curvilinear form;
a globose-conduits globose area height can vary from about 5% to 95% of entire cross-section height with its globose form area breadth varied up to three times a breadth of a vented pipe to which its conduit outlet descending spout connects;
a least mass half-cycle energy mode change conserves energy and fluid mass;
a least mass energy mode PP lengths least sum change is a Sets genome;
sets may constitute genomes for specific fluid mixtures, only;
forms of PPLD band make for PP lengths least sum, least retention, least height side-view “S”, “C”, or “S” and “C” forms, a PAP direction and a least angle, smoothest fluid surface interface forms, from basin lowest PPLD forms ending with a DCSS form;
a PAP makes an angle less than 180 degrees in respect to gravitational direction, entirely aligns Set forms upright plane symmetric from a basin blind side through at least a DCSS, and upwardly entirely to at least include a globose form springing points;
a summit is a DCSS lowest infinitesimal width finite horizontal increment, outlet ascending spouts and PPLD forms highest infinitesimal end furthest from its respective Inlet, and a fluid tension and adhesion height higher than an upper retention free surface “at-rest” elevations retaining conforming continual least fluid mass, volume, and height;
globose-conduit paths-of-passage-of-least-energy-demand, PPLD, and PAP rotational angles less than 180 degrees that constitute least height basin-outlet PPLD for ascending lowest surfaces highest slopes smaller angles, inherently smaller angles shorter smaller slopes for a shorter entire length, with a smallest conforming retention fluid mass;
globose-conduit forms constitute domains of generic and circumferential strain hybrids of horizontal and upright orthogonal planes rotated globose genus form; generic circumferential globose hybrid domains are claimed as forms of globose domains;
migrations of globose Inlets End 2, globose-inverse outlets First End from basin-outlets blind side to an anti-sidelong location on opposite end of basin-outlet retention forms constitutes Sidelong, Sidelong Offset, Offset Centric, Centric, Anti Offset Centric, Anti Sidelong Offset, and Anti Sidelong Sets;
illustrating and describing a domain Set, entire domain Sets, its hybrids and Sets migrations within entire G-C universe range constituted Sets genomes is claimed together with Sets inventions, principles, methodologies, and concepts for retained fluids mass and energy conserving by globose conduit forms Sets and their circumferential hybrids;
basin-outlets basin upper retention constitutes largely one of five: truncated about largest cross-sections of globose, spheroidal, ellipsoidal, cylinder, or cylindroid forms of a short height that is shorter than a largest horizontal dimension of a respective basin;
a basin lowest surfaces makes largely one of following large forms: a rounded, an annular, a crescent, an about flat to doming annular, and an annular crescent, among PPLD FESD many geometrics of single or various compositions of smaller forms;
an about upright Inlet and basin-outlet retention forms rotated into an upright PAP plane of symmetry by rotating its retained fluid form, and horizontal plane rotated about an upright axis, especially an Inlet upright axis, staying upright constitutes an angled form in its original position;
a basin-outlet conduit outlet spout ascends from a globose Set First End surface inflection, an outlet basin end cross-section, or a globose-inverse submerged spout form lower end inside a basin-Inlet retention of respective globose, globose-inverse forms;
basin-outlets outlet spout cross-sections are made up largely by one of following FESD forms: a rounded, an elliptical, or a curvilinear geometries composite areas form;
outlets, DCSS, and Sub-outlets FESD forms constitute PAP upright plane aligned symmetric a lower, smaller, rounded conduit form, a transition region cross-sections, and an upper largest area largely a rounded, an elliptical, a parabolic or a curvilinear form;
highly angled Set angle forms from a lower basin to basin-outlet intersections, to then rotate into about an upright upper end Inlet, and rotate a globose End 2, a globose-inverse First End, basin-outlet lowest surfaces close to near horizontal for respective basin-outlets spouts complete complementing, PP lengths least sum forms;
flow-energy-surface-dispensators, FESD, PAP upright plane symmetric globose-conduit quanta mass, cross-sections, areas, shapes, heights, breaches, or entire breadths, as G-C forms, transform globose to conduit forms and vice versa; They make up conforming quanta mass least volume, rotations, perimeters, and PP lengths sum that constitutes the following forms:
a three-dimensional Set (TD), circumferential, axial or transverse Trough, Ridge, an Inlet upright Ridge a Trough, a Trough in a Trough, a Ridge, a Partition with/without a Window(s), a Troughs-Ridge, a Troughs-Ridge-Partition and a Window(s);
a Circumferential Trough, a Ridge, a Partition, a three-dimensional Window and a Troughs-Ridge and a Troughs-Ridge-Partition and a three-dimensional Window(s);
a Nozzle local highly directional spout forms;
a globose End 2, globose-inverse First End and PPLD counterpart forms of a Set;
a Bridging-Wall with Domed-Cavities about Inlet forms;
a Fin FESD forms dividing globose-conduit cross-sections upper retention;
a Trough, a Ridge, an upright Ridge, a Partition with/without a Window(s), a Trough in a Trough, a Troughs-Ridge, a Troughs-Ridge, a Troughs-Ridge-Partition with/without Window(s) upright plane axially symmetric forms;
an FESD manager enhanced control of fluid free surfaces height differences;
an FESD space manager exchange of air and fluid manages retention form free surface areas and elevations, thus cross-sections areas, height, breadth, breach and length;
cavities; dome Cavities FESD;
a rounded End 2, First End; a flared; an infant boot; a Fin End 2 FESD form;
a Migration Dimension(s) 44, (44,44′);
a crescent PPLD conical form FESD;
outlets, DCSS and globose-conduit cross-sections areas breadth, breach, and height FESD forms managed effects of retained fluid free surface elevations, elevation differences, as counterparts of FESD mangers' and FESD space managers' forms;
flush Apparatus parts, entirely contained within walls of a Set with access to most Set's locations, separately or concurrently disinfect, flush, surface coat, repair or protect damaged surfaces; Flush Apparatus prefabricated pre-assemblies use design fluids and or gases, or air, jointly individually or, to a separate sequence and intervals or concurrently, to a surface location or entire Set with a single, a set, or a nozzles network, with tie-ins, or sets of tie-ins located conveniently about a Set; Flush Apparatus tie-in assemblies with check valves can act as a controlled air and or design fluid inflow into a Set to counter suction through said single or networks of nozzles or sense a low basin fluid level to start pumping air and or design fluid; Flush Apparatus design-fluids adept usage approximates near frictionless surfaces;
a double wall inner space and gravitational direction compliant tubing show and warn expeditiously by dripping leak evidence that a wall failure has occurred;
said Sets exact globose-conduit construction is beyond human creative skills;
a descending outlet spout Second End connects to a vented drainage line with a positive rigid connection, which is one of two connections that support a Set;
connections are generally shown threaded or welded; Compression couplings and flexible installed in place rigid with or without gaskets, washers, or bushings, and locked or double treaded or said connections suitable mix constitutes globose Set connections;
a top quality highest accuracy highest pressure moldings of plastics, metals, and their composites and or semi-rigid materials that are adequately rigid or are with positive provisions for sufficient stiffness or a fabrication combination of above makes said Sets; one-way air nozzles are suction precluding measures; forms constitute smallest mass and height known to stop suction and or venting; forms are to crafts finite or scientific infinitesimal accuracy algorithm computed as needed;
fluids and solids particles non-homogenous mixtures inflow through an End 1 into globose Set forms and by gravity force outflow through an outlet Exhaust;
inventions are not restricted to the highest conservation of fluid mass or energy genomes disclosed narrow highly defined scope of fluid mass, and energy conservation of the inventions, which unify fields of arts and sciences;
said classic perimeter PP mass laminar fluid finite segments constitutes viscosity, adhesion, fluid pressure internal and boundary layer related forces with no rotation of fluid mass, which is identical for homogeneous mass-energy; classic perimeter globose-conduit nonhomogeneous mass energy forms with parallelism travel across arts, science fields analogous to classic, homogeneous, mass energy round forms; classic perimeters mass no rotations or boundary friction constitutes translational energy mode ultimately conserved mass energy;
ascending globose-outlet spout Sub-outlets make either a rounded, or an elliptical major axis upright, or a curvilinear cross-section area form that passes statistically most prevailing continual detention mass with detention free surface at said essential elevation height that also passes said largest sphere as single most unusual event; globose-conduit classic forms constitute classic conduit forms that evolve or devolve from classic globose retention basin forms that also evolve or devolve into rounded, or curvilinear, or elliptical major axis upright forms;
said generic claims fluid mass energy self-conserving self-preservations allow for computed accelerated aging whose energy modes among depicted Figures or as described constitute scope of inventions, methodologies and principles of globose-conduit forms; classic globose-conduit spout rounded basic PP lengths least sum forms surfaces, a life span aged forms, or a specific event forms make up universe of globose-conduit forms; globose-conduit Set of basin-outlet contained fluid mass including an Inlet, and contained entire fluid mass rotate in space transposing mechanics of forms thus make globose-conduit universe strains, domains, Sets including partitions, hybrids, mutations; FIG. 1-2, Section A-A forms with shown ascending outlet spout rotated to 165 degrees transposes globose-conduit Sidelong Set to one cell of said Partitioned Inline Set, reassembled into a globose-inverse Set constitutes depicted Inline forms; FIG. 19, an Industrial Set clockwise rotated to PAP angle of about 127 degrees by universal joint End 1 connection transforms into Low PAP angle domain Sidelong Centric Set of highly angled forms; said Industrial Set as one DCSS curvilinear form without Sub-outlets curving parts with an upright descending outlet spout transposes into said one cell Set of said Inline domain of forms; said Industrial Set one cell Inline forms Inlet, basin, outlet ascending spouts that make a common surface of said double wall with a donut form hemispherical descending outlet spout, holding Chamber described with Industrial Set constitutes a hemispherical outline shown by Inline domain forms; angled domains Set of forms constitute deviations from upright forms;
classic globose-conduit, FESD complete complement of forms constitutes cross-sections, breadths, fluid mass least rotations, least permanently retained fluid mass, least perimeter breadths interface surface lengths, for energy modes least mass-energy transfer; hydrostatic pressure centroids of basin-outlet nonhomogeneous fluid gravity segregated, transported mass is more than ⅔ of a height below retained fluid free surface elevations;
fluid mass inflows outflows PP lengths least sum of classic globose-conduit open channel forms complete complement is least upright distance from PPLD forms highest elevations to largest fluid free surfaces for retention with detention hydrostatic pressures;
conduit Inlets, basin-outlets open channel classic Sets constitute least height, least retained, most detained transported fluid mass that preclude suction and or venting, least height forms, a PP lengths least sum, with conduit outlet spouts narrow lower breadths;
globose-conduit open channel forms complete complement contains conforming quantum mass PP lengths least sum that transports quanta mass with a much shorter PP lengths sum than ubiquitous art forms, for rare events or to preclude a retention suction;
classic globose-conduit open channel forms for nonhomogeneous fluid mass by PP lengths least sum computation, fluid mass path of least resistance, transform, transfer into highest energy, classic nonhomogeneous, natural disposition of hydrostatic pressure, least retained, mass-energy perimeter forms;
globose-conduit forms transfers into known, classic mass energy forms confirms they are of classic genus; conduit lowest surfaces rounded forms with PPLD horizontal width of band reflects upon nonhomogeneous high specific gravity fluid mass, sizes of largest solid particles, among other physical parameters; globose upper surface forms reflect upon nonhomogeneous transport fluids physical parameters and cross-sections area required; cross-section breadths especially transition region breadths reflect upon a nonhomogeneous retained mass least height form highest mass and energy conservation;
elliptical horizontal major axis as fluid energy geometrics forms are subordinate to globose, rounded conduit forms and except for curvilinear forms parts do not normally make up FESD forms except for preference by these very applicable specific exceptions:
a basin lowest surface part under a globose End 2, a globose-inverse First End;
a conduit form of highly homogeneous frictionless, adhesionless fluid surfaces;
a globose-conduit FESD curvilinear “crown” form that reduces forms height;
a part of curvilinear specifically applied outlet, DCSS, and Inlet FESD forms;
forgoing excludes entirely round forms that constitute parts or counterparts of PP lengths least sum FESD, and homogeneous, adhesionless, no cohesion fluid mass forms.
